(19) United States
(12) Patent Application Publication
(10) Pub. No.: US 2015/0031010 A1
(43) Pub. Date: Jan. 29, 2015

(54) IMPROVING NEUROPERFORMANCE

(71) Applicant: ASPEN PERFORMANCE TECHNOLOGIES, Tel Aviv (IL)

(72) Inventors: Jose Roberto KULLOK, Efrat (IL); Saul KULLOK, Efrat (IL)

(73) Assignee: ASPEN PERFORMANCE TECHNOLOGIES, Tel Aviv (IL)

(21) Appl. No.: 14/251,116

(22) Filed: Apr. 11, 2014

Related U.S. Application Data
(60) Provisional application No. 61/857,974, filed on Jul. 24, 2013.

(51) Int. Cl. G09B 7/02

(52) U.S. Cl. CPC G09B 7/02
USPC 434/362

(57) ABSTRACT

A method of promoting fluid intelligence abilities in a subject includes: selecting one or more serial order of symbols sequences from a predefined library of complete symbols sequences and providing the subject with one or more incomplete serial orders of symbols sequences; prompting the subject to manipulate symbols within the incomplete serial orders of symbols sequences or to discriminate differences or sameness between two or more of the incomplete serial orders of symbols sequences; determining whether the subject correctly manipulated the symbols or correctly discriminated differences or sameness between the two or more incomplete serial orders of symbols sequences; if the subject correctly manipulated the symbols or correctly discriminated differences or sameness between the two or more of the incomplete serial orders of symbols sequences, then displaying the correct manipulations or discriminated selection with at least one different spatial or time perceptual related attribute, to highlight the correct answer.

### FIELD

The present disclosure relates to a system, method, software, and tools employing a novel disruptive non-pharmacological technology, characterized by prompting a sensory-motor-perceptual activity in a subject to be correlated with the statistical properties and implicit embedded pattern rules information depicting the sequential order of alphanumerical series of symbols (e.g., in alphabetical series, letter sequences and in series of numbers) and in symbols sequences interrelations, correlations and cross-correlations. This novel technology sustains and promotes, in general, neural plasticity and in particular neural-linguistic plasticity. This technology is executed through new strategies, implemented by exercises designed to obtain these interrelations, correlations and cross-correlations between sensory-motor-perceptual activity and the implicit-explicit symbolic information content embedded in a statistical and sequential properties\rules depicting serial orders of symbols sequences. The outcome is manifested mainly via fluid intelligence abilities e.g., inductive-deductive reasoning, novel problem solving, and spatial orienting.

A primary goal of the non-pharmacological technology disclosed herein is maintaining stable cognitive abilities, delaying, and/or preventing cognitive decline in a subject experiencing normal aging; restraining working and episodic memory and cognitive impairments in a subject experiencing mild cognitive decline associated, e.g., with mild cognitive impairment (MCI), pre-dementia; and delaying progression of severe working, episodic and prospective memory and cognitive decay at the early phase of neural degeneration in a subject diagnosed with a neurodegenerative condition (e.g., Dementia, Alzheimer's, Parkinson's). The non-pharmacological technology disclosed herein is also beneficial as a training cognitive intervention designated to improve the instrumental performance of the elderly person in daily demanding functioning tasks such that enabling some transfer from fluid cognitive trained abilities to everyday functioning. The non-pharmacological technology disclosed herein is also beneficial as a brain fitness training/cognitive learning enhancer tool in normal aging population and a subpopulation of Alzheimer's patients (e.g., stage 1 and beyond), and in subjects who do not yet experience cognitive decline.

### BACKGROUND

Brain/neural plasticity refers to the brain's ability to change in response to experience, learning and thought. As the brain receives specific sensorial input, it physically changes its structure (e.g., learning). These structural changes take place through new emergent interconnectivity growth connections among neurons, forming more complex neural networks. These recently formed neural networks become selectively sensitive to new behaviors. However, if the capacity for the formation of new neural connections within the brain is limited for any reason, demands for new implicit and explicit learning, (e.g., sequential learning, associative learning) supported particularly on cognitive executive functions such as fluid intelligence-inductive reasoning, attention, memory and speed of information processing (e.g., visual-auditory perceptual discrimination of alphanumeric patterns or pattern irregularities) cannot be satisfactorily fulfilled. This insufficient “neural connectivity” causes the existing neural pathways to be overworked and over stressed, often resulting in gridlock, a momentary information processing slow down and/or suspension, cognitive overflow or in the inability to dispose of irrelevant information. Accordingly, new learning becomes cumbersome and delayed, manipulation of relevant information in working memory compromised, concentration overtaxed and attention span limited.

Worldwide, millions of people, irrespective of gender or age, experience daily awareness of the frustrating inability of their own neural networks to interconnect, self-reorganize, retrieve and/or acquire new knowledge and skills through learning. In normal aging population, these maladaptive learning behaviors manifest themselves in a wide spectrum of cognitive functional and Central Nervous System (CNS) structural maladies, such as: (a) working and short-term memory shortcomings (including, e.g., executive functions), over increasing slowness in processing relevant information, limited memory storage capacity (items chunking difficulty), retrieval delays from long term memory and lack of attentional span and motor inhibitory control (e.g., impulsivity); (b) noticeable progressive worsening of working, episodic and prospective memory, visual-spatial and inductive reasoning (but also deductive reasoning) and (c) poor sequential organization, prioritization and understanding of meta-cognitive information and goals in mild cognitively impaired (MCI) population (who don't yet comply with dementia criteria); and (d) signs of neural degeneration in pre-dementia MCI population transitioning to dementia (e.g., these individuals comply with the diagnosis criteria for Alzheimer's and other types of Dementia.).

The market for memory and cognitive ability improvements, focusing squarely on aging baby boomers, amounts to approximately 76 million people in the US, tens of millions of whom either are or will be turning 60 in the next decade. According to research conducted by the Natural Marketing Institute (NMI), U.S., memory capacity decline and cognitive ability loss is the biggest fear of the aging baby boomer population. The NMI research conducted on the US general population showed that 44 percent of the US adult population reported memory capacity decline and cognitive ability loss as their biggest fear. More than half of the females (52 percent) reported memory capacity and cognitive ability loss as their biggest fear about aging, in comparison to 36 percent of the males.

Neurodegenerative diseases such as dementia, and specifically Alzheimer's disease, may be among the most costly diseases for society in Europe and the United States. These costs will probably increase as aging becomes an important social problem. Numbers vary between studies, but dementia worldwide costs have been estimated around $160 billion, while costs of Alzheimer in the United States alone may be $100 billion each year.

Currently available methodologies for addressing cognitive decline predominantly employ pharmacological interventions directed primarily to pathological changes in the brain (e.g., accumulation of amyloid protein deposits). However, these pharmacological interventions are not completely effective. Moreover, importantly, the vast majority of pharmacological agents do not specifically address cognitive aspects of the condition. Further, several pharmacological agents are associated with undesirable side effects, with many agents that in fact worsen cognitive ability rather than improve it. Additionally, there are some therapeutic strategies which cater to improvement of motor functions in subjects with neurodegenerative conditions, but such strategies too do not specifically address the cognitive decline aspect of the condition.

Thus, in view of the paucity in the field vis-à-vis effective preventative (prophylactic) and/or therapeutic approaches, particularly those that specifically and effectively address cognitive aspects of conditions associated with cognitive decline, there is a critical need in the art for non-pharmacological (alternative) approaches.

With respect to alternative approaches, notably, commercial activity in the brain health digital space views the brain as a “muscle”. Accordingly, commercial vendors in this space offer diverse platforms of online brain fitness games aimed to exercise the brain as if it were a “muscle,” and expect improvement in performance of a specific cognitive skill/domain in direct proportion to the invested practice time. However, vis-à-vis such approaches, it is noteworthy that language is treated as merely yet another cognitive skill component in their fitness program. Moreover, with these approaches, the question of cognitive skill transferability remains open and highly controversial.

The non-pharmacological technology disclosed herein is implemented through novel neuro-linguistic cognitive strategies, which stimulate sensory-motor-perceptual abilities in correlation with the alphanumeric information encoded in the sequential and statistical properties of the serial orders of its symbols (e.g., in the letters series of a language alphabet and in a series of numbers 1 to 9). As such, this novel non-pharmacological technology is a kind of biological intervention tool which safely and effectively triggers neuronal plasticity in general, across multiple and distant cortical areas in the brain. In particular, it triggers hemispheric related neural-linguistic plasticity, thus preventing or decelerating the chemical break-down initiation of the biological neural machine as it grows old.

The present non-pharmacological technology accomplishes this by particularly focusing on the root base component of language, its alphabet, organizing its constituent parts, namely its letters and letter sequences (chunks) in novel ways to create rich and increasingly new complex non-semantic (serial non-word chunks) networking. The present non-pharmacological technology also accomplishes this by focusing on the natural numbers numerical series, organizing its constituent parts, namely its single number digits and number sets (numerical chunks) in novel serial ways to create rich and increasingly new number serial configurations.

From a developmental standpoint, language acquisition is considered to be a sensitive period in neuronal plasticity that precedes the development of top-down brain executive functions, (e.g., memory) and facilitates “learning”. Based on this key temporal relationship between language acquisition and complex cognitive development, the non-pharmacological technology disclosed herein places ‘native language acquisition’ as a central causal effector of cognitive, affective and psychomotor development. Further, the present non-pharmacological technology derives its effectiveness, in large part, by strengthening, and recreating fluid intelligence abilities such as inductive reasoning performance/processes, which are highly engaged during early stages of cognitive development (which stages coincide with the period of early language acquisition). Furthermore, the present non-pharmacological technology also derives its effectiveness by promoting efficient processing speed of phonological and visual pattern information among alphabetical serial structures (e.g., letters and letter patterns and their statistical properties, including non-words), thereby promoting neuronal plasticity in general across several distant brain regions and hemispheric related language neural plasticity in particular.

The advantage of the non-pharmacological cognitive intervention technology disclosed herein is that it is effective, safe, and user-friendly, demands low arousal thus low attentional effort, is non-invasive, has no side effects, is non-addictive, scalable, and addresses large target markets where currently either no solution is available or where the solutions are partial at best.

### SUMMARY

In one aspect, the present subject matter relates to a method of promoting fluid intelligence abilities in a subject comprising selecting one or more serial order of symbols from a predefined library of complete symbols sequences and, from this selection, providing the subject one or more incomplete serial orders of symbols sequences, wherein spatial or time perceptual related attributes of the symbols of the one or more incomplete serial order of symbols sequences are the same. The subject is then prompted, within an exercise, to manipulate symbols within the one or more incomplete serial orders of symbols sequences or to discriminate differences or sameness between two or more of the incomplete serial orders of symbols sequences, within a first predefined time interval. After manipulating the symbols or discriminating differences or sameness between two or more incomplete serial orders of symbols sequences within the exercise, an evaluation is performed to determine whether the subject correctly manipulated the symbols or correctly discriminated differences or sameness between the two or more incomplete serial orders of symbols sequences. If the subject made an incorrect symbol manipulation or differences or sameness discrimination between two or more of the incomplete serial orders of symbols sequences, then the exercise is started again and the subject is prompted, within an exercise, to manipulate symbols within the one or more incomplete serial orders of symbols sequences or to discriminate differences or sameness between two or more of the incomplete serial orders of symbols sequences, within the first predefined time interval. If, however, the subject correctly manipulated the symbols or correctly discriminated differences or sameness between the two or more incomplete serial orders of symbols sequences, then the correct manipulations of symbols or discriminated differences or sameness are displayed with at least one different spatial or time perceptual related attribute to highlight the symbols manipulation, difference or sameness. The above steps in the method are repeated for a predetermined number of iterations separated by one or more predefined time intervals, and upon completion of the predetermined number of iterations, the subject is provided with each iteration result.

Another aspect of the present subject matter relates to a method implemented through a computer program product stored on a non-transitory computer-medium, which, when executed, causes a computer system to perform a method for promoting fluid intelligence abilities in a subject, The method executed by the computer program on the non-transitory computer readable medium comprises selecting one or more serial order of symbols sequences from a predefined library of complete symbols sequences and, from this selection, providing the subject one or more incomplete serial orders of symbols sequences, wherein spatial or time perceptual related attributes of the symbols of the one or more incomplete serial order of symbols sequences are the same. The subject is then prompted, within an exercise, to manipulate symbols within the one or more incomplete serial orders of symbols sequences or to discriminate differences or sameness between two or more of the incomplete serial orders of symbols sequences, within a first predefined time interval. After manipulating the symbols or discriminating differences or sameness between two or more incomplete serial orders of symbols sequences within the exercise, an evaluation is performed to determine whether the subject correctly manipulated the symbols or correctly discriminated differences or sameness between the two or more incomplete serial orders of symbols sequences. If the subject made an incorrect symbol manipulation or discrimination concerning difference or sameness between the two or more incomplete serial orders of symbols sequences, then the exercise is initiated again and the subject is prompted, within an exercise, to manipulate symbols within the one or more incomplete serial orders of symbols sequences or to discriminate differences or sameness between two or more of the incomplete serial orders of symbols sequences, within the first predefined time interval. If, however, the subject correctly manipulated the symbols or correctly discriminated differences or sameness between the two or more incomplete serial orders of symbols sequences, then the correct manipulations or discriminated differences or sameness between the two or more incomplete serial orders of symbols sequences are displayed with at least one different spatial or time perceptual related attribute to highlight the symbols manipulation, difference or sameness. The above steps in the method are repeated for a predetermined number of iterations separated by one or more predefined time intervals, and upon completion of the predetermined number of iterations, the subject is provided with each iteration result.

In another aspect, the present subject matter relates to a method presented by a system for promoting fluid intelligence abilities in a subject. The system comprises a computer system comprising a processor, memory, and a graphical user interface (GUI). The processor contains instructions for: selecting one or more serial order of symbols sequences from a predefined library of complete symbols sequences and, from this selection, providing the subject, via the GUI, one or more incomplete serial orders of symbols sequences, wherein spatial or time perceptual related attributes of the symbols of the one or more incomplete serial order o symbols sequences are the same. The subject is then prompted on the GUI, within an exercise, to manipulate symbols within the one or more incomplete serial orders of symbols sequences or to discriminate differences or sameness between two or more of the incomplete serial orders of symbols sequences, within a first predefined time interval. After manipulating the symbols or discriminating differences or sameness between two or more incomplete serial orders of symbols sequences within the exercise, an evaluation is performed to determine whether the subject correctly manipulated the symbols or correctly discriminated differences or sameness between the two or more incomplete serial orders of symbols sequences. If the subject made an incorrect symbol manipulation or discrimination concerning differences or sameness between the two or more incomplete serial orders of symbols sequences, then the exercise is initiated again and the subject is prompted, within an exercise, to manipulate symbols within the one or more incomplete serial orders of symbols sequences or to discriminate differences or sameness between two or more of the incomplete serial orders of symbols sequences, within the first predefined time interval. If, however, the subject correctly manipulated the symbols or correctly discriminated differences or sameness between the two or more incomplete serial orders of symbols sequences, then the correct symbols manipulations or discriminated differences or sameness between two or more of the incomplete serial orders of symbols sequences are displayed on the GUI with at least one different spatial or time perceptual related attribute to highlight the symbols manipulation, difference or sameness. The above steps in the method are repeated for a predetermined number of iterations separated by one or more predefined time intervals, and upon completion of the predetermined number of iterations, the subject is provided with each iteration results.

In another aspect, the subject matter disclosed herein provides a novel non-pharmacological, non-invasive sensorial biofeedback psychomotor application designed to exercise and recreate the developmentally early neuro-linguistic aptitudes of an individual that can be effective in slowing down cognitive decline associated with aging and in restoring optimal neuroperformance.

In yet another aspect, the subject matter disclosed herein provides a non-pharmacological approach that enhances predisposition for implicit learning of serial and statistical alphabetical knowledge properties in order to maintain the stability of selective cognitive abilities thus preventing or delaying in part of the normal aging population: gradual decline of fluid cognitive abilities (e.g., inductive reasoning), working memory fluidity, attention, visual-spatial orientation, visual-auditory speed of processing, etc.

In yet another aspect, the subject matter disclosed herein provides a non-pharmacological approach for compensating or significantly limiting the worsening of working, episodic and prospective memory and cognitive abilities of the pre-dementia mild cognitive impaired MCI population, possibly restoring working and episodic memory and cognitive executive function performance in some tasks to those associated with normal aging adults.

In yet another aspect, the subject matter disclosed herein provides a non-pharmacological cognitive intervention to effectively shield the CNS in the brain in the very early stage of dementia, so that neural degeneration will progress at a very slow pace, thus significantly postponing cognitive functional and physiological morphological (neural) stagnation resulting in a hold-up of the early stage of the disease and to some degree also resulting in longer transitional periods between later more severe dementia stages.

In yet another aspect, the subject matter disclosed herein provides a non-pharmacological, neuro-linguistic stimulation platform promoting new implicit and explicit learning of serial and statistical properties of the alphabet and natural numbers.

In yet another aspect, the subject matter disclosed herein provides a disruptive scalable internet software cognitive neuroperformance training platform which safely stimulates neural networking reach-out among visual-auditory-motor, language-alphabetical, and attention and memory brain areas thus promoting plasticity across functionally different and distant areas in the brain via novel interactive computer based cognitive training. Specifically, this new triggered plasticity stimulates implicit-explicit cognitive learning thus consolidating novel symbolic interrelations, correlations and cross-correlations between non-semantic, visual-auditory-motor, fluid intelligence abilities and spatial salient aspects of attended stimuli, mainly in working memory. Accordingly, fluid intelligence abilities concerning alphanumeric symbolic information is best manipulated in working memory because the present method implements a novel exercising approach that meshes in non-linear complex ways, multiple sources of sensorial-motor-perceptual information (e.g., non-semantic, visual-auditory-motor, inductive reasoning and spatial attention etc.). Further, the approach of the present method expedites the manipulation of symbolic items in working memory.

In yet another aspect, the subject matter disclosed herein provides a non-pharmacological novel cognitive intervention which stimulates visual-auditory-motor cortices via sensorial-perceptual engagement to trigger spatial-temporal cross-domain learning, based on the brain's participating neural networks' natural capacity to interact with each other in novel complex/multifaceted ways. The resulting new learning appears both simple and novel (interesting) to the user.

In yet another aspect, the subject matter disclosed herein provides non-pharmacological brain fitness tools to stimulate, reconstruct and sharpen core selective cognitive skills (e.g., fluid and crystallized skills) that are affected by aging. This is achieved through effortless, quick, novel statistical and sequential assimilation of alphabetical (e.g., non-semantic letter sequences) and numerical patterns and sets by way of cognitive (not-physical) exercises that improve a number of skills, including motor, visual, auditory performances, spatial attention, working, episodic and prospective memories, speed of processing (e.g., visual and auditory “target” pattern search), ignoring or filtering out distracting non-relevant sensorial information, and fluid intelligence abilities (e.g., problem solving, inductive reasoning, abstract thinking, pattern-irregularity recognition performance, etc.)

In a further aspect, the subject matter disclosed herein provides an interactive cognitive intervention software platform to non-pharmacologically retrain early acquired an constantly declining fluid intelligence abilities such as: inductive reasoning, problem solving, pattern recognition, abstract thinking etc., by novel exercising of basic alphabetical and numerical symbolic implicit familiarity acquired particularly during the early language acquisition stage of cognitive development, which assists in improving information processing speed, establishing cognitive performance stability, delaying or reversing cognitive decline in early stages of the aging process and maintains or restores basic instrumental functionality skills in daily demanding tasks.

### BRIEF DESCRIPTION OF DRAWINGS

FIG. 1 is a flow chart setting forth the broad concepts covered by the specific non-limiting exercises put forth in the Examples disclosed herein.

FIG. 2 is a flow chart setting forth the method that the exercises disclosed in Example 1 use in promoting fluid reasoning ability in a subject by inductively inferring the next term in an alphabetical sequence.

FIGS. 3A-3B depict a number of non-limiting examples of the exercises for inductively inferring the next symbol in an incomplete serial order of symbols sequence. FIG. 3A shows a direct alphabetical serial order of symbols sequence comprising three letter symbols and prompts the subject to correctly select the fourth letter symbol in the sequence. FIG. 3B shows that the correct letter symbol selection is the letter symbol D.

FIG. 4 is a flow chart setting forth the method that the present exercises use in promoting fluid intelligence abilities in a subject by reasoning about the similarity or disparity in letter symbols sequences.

FIG. 5A-5B depict a number of non-limiting examples of the exercises for reasoning about the sameness and differentness in two incomplete serial orders of symbols sequences. FIG. 5A shows two incomplete serial orders of symbols sequences comprising three letter symbols (A, B, and C) in the same serial order but containing different spatial or time perceptual related attributes (i.e., the letter symbol A has a different time related color attribute in each of the two symbol patterns sets) and prompts the subject to correctly select whether the incomplete serial orders of letter symbols sequences are the same or different. FIG. 5B shows an example of when the subject selects that the two incomplete serial orders of letter symbols sequences are different.

FIG. 6 is a flow chart setting forth the method that the present exercises use in promoting fluid intelligence abilities in a subject by reasoning strategies the subject utilizes in order to insert missing symbols into an incomplete serial order of symbols sequence to form a completed serial order of symbols sequence.

FIGS. 7A-7D depict a number of non-limiting examples for inserting the missing symbols in an incomplete serial order of symbols sequence. FIG. 7A shows an incomplete direct alphabetical serial order of symbols sequence, along with the complete alphabetical serial order of symbols sequence underneath the incomplete serial order of symbols sequence. The subject is then prompted to complete the alphabetical serial order of symbols sequence by inserting the missing letter symbols. FIG. 7B shows the completed alphabetical serial order of symbols sequence with the inserted letter symbols being displayed with a changed spatial or time perceptual related attribute. FIG. 7C shows an incomplete inverse alphabetical serial order of letter symbols sequence, along with the complete inverse alphabetical serial order of symbols sequence underneath the incomplete inverse alphabetical serial order of symbols sequence. The subject is then prompted to complete the inverse alphabetical serial order of symbols sequence by inserting the missing letter symbols. FIG. 7D shows the inserted letter symbols having a single changed time perceptual related attribute in the form of a color change.

FIG. 8 is a flow chart setting forth the method that the present exercises uses in promoting fluid intelligence abilities in a subject by completing an incomplete serial order of symbols sequence to form a completed serial order of symbols (e.g., alphabetic, numeric or alphanumeric symbols) sequence.

FIGS. 9A-9C depict a non-limiting example of the exercises completing an incomplete serial order of symbols sequence. FIG. 9A shows an original incomplete alphabetical serial order of symbols sequence, along with a number of other incomplete serial orders of symbols sequences provided under the original incomplete alphabetical serial order of symbols sequence. The original incomplete alphabetical serial order of symbols sequence provided in FIG. 9A is incomplete symbols sequence KLMNOPQ. FIG. 9B shows that the subject has correctly identified one complementary contiguous incomplete serial order of symbols sequence in the form of incomplete symbols sequence ABCDEFGHIJ. Further, FIG. 9C shows the obtained completed direct alphabetical serial order of symbols sequence, with the subject having correctly identified the second complementary contiguous incomplete serial order of symbols sequence in the form of incomplete symbols sequence RSTUVWXYZ.

### DETAILED DESCRIPTION

### Overview

A growing body of research supports the protective effects of late-life intellectual stimulation on incident dementia. Recent research from both human and animal studies indicates that neural plasticity endures across the lifespan, and that cognitive stimulation is an important predictor of enhancement and maintenance of cognitive functioning, even in old age. Moreover, sustained engagement in cognitively stimulating activities has been found to impact neural structure in both older humans and rodents. Conversely, limited education has been found to be a risk factor for dementia. There is also a sizeable body of literature documenting that different types of cognitive training programs have large and durable effects on the cognitive functioning of older adults, even in advanced old age.

Longitudinal Studies Addressing Training Effects on Cognitive Decline:

Longitudinal studies addressing the decline in intellectual abilities in later adulthood and early old age, suggest that such decline is commonly selective (often ability specific), rather than global or catastrophic. In other words, typically, individuals show statistically reliable decrement on a particular subset of abilities, although their performance remains stable on other abilities. Moreover, there are wide individual differences in the specific abilities showing decline.

A study by Willis and Schaie examined the effects of cognitive training on two primary mental abilities-spatial orientation and inductive reasoning, within the context of the Seattle longitudinal study (SLS), which study provided a major model for longitudinal-sequential studies of aging. (See Willis, S. L. and Shaie, K. W. Psychol. Aging. 1986 September; 1(3):239-47). These specific cognitive abilities were targeted because they had been identified by previous studies to exhibit patterns of normative decline. The focus of the study was on facilitating the subject's use of effective cognitive strategies, identified in previous research, on the respective cognitive abilities. Spatial orientation ability was assessed by four measures: Primary Mental Abilities (PMA) Space; Object Rotation; Alphanumeric rotation; and Cube Comparison. Inductive reasoning ability was measured by four measures: The PMA reasoning measure (which assesses inductive reasoning via letter series problems); The Adult Development and Enrichment Project (ADEPT) Letter Series test; The Word Series test: and The Number Series test. Each of these four inductive reasoning measure tests involves different types of pattern-description rules involving letters, words, numbers or mathematical computations. In addition to the spatial orientation and inductive reasoning, Willis and Schaie's test battery also involved psychometric measures representing primary mental abilities (PMA) for perceptual speed, numeric and verbal abilities.

The results of Willis and Schaie's study suggested that training effects were significant only for the two targeted abilities, i.e., inductive reasoning and spatial orientation abilities, but not for the other abilities tested, i.e., perceptual speed, numeric and verbal. Further, the results showed that not only were the training efforts effective in significantly improving the performance of older adults whose abilities trained had declined, but were also effective in enhancing the performance of those older persons whose (i.e., those who showed no prior decline) target abilities had remained stable. Thus, Willis and Schaie's study suggested that for elderly subject s with known intellectual histories, it appears feasible to develop individual profiles of ability change and to target cognitive intervention efforts specifically to the needs of the individual, whether there is remediation of loss or increasing performance to a level not previously demonstrated by the individual. However, the magnitude of training effects has been found to vary with cognitive risk and dementia status.

Overview of the Seattle Longitudinal Study (SLS):

An overview of the Seattle Longitudinal Study (SLS) is provided in a review article by Schaie, Willis and Caskie, and briefly summarized below (See Schaie, K. W., Willis, S. L., and Caskie, G. I. L., Neuropsychol Dev Cogn B Aging Neuropsychol Cogn. 2004 June; 11(2-3): 304-324.)

The SLS study has provided a major model for longitudinal-sequential studies of aging and has allowed for charting the course of selected psychometric abilities from young adulthood through old age. The SLS has investigated individual differences and differential patterns of change. In so doing it has focused not only on demonstrating the presence or absence of age-related changes and differences but has attended also to the magnitude and relative importance of the observed phenomena.

During all seven cycles of the SLS, the principal dependent variables were the measures of verbal meaning, space, reasoning, number and word fluency, identified by Thurstone as accounting for the major proportion of variance in the abilities domain in children and adolescents contained in the 1948 version of the Thurstone's SRA Primary Mental Abilities Test. The second set of variables that has been collected consistently includes the rigidity-flexibility measures from, the Test of Behavioral Rigidity, which also include a modified version of the Gough social responsibility scale. Limited demographic were collected during the first three cycles. The above measures are referred to as the “Basic Test Battery,” and have been supplemented since 1974 with a more complete personal data inventory, the Life Complexity Inventory (LCI), which includes topics such as major work circumstances (with home-making defined as a job) friends and social interactions, daily activities, travel experiences, physical environment and life-long educational pursuits. The battery was expanded in 1991 by adding the Moos Family Environment and Work Scales, and a family contact scale. A Health Behavior Questionnaire was added in 1993.

In the 1975 collateral study, a number of measures from the ETS kit of factor referenced tests as well as the 1962 revision of the PMA were added. Of these the Identical Picture, Finding A's and Hidden Pattern tests were included in the fourth (1977) SLS cycle.

To be able to explore age changes and differences in factor structure, multiple markers for most abilities were included during the fifth (1984) cycle. Also measures of Verbal Memory were added. This now permits an expanded cognitive battery to measure the primary abilities of Verbal Comprehension, Spatial Orientation, Inductive Reasoning, Numerical Facility, Perceptual, Speed and Verbal Memory at the latent construct level. Also added were a criterion measure of “real life tasks,” the ETS Basic Skills test (Educational Testing Service, 1977), and a scale for measuring participants' subjective assessment of ability changes between test cycles. Beginning in 1997 the Everyday Problems Test (EPT) was substituted for the Basic Skills test, since the more recent test was specifically constructed for work with adults and has been related to measures of the Instrumental Activities of Daily Living (IADL).

The fifth cycle (1984) of the SLS marked the designing and implementation of cognitive training paradigms to assess whether cognitive training in the elderly serves to remediate cognitive decrement or increase levels of skill beyond those attained at earlier ages. (See Schaie, K. W., and Willis, S. L., ISSBD Bull. 2010; 57(1): 24-29). The database available through the fifth cycle also made it possible to update the normative data on age changes and cohort differences and to apply sequential analysis designs controlled for the effects of experimental mortality and practice. Finally, this cycle saw the introduction of measures of practical intelligence analyses of marital assortativity using data on married couples followed over as long as 21 years, and the application of event history methods to hazard analysis of cognitive change with age.

Throughout the history of the SLS, an effort now extending over 47 years, the focus has been on five major questions, which investigators have asked with greater clarity and increasingly more sophisticated methodologies at each successive stage of the study: (1) Does intelligence change uniformly through adulthood, or are there different life course ability patterns; (2) At what age is there a reliably detectable decrement in ability, and what is its magnitude?; (3) What are the patterns of generational differences, and what is their magnitude?; (4) What accounts for individual differences in age-related change in adulthood?; and (5) Can intellectual decline with increasing age be reversed by educational intervention?. These are summarized in turn below:

(1) Does Intelligence Change Uniformly Through Adulthood, or are there Different Life Course Ability Patterns?

The SLS studies have shown that there is no uniform pattern of age-related changes across all intellectual abilities, and that studies of an overall Index of Intellectual Ability (IQ) therefore do not suffice to monitor age changes and age differences in intellectual functioning for either individuals or groups. The data do lend some support to the notion that fluid abilities tend to decline earlier than crystallized abilities. However, there are, important ability-by age, ability-by-gender, and ability-by-cohort interactions that complicate matters. Moreover, whereas fluid abilities begin to decline earlier, crystallized abilities appear to show steeper decrement once the late 70s are reached.

Although cohort-related differences in the rate and magnitude of age changes in intelligence remained fairly linear for cohorts who entered old age during the first three cycles of our study, these differences have since shown substantial shifts. For example, rates of decremental age change have abated somewhat, and at the same time modestly negative cohort trends are beginning to appear as we begin to study members of the baby boom generation. Also, patterns of socialization unique to a given gender role in a specific historical period may be a major determinant of the pattern of change in abilities.

More fine grained analyses suggested that there may be substantial gender differences as well as differential changes for those who decline and those who remain sturdy when age changes are decomposed into accuracy and speed. With multiple markers of abilities, we have conducted both cross-sectional and longitudinal analyses of the invariance of ability structure over a wide age range. In cross-sectional analyses, it is possible to demonstrate configural but not metric factor invariance across wide age/cohort ranges. In longitudinal analyses, metric invariance obtains within cohorts over most of adulthood, except for the youngest and oldest cohorts. Finally, we examined the relationship of everyday tasks to the framework of practical intelligence and perceptions of competence in everyday situations facing older persons.

(2) At What Age is there a Reliably Detectable Decrement in Ability, and What is its Magnitude?

It has been generally observed that reliably replicable average age decrements in psychometric abilities do not occur prior to age 60, but that such reliable decrement can be found for all abilities by 74 years of age. Analyses from the most recent phases of the SLS, however, suggested that small but statistically significant average decrement can be found for some, but not all, cohorts beginning in the sixth decade. However, more detailed analyses of individual differences in intellectual change demonstrated that, even at age 81, fewer than half of all observed individuals have shown reliable decremental change over the preceding 7 years. In addition, average decrement below age 60 amounts to less than 0.2 of a standard deviation; by 81 years of age, average decrement rises to approximately 1 population standard deviation for most variables.

As data from the SLS cover more cohorts and wider age ranges within individuals, they attain increasing importance in providing a normative base to determine at what ages declines reach practically significant levels of importance for public policy issues. Thus, these data have become relevant to issues such as mandatory retirement, age discrimination in employment, and prediction of proportions of the population that can be expected to live independently in the community. These bases will shift over time because we have demonstrated in the SLS that both level of performance and rate of decline show significant age-by-cohort interactions.

(3) What are the Patterns of Generational Differences, and What is their Magnitude?

Results from the SLS have conclusively demonstrated the prevalence of substantial generational (cohort) differences in psychometric abilities. These cohort trends differ in magnitude and direction by ability and therefore cannot be determined from composite IQ indices. As a consequence of these findings, it was concluded that cross-sectional studies used to model age change would overestimate age changes prior to the 60s for those variables that show negative cohort gradients and underestimate age changes for those variables with positive cohort gradients.

Studies of generational shifts in abilities have in the past been conducted with random samples from arbitrarily defined birth cohorts. As a supplement and an even more powerful demonstration, we have also conducted family studies that compared performance levels for individuals and their adult children. By following the family members longitudinally, we are also able to provide data on differential rates of aging across generations. In addition, we have also recruited siblings of our longitudinal participants to obtain data that allow extending the knowledge base in the developmental behavior genetics of cognition to the adult level by providing data on parent-offspring and sibling correlations in adulthood.

(4) What Accounts for Individual Differences in Age-Related Change in Adulthood?

The most powerful and unique contribution of a longitudinal study of adult development arises from the fact that only longitudinal data permit the investigation of individual differences in antecedent variables that lead to early decrement for some persons and maintenance of high levels of functioning for others into very advanced age.

A number of factors that account for these individual differences have been implicated; some of these have been amenable to experimental intervention. The variables that have been implicated in reducing risk of cognitive decline in old age have included (a) absence of cardiovascular and other chronic diseases; (b) a favorable environment mediated by high socioeconomic status; (c) involvement in a complex and intellectually stimulating environment; (d) flexible personality style at midlife; (e) high cognitive status of spouse; and (f) maintenance of high levels of perceptual processing speed.

(5) Can Intellectual Decline with Increasing Age be Reversed by Educational Intervention?

Because longitudinal studies permit tracking stability or decline on an individual level, it has also been feasible to carry out interventions designed to remediate known intellectual decline as well as to reduce cohort differences in individuals who have remained stable in their own performance over time but who have become disadvantaged when compared with younger peers. Findings from the cognitive training studies conducted with our longitudinal subjects suggested that observed decline in many community-dwelling older people might well be a function of disuse and is clearly reversible for many. Indeed, cognitive training resulted in approximately two-thirds of the experimental subjects showing significant improvement; and about 40% of those who had declined significantly over 14 years were returned to their pre-decline level. In addition, we were able to show that we did not simply “train to the test” but rather trained at the ability (latent construct) level, and that the training did not disturb the ability structure. We have now extended these studies to include both a 7-year and a 14-year follow-up that suggest the long-term advantage of cognitive interventions.

The Advanced Cognitive Training for Independent and Vital Elderly (ACTIVE) Trial:

A large-scale multicenter, randomized, controlled cognitive intervention trial, sponsored by the National Institute on Aging and the National Institute of Nursing Research, called The Advanced Cognitive Training for Independent and Vital Elderly (ACTIVE) study, followed 2,832 people age 65 to about 94 in six U.S. metropolitan areas for ten years after they received 10 sessions of targeted cognitive training. The primary objective of the ACTIVE trial was to test the effectiveness and durability of three distinct cognitive interventions (i.e., memory training, reasoning training, or speed-of-processing training) in improving the performance of elderly persons on basic measures of cognition and on measures of cognitively demanding daily activities (e.g., instrumental activities of daily living (IADL) such as food preparation, driving, medication use, financial management). These interventions previously had been found successful in improving cognitive abilities under laboratory or small-scale field conditions.

The results of a two-year follow-up of the ACTIVE study were reported by Ball et al. (See Ball K., et al., JAMA, 2002 November 13; 288(18): 2271-2281). ACTIVE was a randomized controlled, single-blind trial, using a four-group design, including three treatment groups and a control group. Ball et al. reported that each intervention group received a 10-session intervention, conducted by certified trainers, for one of three cognitive abilities—memory, inductive reasoning, or speed of processing. Assessors were blinded to participant intervention assignment. Training exposure and social contact were standardized across interventions so that each intervention served as a contact control for the other two interventions. Booster training was provided to a random sub sample in each intervention group. Measurement points consisted of baseline tests, an immediate posttest (following the intervention), and A1 and A2 annual posttests.

Memory training focused on verbal episodic memory. Participants were taught mnemonic strategies for remembering word lists and sequences of items, text material, and main ideas and details of stories. Participants received instruction in a strategy or mnemonic rule, exercises, individual and group feedback on performance, and a practice test. For example, participants were instructed how to organize word lists into meaningful categories and to form visual images and mental associations to recall words and texts. The exercises involved laboratory like memory tasks (e.g., recalling a list of nouns, recalling a paragraph), as well as memory tasks related to cognitive activities of everyday life (e.g., recalling a shopping list, recalling the details of a prescription label). Reasoning training focused on the ability to solve problems that follow a serial pattern. Such problems involve identifying the pattern in a letter or number series or understanding the pattern in an everyday activity such as prescription drug dosing or travel schedules. Participants were taught strategies to identify a pattern and were given an opportunity to practice the strategies in both individual and group exercises. The exercises involved abstract reasoning tasks (e.g., letter series) as well as reasoning problems related to activities of daily living. Speed-of-processing training focused on visual search skills and the ability to identify and locate visual information quickly in a divided-attention format. Participants practiced increasingly complex speed tasks on a computer. Task difficulty was manipulated by decreasing the duration of the stimuli, adding either visual or auditory distraction, increasing the number of tasks to be performed concurrently, or presenting targets over a wider spatial expanse. Difficulty was increased each time a participant achieved criterion performance on a particular task.

Eleven months after the initial training was provided, booster training was offered to a randomly selected 60% of initially trained subjects in each of the 3 intervention groups. Booster training was delivered in four 75-minute sessions over a two to three-week period. Consistent with results of the primary analyses, secondary analyses indicated large immediate intervention gains on the cognitive outcomes. Eighty-seven percent of speed trained, 74% of reasoning-trained, and 26% of memory-trained participants demonstrated reliable improvement on the pertinent cognitive composite immediately following intervention. While intervention participants showed reliable posttest gains, a comparable proportion of control participants also improved, and the proportion of control participants exhibiting reliable retest gain remained fairly constant across study intervals. In terms of the proportion of the intervention group showing reliable gain in the trained domain, booster effects occurred for the speed conditions (boost, 92%; no boost, 68%; control, 32%) and the reasoning conditions (boost, 72%; no boost, 49%; control, 31%). While some dissipation of intervention effects occurred across time, cognitive effects were maintained from baseline to A2, particularly for boosted participants (79% [speed boost] vs. 37% [controls]; 57% [reasoning boost] vs 35% [controls]).

Willis et al. reported data obtained from a five-year follow-up of the ACTIVE study (See Willis et al., JAMA. 2006 December 20; 296(23): 2805-2814). Cognitive outcomes assessed the effects of each intervention on the cognitive ability trained. Memory training outcomes involved three measures of verbal memory ability: Hopkins Verbal Learning Test, Rey Auditory-Verbal Learning Test, and the Rivermead Behavioral Paragraph Recall test. Reasoning training outcomes involved three reasoning ability measures: letter series, letter sets, and word series. Speed of processing training outcomes involved three useful field of view subscales.

Functional outcomes assessed whether the cognitive interventions had an effect on daily function. Everyday functioning represented the participant's self-ratings of difficulty (IADL difficulty from the Minimum Data Set—Home Care and ranged from “independent” to “total dependence” on a 6-point scale) in completing cognitively demanding tasks involved in meal preparation, house-work, finances, health maintenance, telephone use, and shopping. Two performance-based categories of daily function were also assessed. Everyday problem solving assessed ability to reason and comprehend information in common everyday tasks (e.g., identifying information in medication labels). Performance was measured with printed materials (e.g., yellow pages, using the Everyday Problems Test) and behavioral simulations (e.g., making change, using the Observed Tasks of Daily Living). These measures were hypothesized to be most closely related to reasoning and memory abilities due to their task demands. Everyday speed of processing assessed participants' speed in interacting with real world stimuli (e.g., looking up a telephone number, using the Timed IADL Test), and the ability to react quickly to 1 of 4 road signs (Complex Reaction Time Test), which was hypothesized to be the most closely related to speed of processing.

Data obtained from the five-year follow-up study showed that each intervention produced immediate improvement in the cognitive ability trained that was retained across five years. Similarly, when controlling for baseline age and cognitive function, booster training for the reasoning and speed of processing groups produced significantly better performance (net of initial training effect) on their targeted cognitive outcomes that remained significant at five years. Further, training effects on daily functioning showed that for self-reported IADL difficulty, at year five, participants in all three intervention groups reported less difficulty compared with the control group in performing IADL. However, this effect was significant only for the reasoning group, which compared with the control group had an effect size of 0.29 (99% CI, 0.03-0.55) for difficulty in performing IADL. Neither speed of processing training (effect size, 0.26; 99% CI, −0.002 to 0.51) nor memory training (effect size, 0.20; 99% CI, −0.06 to 0.46) had a significant effect on IADL. Group mean IADL difficulty ratings improved through the first two years of the study (baseline through year two). The decline in function for all groups is first evident between years two and three. From years three to five, the decline is dramatically accelerated for the control group and to a lesser extent for the three treatment groups.

Willis et al. concluded that declines in cognitive abilities have been shown to lead to increased risk of functional disabilities that are primary risk factors for loss of independence. The five-year results of the ACTIVE study provide limited evidence that cognitive interventions can reduce age-related decline in self-reported IADLs that are the precursors of dependence in basic ADLs associated with increased use of hospital, outpatient, home health, and nursing home services and health care expenditures. The authors concluded that these results are promising and support future research to examine if these and other cognitive interventions can prevent or delay functional disability in an aging population.

Reasoning Training in the ACTIVE Study:

In light of the ACTIVE findings of five-year durability of training effects and some transfer to everyday functioning, there has been considerable interest in further examination of the characteristics of individuals profiting from reasoning training and of issues of dosing, including adherence with training and added effects of booster training.

To follow-up on the data obtained from the five-year follow-up of the ACTIVE study, Willis and Caskie reported employing piecewise growth models from baseline to the 5th annual follow-up to examine the five-year trajectory separately for the reasoning training group. (See Willis, S. L. and Caskie, G. I. L., J Aging Health. 2013 December; 25(8 0)). Although only the reasoning composite score was used in the prior studies to represent the proximal outcome of the reasoning training, Willis and Caskie's study reported findings for both the composite and three individual reasoning tests (letter series, letter sets, and word series). Their study addressed three major questions with regard to the reasoning training group within the ACTIVE trial. 1) What was the impact of training on the trajectory of the reasoning trained group from baseline to five-year follow-up? 2) Did adherence with training and booster sessions influence training outcomes? 3) What covariates were significant predictors of training effects?

The dependent variables in Willis and Caskie's cognitive outcome analysis were: three reasoning measures and a composite score of the three measures. The Letter Series test requires participants to identify the pattern in a series of letters and circle the letter that comes next in the series. The Word Series test requires participants to identify the pattern in a series of words, such as the month or day of the week, and circle the word that comes next in the series. The Letter Sets test requires participants to identify which set of letters out of 4 letter sets does not follow the pattern of letters. For the Reasoning Composite, each of the 3 reasoning measures was standardized to its baseline value, and an average of the equally weighted standardized scores was calculated.

The dependent variables in Willis and Caskie's functional outcome analysis were: two measures of everyday reasoning/problem-solving abilities—the Everyday Problems Test (EPT), and the Observed Tasks of Daily Living (OTDL); and two measures of everyday speed of processing—the Complex Reaction Time test (CRT) and the Timed Instrumental Activities of Daily Living (TIADL). Lower scores on the CRT and TIADL reflected better performance. The covariates were: baseline Mini-Mental State Exam (MMSE), self-rated health, age, education, and gender.

The adherence indicators were: Participants were considered compliant with initial training if they participated in at least 80% of the training sessions (i.e., 8-10 sessions). Adherence with the booster training sessions at the 1st annual and 3rd annual follow-up assessments was indicated by participation in at least three of the four sessions; participants not randomly assigned to booster training were given missing values for the booster adherence variables.

The reasoning training program focused on improving the ability to solve problems that require linear thinking and that follow a serial pattern or sequence. Such problems involve identifying the pattern in a series of letters or words. Participants were taught strategies (e.g., underlining repeated letters, putting slashes between series, indicating skipped items in a series with tick marks) to identify the pattern or sequence involved in solving a problem; they used the pattern to determine the next item in the series. Participants practiced the strategies in both individual and group exercises. Exercises involved both abstract reasoning tasks (e.g., letter series) and reasoning problems related to activities of daily living (e.g., identifying medication dosing pattern).

Willis and Caskie's results showed training resulted in a significant positive training effect for all reasoning measures, which were maintained though the fifth annual follow-up. A significant third annual booster effect was one-half the size of the training effect. Additionally, training adherence resulted in greater training effects. Covariates such as higher education, Mini-Mental State Exam (MMSE), better health and younger age related to higher baseline performance. Finally, a significant functional outcome included training effects for the Complex Reaction Time (CRT), and first annual booster effects for the CRT and Observed Tasks of Daily Living (OTDL).

It is noteworthy that the ACTIVE study was the first large-scale randomized trial to show that cognitive training improves cognitive functioning in well-functioning older adults, and that this improvement lasts up to 5 years follow up. Prior smaller intervention studies had documented significant immediate effects of training; the ACTIVE trial using intent-to-treat analyses replicated these findings. However, prior training research had not carefully examined issues of adherence with training and the effect of temporally-spaced booster sessions. Prior studies had seldom reported the proportion of participants compliant with the intervention or whether adherence enhanced the intervention effect. The significant effect of adherence indicates that the dosing of the intervention is an important factor in its effectiveness. The finding that the three-year booster sessions resulted in an effect approximately half the size of the initial training is informative, given that the number of booster sessions was 60% of the intensity of the initial training and the participants were three years older, on average in their mid-to-late seventies. The efficacy of the delayed booster suggests that maintenance of training effects may indeed extend beyond the five year follow-up, underscoring the importance of following this sample into old-old age.

Ten-Year Effects of the ACTIVE Cognitive Training Trial on Cognition and Everyday Functioning in Older Adults:

The results of a ten-year follow-up of the ACTIVE study were reported by Rebok et al. (See Rebok., et al., JAGS, January 2014—Vol. 62, No. 1). In the ACTIVE trial, 10 to 14 weeks of organized cognitive training delivered to community-dwelling older adults resulted in significant improvements in cognitive abilities and better preserved functional status (memory group: effect size=0.48, 99% CI=0.12-0.84; reasoning group: effect size=0.38, 99% CI=0.02-0.74; speed of processing group: effect size=0.36, 99% CI=0.01-0.72) than in non-trained persons 10 years later. Each training intervention produced large and significant improvements in the trained cognitive ability. These improvements dissipated slowly but persisted to at least 5 years for memory training (memory training effects were no longer maintained for memory performance after 5 years) and to 10 years for reasoning (effect size=0.23, 99% CI=0.09-0.38) and speed-of-processing (effect size=0.66, 99% CI=0.43-0.88) training Booster training produced additional and durable improvement for the reasoning intervention for the reasoning performance (effect size=0.21, 99% CI=0.01-0.41) and the speed-of-processing intervention for the speed-of-processing performance (effect size=0.62, 99% CI=0.31-0.93). This is the first demonstration of long-term transfer of the training effects on cognitive abilities to daily functions.

Unlike for the non-trained participants, at a mean age of 82 years old, cognitive function for the majority of the reasoning and speed-trained participants was at or above their baseline level for the trained cognitive ability 10 years later. A significant percentage of participants in all trained groups (>60%) continue to report less difficulty performing IADLs than (49%) non-trained participants controls (P<0.05). After 10 years, 60% to 70% of participants were as well off as or better off than when they started (less decline in self-reported IADL compared with the non-trained control group).

In summary, this is the first multi-site (six U.S. cities) large-scale (2,832 volunteer persons—mean baseline age: 73.6; 26% African American—living independently) randomized, controlled single blind trial carried to demonstrate a long-term transfer of the training effects on cognitive abilities to daily functions. Results at 10 years demonstrate that cognitive training has beneficial effects on cognitive abilities and on self-reported IADL function. These results provide support for the development of other interventions targeting cognitive abilities that hold the potential to delay the onset of functional decline and possibly dementia and are consistent with comprehensive geriatric care that strives to maintain and support functional independence.

Cognitive Decline or Excess Knowledge:

Aging adults' performance on many psychometric tests supports the finding that cognitive information-processing capacities decline across adulthood, and that the brain slows down due to normal aging causes. Imaging studies show clearly that even healthy aging brains experience neural shrinkage in areas that are related to learning, reason and memory.

Despite the above, there might be additional reasons for the slowing down of the aging brain. First, it could well be that an older mind organizes information differently from a mind of a 20 years old. Secondly, it might simply be that it takes older minds longer to retrieve the right bits of information since they have accumulated a larger semantic reserve.

The theory of age-related positivity effect provides further theoretical and clinical support in favor of the theory that maintains that older brains think and process information in a different manner than young brains (See Andrew E. Reed, Laura L. Carstensen (2012). Front. Psychol. 3:339). The “positive effect” refers to an age-related trend that favors positive over negative stimuli in cognitive processing. Relative to their younger counterparts, older people attend to and (tend to) remember more positive than negative information (negative information is more cognitive demanding (See Labouvie-Vief et al. 2010, The Handbook of Life-Span Development, Vol. 2, eds R. M. Lerner, M. E. Lamb, and A. M. Freund Hoboken: John Wiley & Sons, Inc.), 79-115.). Researchers came to the conclusion that the “positive effect” in the older aging brain represents controlled processing, rather than cognitive decline.

Ramscar argues that older adults will exhibit greater sensitivity to the fine-grained properties of test items (in lexical decision and naming data, older adults show greater sensitivity to differences in item properties in comparison to younger adults (See M. Ramscar et al. Topics in Cognitive Science 6 (2014) 5-42). For example, hard pair association e.g., jury-eagle versus an easy pair association e.g., baby-cries (See Des Rosiers, G., & Ivison, D. (1988). Journal of Clinical Experimental Neuropsychology, 8, 637-642.). Therefore, the patterns of response change that are typically considered as evidence for and measure of cognitive decline, stem out of basic principles of learning and emerge naturally in learning models as adults acquire more knowledge. More so, Ramscar strongly argues that psychometric tests do not take account of the statistical skew of human experience, or the way knowledge increases with experience as we age. Therefore, he remains very skeptical concerning the use of psychometric tests as strong indicative or proof of cognitive decline in older individuals.

It is widely accepted that crystalized knowledge climbs sharply between ages 20 and 50 and then plateaus, even as fluid intelligence drops steadily, by more than 50 percent between ages 20 and 70, in some studies. In light of the above, the present subject matter acknowledges and addresses the fact that the overwhelming amount of acquired crystalized knowledge (verbal—declarative knowledge concerning expanded vocabulary, knowledge of low frequency words and fixed predictability outcomes from semantic knowledge) along adulthood, becomes a critical detrimental information processing backlog in the older aging brain. More so, that the information processing backlog takes place at a time when there is also a pronounced decline of fluid knowledge. In the long run, this situation promotes an inverse relationship between the continual growth of crystalized knowledge versus the continual decline of fluid knowledge, a situation that is too cognitively taxing to be sustained physiologically. It does not take too long before the physiologically uncontrolled proliferation of crystalized intelligence forces fixed patterns of cognitive stiff behaviors. These stiff cognitive behaviors rely heavily on semantic and episodic information retrieval from memory when the aging individual copes with everyday problem solving and demanding daily tasks. More so, these stiff cognitive behaviors also swell negative information processing demands in the older aging brain that inevitably increase its risk for gravitating into neuropathology.

In light of the above, the subject matter disclosed herein reveals a non-pharmacological approach directed to promote novel strategies in the aging brain, mainly concerning fluid intelligence abilities, via the performance of a new platform of alphanumeric exercises. Further, recurrent performance of the presently disclosed novel non-pharmacological technology diminishes detrimental cognitive information processing demands and disrupts fixed pattern loops of sensorial-motor-perceptual repetitive habitual behaviors (e.g., a healthy aging person and the elderly will start acting favorably in a less predicted, routine-like manner and will display more varied novel reactions) stemming from a lifetime of accumulated crystalized knowledge (particularly crystalized knowledge related to expectations derived from non-flexible declarative knowledge constructs e.g., word associations).

In summary, the subject matter disclosed herein provides a practical and novel cognitive training approach that combines both point of views formulated by theoretical researchers in respect to the status of cognitive functional abilities in the aging brain (whether the aging brain experiences cognitive decline or simply knows too much).

The present subject matter provides a novel non-pharmacological technology which implementation is of immediate survival benefit for the older healthy and non-healthy aging brains. The presently disclosed non-pharmacological technology provides cognitive training of a novel platform of alphanumeric exercises aimed to promote a variety of fluid intelligence abilities in healthy, MCI, mild Dementia and Alzheimer's aging subjects.

Cognitive Decline—Normal Versus Pathological.

Normal aging is associated with a decline in various memory abilities in many cognitive tasks; the phenomenon is known as Age-related Memory Impairment (AMI) or Age-Associated Memory Impairment (AAMI). Memory functions which decline with age are: (a) Working memory (e.g., holding and manipulating information in the mind, as when reorganizing a short list of words into alphabetical order; verbal and visuospatial working speed, memory and learning; visuospatial cognition is more affected by aging than verbal cognition); (b) Episodic memory (e.g., personal events and experiences); (c) Processing speed; (d) Prospective memory, i.e., the ability to remember to perform a future action (e.g., remembering to fulfill an appointment or take a medication); (e) Ability to remember new textual information, to make inferences about new textual information, to access prior knowledge in long-term memory, and to integrate prior knowledge with new textual information; and (f) Recollection.

During a person's twenties, brain cells begin to gradually die off and the body starts producing smaller amounts of the chemicals needed for memory function. In fact, the brain produces 15% to 20% fewer neurotransmitters, chemicals that transfer messages between neurons. However, these chemical changes do not affect a person's ability to lead a normal life and any resulting memory loss does not worsen noticeably over time. Occasional memory lapses, such as forgetting why you walked into a room or having difficulty recalling a person's name, become more common as we approach our 50's and 60's. One widely cited study (Larrabee G J, Crook T H 3rd. Estimated prevalence of age-associated memory impairment derived from standardized tests of memory function. Int Psychogeriatr. 1994 Spring; 6(1):95-104.) estimates that more than half of the people over 60 have “age-associated memory impairment,” and finds that this type of memory loss is prevalent in younger groups as well. In short, it's comforting to know that this minor forgetfulness is a normal sign of aging, not a sign of dementia.

But other types of memory loss, such as forgetting appointments or becoming momentarily disoriented in a familiar place, may indicate mild cognitive impairment (MCI). MCI involves memory loss that is more severe than what is considered normal for the aging process and it falls somewhere between age-associated memory impairment and early dementia. In MCI, there is measurable memory loss, but that loss does not interfere with a patient's everyday life, in terms of the ability to live independently, but the patient might become less active socially. MCI is not severe enough (does not include cognitive problems/symptoms associated with dementia, such as disorientation or confusion about routine activities) to be diagnosed as dementia. In many cases, memory loss in people with MCI does worsen, however, and studies suggest that approximately 10-15% of people with MCI eventually develop Alzheimer's disease. MCI also affects a person's language ability, judgment, and reasoning. Prevalence and incidence rates of MCI vary as a result of different diagnostic criteria as well as different sampling and assessment procedures (Petersen et al, 2001. Current concepts in mild cognitive impairment. Arch Neurol 58: 1985-1992.).

Precise understanding/awareness of the magnitude and pattern of MCI is of importance because early intervention might delay progression to Alzheimer's disease, the most common type of dementia. People with MCI develop dementia at a rate of 10-15% per year, while the rate of memory loss for healthy aging individuals is 1-2% per year (Ibid). It is estimated that approximately 20% of people over the age of 70 have MCI.

Dementia is the most serious form of memory impairment, a condition that causes memory loss that interferes with a person's ability to perform everyday tasks. In dementia, memory becomes impaired, along with other cognitive skills, such as language use (e.g., inability to name common objects), judgment (e.g., time and place disorientation), and awareness (ability to recognize familiar people). The most common type of dementia is Alzheimer's disease.

Alzheimer's disease affects 5.3 million Americans and is the sixth leading cause of death in the United States. According to the Alzheimer's Association, by the year 2030 as many as 7.7 million Americans will be living with Alzheimer's disease if no effective prevention strategy or cure is found. By 2050, the number is projected to skyrocket to 11-16 million. Ten million baby boomers are expected to develop the disease. According to Alzheimer's Disease International, approximately 30 million people worldwide suffer from dementia and about two-thirds of them live in developing countries. In people younger than 65 years of age, dementia affects about 1 person in 1000. In people over the age of 65, the rate is about 1 in 20, and over the age of 80, about 1 in 5 people have dementia. According to the National Institute of Aging, between 2.4 and 4.5 million people in the United States have Alzheimer's disease.

TABLE 1
Some examples of the types of memory problems common in normal age-
related forgetfulness, mild cognitive impairment, and dementia:

Normal Age-Related Forgetfulness
Sometimes misplaces keys, eyeglasses, or other items.
Momentarily forgets an acquaintance's name.
Occasionally has to “search” for a word.
Occasionally forgets to run an errand.
May forget an event from the distant past.
When driving, may momentarily forget where to turn; quickly orients self.
Mild Cognitive Impairment (MCI)
Frequently misplaces items.
Frequently forgets people's names and is slow to recall them.
Has more difficulty using the right words.
Begins to forget important events and appointments.
May forget more recent events or newly learned information.
May temporarily become lost more often. May have trouble understanding
and following a map.
Worries about memory loss. Family and friends notice the lapses in
memory.
Dementia
Forgets what an item is used for or puts it in an inappropriate place.
May not remember knowing a person.
Begins to lose language skills. May withdraw from social interaction.
Loses sense of time. Doesn't know what day it is.
Has serious impairment of short-term memory. Has difficulty learning and
remembering new information.
Becomes easily disoriented or lost in familiar places, sometimes for hours.
May have little or no awareness of cognitive problems.

Cognitive decline manifests as shortcomings related to simple reasoning about items relationships, visual-spatial abilities and working and episodic/verbal memory.

Reasoning decline manifests as a decline or a compromise in the ability to perform tasks (exercises) involving simple reasoning relationships, e.g., tasks related to inferring into the future the next immediate action/step (or a number of future actions/steps) in a process involving a number of past correlated actions/steps (e.g., figuring out the next number/letter/shape in a series of numbers/letters/shapes).

Memory decline manifests as an inability to solve or ameliorate learning gridlocks arising from cognitive functions such as working/short-term memory (e.g., processing, storage, retrieval and/or disposal of relevant/irrelevant information.) Memory decline resulting in learning domain problems is manifested by, e.g., alphabet learning; forgetting lengthy instructions; place keeping errors (e.g., missing out letters or words in sentences); failure to cope with simultaneous processing and storage demands.

Visual-spatial decline manifests as e.g., difficulty in complex pattern recognition; difficulty in arranging picture pieces of different/same shapes and sizes together to assemble a complete picture (shape closure, e.g., cannot do puzzles); difficulty to follow complex spatial directions; and recollection of objects' spatial location (misplacement of car keys, wallet, watch, etc.)

In one aspect, the subject matter disclosed herein provides a non-pharmacological approach to enhance and enable cognitive competences via delaying or preventing working/short-term memory decline.

The term working memory (WM) refers to a brain system that provides temporary storage and manipulation of the information necessary for such complex cognitive tasks as, language comprehension, learning, and reasoning. It is widely accepted that WM has been found to require the simultaneous storage and processing of information. The central executive component of working memory, which is assumed to be an attentional-controlling system, is significant/crucial in skills such as learning an alphabet and is particularly susceptible to the effects of Alzheimer's disease. WM is strongly associated with cognitive development and research shows that its capacity tends to drop with old age and that such decline begins already at the early age of 37 in certain populations. That is, the potential market for delaying memory decline in normal aging population is about 50% of the total global population.

In another aspect, the subject matter disclosed herein provides a novel non-pharmacological cognitive training to hinder forgetfulness and cognitive ability loss in normal aging baby boomers by promoting brain (neuronal) plasticity. Brain/neuronal plasticity refers to the brain's ability to change in response to experience, learning and thought. The most accepted evidence about the occurrence of brain plasticity is when training increases the thickness or volume of neural structures (Boyke et al. Training-Induced Brain Structure Changes in the Elderly. The Journal of Neuroscience, Jul. 9, 2008; 28(28):7031-7035; 7031). However, a more common finding is a change in neural activity with mental training. The change can be manifested in the activation of new regions or in measurements of decrease or increase of neural activity in task-related structures that were activated before the training There is a body of overwhelming literature suggesting that enhanced neural activity is facilitated for old adults, and there are data supporting the finding that training enhances neural activation and behavioral function in older adults (Nyberg et al. Neural correlates of training-related memory improvement in adulthood and aging. Proc Natl Acad Sci USA. 2003; 100(23):13728-13733 and Carlson et al. Evidence for neurocognitive plasticity in at-risk older adults: the experience corps program. J Gerontol Biol Med Sci. 2009; 64(12):1275-1282.). In short, as the brain receives specific sensorial input, it physically changes its structure, e.g., via forming new neuronal connections.

In another aspect, the subject matter disclosed herein provides a novel non-pharmacological, non-invasive sensorial biofeedback psychomotor application designed to exercise and recreate the developmentally early neuro-linguistic aptitudes of an individual that can be effective in slowing down aging and restoring optimal neuroperformance.

Early Childhood Language Development:

Scientists have found that language development begins before a child is even born, as a fetus is able to identify the speech and sound patterns of the mother's voice. By the age of four months, infants are able to differentiate sounds and even read lips. Infants are able to distinguish between speech sounds from all languages, not just the native language spoken in their homes. Nonetheless, this remarkable ability disappears around the age of 10 months and children begin to only recognize the speech sounds of their native language. By the time a child reaches age three, he or she will have a vocabulary of about 3,000 words.

Ontology of Cognitive Development:

The current understanding of cognitive development stages in humans is loosely based on observations by Piaget (Piaget's stages). Piaget identified four major stages during the cognitive development of children and adolescents: sensorimotor (birth—2 years old), preoperational (2-7 years old), concrete operational (7-11 years old) and formal operational (adolescent to adult). Piaget believed that at each stage, children demonstrate new intellectual abilities and increasingly complex understanding of the world.

The first stage, sensorimotor, involves the use (acting) of sensorial, motor, and perceptual activities (i.e., modal systems), without the use of symbols, e.g., alphabets, numbers, or other representations, (i.e., amodal systems). At the sensorimotor stage, because acquaintance/familiarity with objects or symbols is absent or limited at this stage, infants cannot predict reaction, and therefore must constantly experiment and learn reaction through trial and error. Importantly, early language development begins during this stage.

Thus, at this first stage, infants perform (execute/deploy) actions for the sake of action (i.e., an action performed without any objective or end goal). Notably, while infants successfully implement (act) sensory-motor kinematics in their egocentric space, these sensory-motor kinematics establish informational interrelations, correlations and cross-relations among manipulated objects and at this stage, the infants do so by relying solely on limited information namely information limited to the sensory-kinematical properties of the manipulated objects, without the benefit of familiarity/understanding, or awareness of the representational capacity that symbols can directly afford to the manipulated objects. In other words, infants engage in fluid intelligence operations of inductive “reasoning processes kind,” deploying or executing sequences of actions with manipulated objects, without really understanding why they are acting this or that way with the said objects and this is what is herein meant by deploying actions for the sake of actions (also referred to herein as “motor-motion for the sake of motor-motion”), without the benefit of the representational powers (knowledge) of symbols related to the sensory-motor manipulated objects.

Language development is one of the hallmarks of preoperational stage (2-7 years old period) where memory and imagination also develop. In this stage, children engage in “make believe” and can understand and express basic relationships between the past and the future. More complex temporal relationships and concepts linking past-present and future, such as cause and effect relationships, have not yet been learned at this stage. In relation to the latter said, fluid Intelligence can be characterized as egocentric, intuitive and illogical. In the later stages of cognitive development, the concrete operational stage (ages 7-11) and formal operational stage (adolescent to adult), crystalized intellectual development is achieved through the use of logical and systematic manipulation of representational informational qualities/attributes of symbols. Thus, it can be said that the cognitive edifice is finally formed when the representational power of symbols is introduced into the cognitive landscape. While in the concrete operational stage symbols are related to concrete objects and thinking involves concrete references, in the formal operational stage symbols are related to abstract concepts and thinking involves abstract informational relationships and concepts.

According to Piaget, when formal operational thought is attained, no new structures are needed. Intellectual development in adults is therefore thought to proceed by developing more complex schema through the addition of symbolic knowledge. However, as discussed below, the process of neuronal “pruning” that occurs during normal ontological development of the brain inherently places enormous limitations and challenges, which restrain the nature and amount of additional formal operational knowledge acquired in adulthood, even more pronounced/particularly when the aging brain is facing pathological changes, e.g., neuro-degeneration.

The non-pharmacological technology disclosed herein addresses this challenge via a new kind of cognitive training that enhances the predisposition for the implicit acquisition of new fluid intelligence performance and competence subsequently promoting neural-linguistic plasticity mainly via novel inductive reasoning strategies that administer to a subject in need thereof, a novel neuro-linguistic cognitive platform supported by novel serial and statistical properties of the alphabet and natural numbers. This can be achieved effectively via novel interactive computer-based cognitive training regimens, which promote neuronal plasticity across functionally different and distant areas in the brain, particularly hemispheric-related neural-linguistic plasticity.

With respect to the stages of cognitive development described above, it is noteworthy to mention that in despite of the fact that there is no explicit learning awareness at the sensorimotor stage (i.e., fluid intelligence “inductive reasoning” stage), early language development begins during this stage. The conceptual understanding of fluid intelligence operational competences such as inductive reasoning and spatial orienting abilities and their temporal relationship to early language development, is a key feature on which the non-pharmacological technology disclosed herein is based (it's undeniable the seminal role played by fluid intelligence skills principally inductive-deductive reasoning and spatial orienting abilities in the early shaping of language acquisition. More so, efficient processing speed of sensorial-perceptual information and how this information is manipulated and retrieve from memory (e.g., alphanumeric information manipulation in working memory and retrieval from long term memory) are developmental markers sub-serving future cognitive skill and behavior. More so, fluid intelligence skills do shape language acquisition in early human cognitive life so “grounding” brain cognitive functioning to a timely successfully launch of crystalized intelligence abilities during late childhood).

When cognitive decline exceeds the norm of what is expected during normal aging, the individual becomes diagnosed with MCI. Clinically, MCI is not precisely defined and is difficult to distinguish from normal aging. Approximately 50% of MCI subjects develop dementia and of those approximately 50% end up with Alzheimer's. In MCI, cognitive dysfunction occurs across many areas (i.e., not localized) in the brain, making it problematic to pinpoint whether what is observed is a pathology or just a symptomatic behavior of massive cognitive decline. MCI subjects over the age of 55 transition to Alzheimer's by the time they are 60-63. At this stage, neuroimaging shows that their brain is shrinking, which means the problem has transitioned to the physiological structure of the brain and soon biochemical imbalance follows, which is triggered by neuronal death, which is incurable.

The novel non-pharmacological technology disclosed herein comprises novel audio-visual-tactile means aimed at exercising different serial orders of symbols sequences (numbers, letters, alphanumeric, etc.). The exposure to this novel non-pharmacological technology at the MCI stage may not only delay, but perhaps event prevent onset of dementia and Alzheimer's. In subjects with dementia and Alzheimer's, the novel non-pharmacological technology can delay or maintain the individual in the milder first phase of dementia for a longer period (this parameter is measured as a population). There are 3-4 stages of Alzheimer's. At later more severe stages (stages two and above), the subjects become violent and their care poses an enormous burden on caretakers. Thus, by maintaining milder phases for a longer period, this novel non-pharmacological technology can bring social relief to caretakers of subjects with dementia and Alzheimer's.

The Brain as a “Muscle”—Neural Systems Morphology Versus Functionality:

The reasons the present non-pharmacological technology rejects for the most part the brain's analogy to just being a “muscle,” and views it as too simplistic and short sighted are: (a) Aging is a time dependent process where cognitive performance and competencies gradually decline across multiple functional domains; as the brain neural machinery (e.g., the popular descriptive analogy of the brain been like a muscle) ages, its related cognitive abilities deteriorate also, thus a decrease of skills despite robust practice-time is also expected; (b) Muscles are not biologically complex enough to emulate thought, affection and language-related psychomotor activity by their own, nor do they capture or resemble a person's identity in any shape or form; and (c) The functional organization displayed by the nervous system is by far more complex than the body's morphological organization. The peripheral and central nervous systems are nourished by a fabric of temporal signals and disturbances that impose non-linear complex informational constrains upon the body's skeletal and muscular physical structures. This complex temporal fabric of the nervous systems consists in multiple layers of biological clocks that interact with each other at multiple levels of biological organization (e.g., cellular, organs, systems, etc.) within the body's internal milieu and act-react differently to temporal events outside the body (e.g., circadian rhythms). The timing and synergic cycling properties of these biological clocks gradually become out of sync as we age and our cognitive and motor neuroperformance (performance and ability competence) suffers.

Grounded Cognition; Symbol Grounding Problem (SGP):

The theory of grounded/embodied cognition holds that all aspects of cognition are shaped by aspects of the body. These aspects of cognition include high level mental constructs (such as concepts and categories) and human performance on various cognitive tasks (such as reasoning or judgment). The aspects of the body include the motor system, the perceptual system, the body's interactions with the environment (situatedness) and the ontological assumptions about the world that are built into the body and the brain. A core principle of grounded cognition is that cognition shares mechanisms with perception, action and introspection.

Standard theories of cognition assume that knowledge resides in a semantic memory system separate from the brain's modal sensorial systems for perception (e.g., vision, audition, touch), action (e.g., movement, proprioception) and introspection (e.g., mental states, affect).

According to standard theories of cognition, representations in modal sensorial systems are transduced into amodal symbols that represent knowledge about experience in semantic memory. Once this knowledge exists, it is assumed it supports the spectrum of cognitive processes from perception to thought.

Usually, the symbols constituting a symbolic system neither resemble nor are causally linked to their corresponding meaning They are merely part of a formal, notational convention agreed upon by its users. One may then wonder whether an Artificial Agent AA (or indeed a population of them) may ever be able to develop an autonomous, semantic capacity to connect symbols with the environment in which the AA is embedded interactively. This is to many the core issue of the SGP.

As Hamad phrases the SGP, “how can the semantic interpretation of a formal symbol system be made intrinsic to the system, rather than just parasitic on the meanings in our heads?” In other words, the question is: how can the meanings of the meaningless symbol tokens, which are manipulated solely on the basis of their (arbitrary) shapes, be grounded in anything but other meaningless symbols? (Hamad 1990). Hamad uses the Chinese Room Argument (Searle 1980) to introduce the SGP. An AA, such as a robot, appears to have no access to the meaning of the symbols it can successfully manipulate syntactically. It is like someone who is expected to learn Chinese as his/her native language by consulting a Chinese-Chinese dictionary. Both the AA and the non-Chinese speaker are bound to be unsuccessful, since a symbol's mere physical shape and syntactic properties normally provide no clue as to its corresponding semantic value or meaning, the latter being related to the former in a notoriously, entirely arbitrary way.

In practical terms, the key question posed by the SGP is how a modal sensorial perceptual representation (e.g., a picture of a person slicing a cucumber) is converted into an amodal symbolic representation (e.g., writing/spelling out the letters—“slicing the cucumber” on a piece of paper/computer).

Sensory-Visual Perception:

When a visual stimulus is received in the retina, the light stimulus is segregated along the brain in two distinct neural pathways—one neural pathway, the Parvocellular “ventral” pathway is directed towards the inferior temporal cortex (ITC) and resolves information concerning shape, size and color of fovea it items (e.g., visual pattern recognition of objects and their related features). (See Ungerleider L. G. & Mishkin M. (1982), in Ingle D. J. Goodale M. A. & Mansfield R. J. W. (eds.). Analysis of visual behavior (549-586). MIT Press) (See also Goodale M. A. & Milner D. (1992), in Baars B. J. Banks W. P. & Newman J. B. (eds.). Essential sources in the scientific study of consciousness, MIT Press.) This visual neural pathway in the brain is commonly referred as the “what” is it?, and the other neural pathway, the Magnocellular “dorsal” pathway is directed towards the posterior parietal cortex (PPC) and resolves information concerning the state of motion of visual stimuli and coarse outlines of objects (e.g. computes time to collision when we move around objects and visually coding boundaries\edges of (moving) objects). Milner and Goodale describe a model where there is a visual system for perception and there is another visual system for planning “action” (e.g., ballistic pointing movements considered the simplest reaching movements), that is, the dorsal stream reaches more specialized areas in the parietal-frontal cortex of the monkey brain like the neural network area VIP—F4 which serves to prepare goal directed action (See Milner D. & Goodale M. A. (1995) The visual brain in action, Oxford University Press). Additionally, the dorsal visual neural pathway serves as a good example of how the brain neural overlaps, grounds cognition with the environment (e.g., when there is a need for planning and deploying motor reaching movements) and is commonly referred by the Milner and Goodale model as the “where/how” is it?

In humans, brain hemispheric control and perceptual span contribute to orthographic processing of visually perceived symbols. The perceptual span of the human eye constitutes about 12 symbols. Sensory perception by the right visual field (RVF) is controlled by the left hemisphere of the brain and the left visual field (LVF) is controlled by the right hemisphere. When reading, the eyes are on the move at all times. Words can only be identified during very brief ‘fixations’ time periods lasting about ¼th of a second (during which the eyes are in continuous motion). Around the fixation point (sharpest foveal acuity) only four to five symbols (e.g., letters, numbers etc.,) are seen with 100% acuity. In the LVF, the strongest serial neuronal firing is to the first and middle symbol in the sequence, not to the last symbol. In the RVF, the strongest serial neuronal firing is to the first, middle and last symbol in the sequence.

Orthographic Sequential Encoded Regulated by Inputs to Oscillations within Letter Units (‘SERIOL’) Processing Model:

According to the SERIOL processing model, orthographic processing occurs at two levels—the neuronal level, and the abstract level. At the neuronal level, orthographic processing occurs progressively, beginning from retinal coding (e.g., sequential position of letter symbols within a sequence), followed by letter symbols spatial related attributes-feature coding (e.g., lines, angles, curves), and ending with letter symbols coding (coding for letter symbols nodes according to temporal neuronal firing.) (Whitney. How the brain encodes the order of letters in a printed word: the SERIOL model and selective literature review. Psychonomic Bulletin & Review 2001, 8 (2), 221-243.)

Cognitive, Affective and Psychomotor Competencies are Affected by Native Language Acquisition:

As noted earlier in the present disclosure, native language acquisition occurs during childhood, a period of rapid increase in brain volume. At this point in childhood development, the brain has many more neural connections than it will ever have, enabling us to be far more apt to implicitly acquire new information than as adults. As a rule of thumb, much of the knowledge acquired in life is learned implicitly. Native language acquisition is no exception; it is acquired unaware or without any explicit intention of learning. From a developmental point of view, native language acquisition is an extraordinary sensitive developmental neural period that engages us entirely: namely our cognitive, affective, and psychomotor domains. More so, our adult clarity of thought and expression is only possible when we have mastered a sufficient automatic command of our native language. Usually, a weakness in a specific skill results in a drawback in that particular skill only, but weakness in our ability to automatically command our native language results in the paralysis of all thought and of our power of expression.

Neurocognitive research has confirmed that native language acquisition and early cognitive development are strongly linked, and when language acquisition is delayed or impaired, it affects our ability to internalize basic concepts/actions and also causes deficiencies in emotional and psychomotor skills. There are strong intuitive reasons to believe that human cognition as a whole revolves around mental non-concrete symbolic representations that are alphanumeric language-based.

Language and Time Internalization:

The non-pharmacological technology disclosed herein approaches the evolution of the central nervous system in the brain with a multidisciplinary view, emphasizing the brain neural developmental sensitive time periods and the way they manifest within the body's complex temporal biological organization. Early language acquisition is herein considered as a landmark developmental sensitive event that enables neural aptitudes in the growing child that allow him/her to internalize the primordial meaning of “time”. More so, during early language acquisition, the growing child self-develops a sensory motor and elemental tacit awareness towards existing and acting in “time”. As the child grows older (about the age of 6-7), his/her understanding about ‘time’ deepens through learning how to count, read and write (orthographic and numerical sequential decoding of symbols sequences) and he/she will further differentiate his/her sensorial—perceptual capacities to successfully mentally manipulate non-concrete symbolic information to understand the existence and acting-actions of others in “time”.

In short, early language acquisition sets initial conditions that pre-dispose the growing child towards meeting the demands of a social evolutionary path where new implicit self-learning and novel grounding (interaction) with the environment not only involves one's brain (e.g., non-concrete mental operations concerning strict egocentric view) but the brains of others (e.g. non-concrete mental operations that take into account/represent/simulate the point of view of others). The present non-pharmacological technology envisions early language acquisition as a unique sensitive neural developmental period, characterized by one of the apexes of neuroplasticity by which the personal, social and cultural identity of an individual comes to life.

Inductive Reasoning Versus Deductive Reasoning:

Inductive reasoning is usually contrasted to deductive reasoning. Inductive reasoning is a process of logical reasoning in which a person uses a collection of evidence gained through observation and sensory experience and applies it to build up a conclusion or explanation that is believed to fit with the known facts. Therefore, inductive reasoning mostly makes broad generalizations from specific observations. By nature, inductive reasoning is more open-ended and exploratory, especially during the early stages. Inductive reasoning is sometimes called a “bottom up” approach; that is, the researcher begins with specific observations and measures, he then searches, detects and isolates patterns and regularities, formulates some tentative hypotheses to explore, and finally ends up developing some general conclusions or theories.

An inductive argument is an argument claimed by the arguing party merely to establish or increase the probability of its conclusion. In an inductive argument, the premises are intended only to be as strong as, if true, it would be unlikely that the conclusion were false. There is no standard term for a successful inductive argument, but its success or strength is a matter of degree (weak or strong), unlike with deductive arguments. A deductive argument is valid or else invalid. Even if all of the premises are true in a statement, inductive reasoning allows for the conclusion to be false. Here's an example: “Harold is a grandfather. Harold is bald. Therefore, all grandfathers are bald.” The conclusion does not follow logically from the statements. Inductive reasoning has its place in the scientific method. Scientists use it to form hypotheses and theories. Deductive reasoning allows them to apply the theories to specific situations.

Deductive reasoning is the opposite of inductive reasoning and is a basic form of valid reasoning. A deductive argument is an argument that is intended by the arguing party to be (deductively) valid, that is, to provide a guarantee of the truth of the conclusion provided that the argument's premises (assumptions) are true. This point can also be expressed by stating that, in a deductive argument, the premises are intended to provide such strong support for the conclusion that, if the premises are true, then it would be impossible for the conclusion to be false. An argument in which the premises do succeed in guaranteeing the conclusion is called a (deductively) valid argument. If a valid argument has true conclusions, then the argument is said to be sound. Deductive reasoning, or deduction, may start out with a general statement, or hypothesis, and examines the possibilities to reach a specific, logical conclusion. Sometimes deductive reasoning is called the “top-down” approach because the researcher starts at the top with a very broad spectrum of information and he works his\her way down to a specific conclusion. Deductive reasoning may be narrower and is generally used to test or confirm hypotheses. It can then be said in general that the scientific method uses deduction to test hypotheses and theories. In deductive reasoning, if in the argument premise is something true about a class of things in general, it is also true in the logical conclusion for all members of that class of things. For example, “All men are mortal. Harold is a man. Therefore, Harold is mortal.” For deductive reasoning to be sound, the hypothesis must be correct. It is assumed that the premises, “All men are mortal” and “Harold is a man” are true. Therefore, the conclusion is logical and true. It is possible to come to a logical conclusion even if the generalization is not true. If the generalization is wrong, the conclusion may be logical, but it may also be untrue. For example, the argument, “All bald men are grandfathers. Harold is bald. Therefore, Harold is a grandfather,” is valid logically but it is untrue because the original statement is false.

Fluid Intelligence Versus Crystallized Intelligence:

Fluid intelligence is our reasoning and problem solving ability in new situations. It lies behind the use of deliberate and controlled mental operations to solve novel problems that cannot be performed automatically. Mental operations often include drawing inferences, concept formation, classification, generating and testing hypothesis, identifying relations, comprehending implications, problem solving, extrapolating, and transforming information. Inductive and deductive reasoning are generally considered the hallmark indicators of fluid intelligence. Fluid intelligence has been linked to cognitive complexity which can be defined as a greater use of a wide and diverse array of elementary cognitive processes during performance.

In general, fluid intelligence tests typically measure deductive reasoning, inductive reasoning (matrices), quantitative reasoning, and speed of reasoning. For example, these tests may assess novel reasoning and problem solving abilities; ability to reason, form concepts and solve problems that often include novel information or procedures; basic reasoning processes that depend minimally on learning and acculturation; manipulating abstractions, rules, generalizations, and logical relations.

More specific fluid intelligence tests measure narrower abilities. For example, such tests may assess general sequential reasoning, quantitative reasoning, Piagetian reasoning, or speed of reasoning. General sequential reasoning abilities include, e.g., the ability to start with stated rules, premises, or conditions, and to engage in one or more steps to reach a solution to a problem; induction, the ability to discover the underlying characteristic (e.g., rule, concept, process, trend, class membership) that governs a problem or a set of materials. Quantitative reasoning abilities include, e.g., the ability to inductively and deductively reason using concepts involving mathematical relations and properties. Piagetian reasoning abilities include, e.g., seriation, conservation, classification and other cognitive abilities as defined by Piaget. Speed of reasoning abilities is not clearly defined.

Crystallized intelligence is the ability to use skills, knowledge and experience or in other words, the amount of information you accumulate and the verbal skills you develop over time. Together, these elements form your crystallized intelligence. According to psychologist Raymond Cattell, who developed the concept in the 1980s to explain intelligence, crystallized intelligence comprises the skills and knowledge acquired through education and acculturation. It is related to specific information and is distinct from fluid intelligence, which is the general ability to reason abstractly, identify patterns, and recognize relations. Applying old knowledge to solve a new problem depends on crystallized intelligence; for example, the ability to use one's knowledge of ocean tides to navigate unfamiliar seas. Cattell believed that crystallized intelligence interacts with fluid intelligence. Many psychologists believe that crystallized intelligence increases with age, as people learn new skills and facts; however, researchers disagree about the precise relation between crystallized intelligence and age.

In general crystallized intelligence tests may measure, the breadth and depth of knowledge of a culture; abilities developed through learning, education and experience; storage of informational declarative and procedural knowledge; ability to communicate (especially verbally) and to reason with previously learned procedures; abilities that reflect the role of learning and acculturation. Crystallized intelligence is not the same as achievement.

More specific tests of crystallized intelligence measure narrower abilities. For example, such tests may assess language development, lexical knowledge, listening ability, general (verbal) information, information about culture, general science information, general achievement, communication ability, oral production and fluency, grammatical sensitivity, foreign language proficiency and foreign language aptitude. Language development abilities include, general development, or the understanding of words, sentences, and paragraphs (not requiring reading), in spoken native language skills. Lexical knowledge abilities include, e.g., the extent of vocabulary that can be understood in terms of correct word meanings. Listening ability may assess, e.g., the ability to listen and comprehend oral communications. General (verbal) information abilities include, e.g., the range of general knowledge. Information about culture includes e.g., the range of cultural knowledge (e.g., music, art). General science information abilities include, e.g., the range of scientific knowledge (e.g., biology, physics, engineering, mechanics, electronics). Geography achievement abilities include, e.g., the range of geographic knowledge. Communication ability includes, e.g., ability to speak in “real life” situations (e.g., lecture, group participation) in an adult-like manner. Oral production and fluency abilities include, e.g., more specific or narrow oral communication skills than reflected by communication ability.

Grammatical sensitivity abilities include, e.g., knowledge or awareness of the grammatical features of the native language. Foreign language proficiency abilities are similar to language development, but for a foreign language. Foreign language aptitude includes e.g., rate and ease of learning a new language.

Inducing Inductive Reasoning: Does it Transfer to Fluid Intelligence

It is generally agreed that inductive reasoning constitutes a central aspect of intellectual functioning. Inductive reasoning is usually measured by tests consisting of classifications, analogies, series, and matrices. Many intelligence tests contain one or more of these tests therefore the contribution of inductive reasoning to intelligence test performance is beyond question. (See Klauer, K. J. and Willmes, K., Contem. Edu. Psychol. 27, 1-25 (2002))

Klauer and Willmes (cited above) discuss that at least four important waves of research have contributed to knowledge about the relationship between inductive reasoning and intelligence. Spearman (1923), the founder of the factor analytical tradition, was convinced that his general intelligence factor g was mainly determined by inductive processes (“education of relations”). Thurstone (1938) used a different factor analytic approach, which led him to a concept of multiple intelligence factors. One of these was the factor “Reasoning” that is made up of a combination of inductive and deductive tests. Cattell (1963) found an adequate solution by making the distinction between fluid and crystallized intelligence. Fluid intelligence is primarily involved in problem solving, whereas crystallized intelligence is involved in acquired declarative knowledge. Fluid intelligence can be understood as at least partially determined by genetic and biological factors, while the crystallized factor is conceived of as a combined product of fluid intelligence and education. Vocabulary tests are typical markers of the crystallized factor, whereas inductive tests typically serve as markers of the fluid factor. Using the method of linear structural equations (LISREL), Cattell's theory of fluid and crystallized intelligence was confirmed. Undheim and Gustafsson also concluded that inductive processes play a major role in fluid intelligence. (Undheim, J.-O., & Gustafsson, J.-E. The hierarchical organization of cognitive abilities: Restoring general intelligence through use of linear structural relations (LISREL). Multivariate Behavioral Research, 22, 149-171. (1987))

Continuing interest in inductive reasoning and fluid intelligence has prompted cognitive researchers to engage in analyzing the processes that occur when subjects solve tasks requiring inductive reasoning. Further, researchers in the field of artificial intelligence have constructed computer programs that attempt to solve certain kinds of inductive-reasoning problems in order to test theories about inductive processes.

Prescriptive Theory of Inductive Reasoning:

In certain non-limiting aspects, the presently disclosed subject matter provides novel exercises, based on, but not derived from, an understanding of the prescriptive theory of inductive reasoning. As such, the present subject matter discloses novel concepts such as spatial or time perceptual related “attribute” and “interrelation, correlation among alphanumeric symbols and cross-correlations among alphanumeric symbols sequences, which concepts are different in their fundamental premises from previously-described concepts, which are mostly based on randomly selected associations among symbols and/or the combinations of symbols and things in the world. In particular, the present subject matter relies exclusively on alphanumeric symbolic sequential and statistical novel information characterized by interrelations, correlations and cross-correlations among symbols and symbol sequences.

In general, a prescriptive theory does not describe how subjects actually proceed when solving problems—there is presumably an infinite number of ways to solve inductive problems, depending on the type of problem as well as on different experiential backgrounds and idiosyncrasies of the problem solver.

Unlike descriptive theories, a prescriptive theory delineates what to do when a problem has to be solved by describing those steps that are sufficient to solve problems of the type in question. A prescriptive theory of inductive reasoning specifies the processes considered to be sufficient to discover a generalization or to refute an overgeneralization. Obviously, such a theory can be tested in a straightforward manner by a training experiment for transfer. Participants trained to apply an efficient strategy to solve inductive problems should outperform subjects who did not have this training, given that the subjects are not already highly skilled in solving inductive problems. Thus, children would seem to be likely candidates for the training of inductive reasoning strategies.

Inductive reasoning enables one to detect regularities and to uncover irregularities. These are conceptually illustrated in the above cited publication by Klauer and Willmes, and reproduced herein. (See Klauer, K. J. and Willmes, K., Contem. Edu. Psychol. 27, 1-25 (2002)).

As shown in Table 2 herein, Klauer and Willmes suggest that inductive reasoning is accomplished by a comparative process, i.e., by a process of finding out similarities and/or differences with respect to attributes of objects or with respect to relationships between objects. Conceptualizing the definition of inductive reasoning this way implies that inducing adequate comparison processes in learners would improve the learners' abilities of inductive reasoning.

Specifically, Table 2 makes use of an incomplete form of a mapping sentence as developed by Guttman. The three facets A, B, and C consist of 3, 2, and 5 elements, respectively. Accordingly, 3×2×5=30 varieties of inductive reasoning tasks are distinguished.

TABLE 2

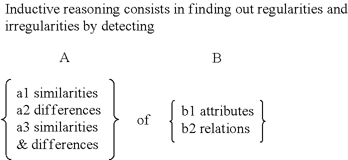

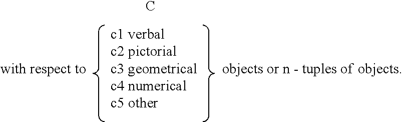

Facets A and B constitute six types of inductive reasoning. Table 3 specifies these six types in some detail. The table presents the designations given each of the six types of inductive reasoning, moreover the facet identifications, the item formats used in psychological tests, and the cognitive operations required by them.

Table 4 shows an overview of the genealogy of inductive reasoning tasks for the six types of tasks defined by Facets A and B. The inductive reasoning strategy refers to the comparison process which deals either with comparing attributes of objects (left-hand branch of the genealogy) or with relations between objects (right-hand branch). In any case, one is required to search for similarity, for difference, or both similarity and difference. In this way one detects commonalities and difference. The item classes “cross classification” and “system formation” require one to take notice of both the same and a different attribute or the same and a different relationship. That is the reason why these item classes represent the most complex inductive problems—the problem solver must deal with two or more dimensions simultaneously.

TABLE 3
Types of Inductive Reasoning Problems

| | Facet | Problem | Cognitive operation |
|---|---|---|---|
| Process | identification | formats | required |
| Generalization (GE) | a₁b₁ | Class formation | Similarity of attributes |
| | | Class expansion | |
| | | Finding common attributes | |
| Discrimination (GE) | a₂b₁ | Identifying irregularities | Discrimination of attributes |
| | | | (concept differentiation) |
| Cross-Classification | a₃b₁ | 4-fold scheme | Similarity & difference |
| (CC) | | 6-fold scheme | in attributes |
| | | 9-fold scheme | |
| Recognizing Relationships | a₁b₂ | Series completion | Similarity of relationships |
| (RR) | | ordered series analogy | |
| Differentiating Relationships | a₂b₂ | Disturbed series | Differences in relationships |
| (DR) | | | |
| System Construction | a₃b₂ | Matrices | Similarity & difference |
| (SC) | | | in relationships |

TABLE 4
Genealogy of tasks in inductive reasoning

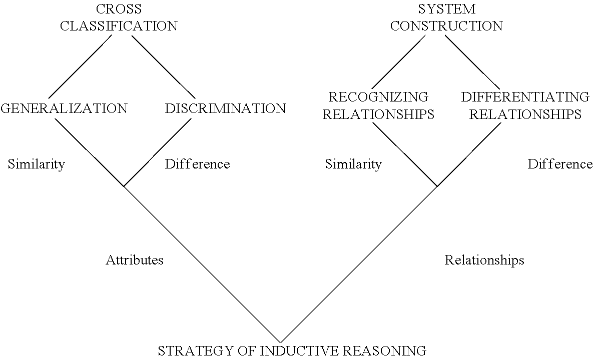

Advantages of the Present Non-Pharmacological Technology Over Digital Brain Fitness and Other Cognitive Interventions:

The present non-pharmacological technology aims to stimulate a new neuroplasticity apex in normal aging individuals in general and in mild neurodegenerative elderly individuals in particular. The present non-pharmacological technology is a new cognitive intervention platform, which regime of performance aims to enable an efficient transfer of fluid (inductive/abstract reasoning, spatial orientation operations, novel problem solving, adapt to new situations) and related crystalized intelligence competences (e.g., declarative-verbal knowledge) to everyday demanding tasks by promoting implicit acquisition of rules, concepts and schema governing sequential and statistical patterns and patterns closure of symbolic information in one's native language alphabet and in numerical series. To that effect, the present technology achieves its goal via a new cognitive intervention platform of exercises based on interactive (and passive at times) exposures to novel strategies consisting in a suite of phonological-visual sequential patterns of serial and statistical symbolic knowledge encoded in one's native alphabet and/or in numerical series. The present non-pharmacological technology aims to effectively recreate threshold plastic neuro-linguistic conditions potentially capable of giving birth and sustaining a language-sensitive neural period, predisposing the brain of the aging individual to a new and safe opportunity, although late, for native symbolic language acquisition.

As such, a brain fitness approach which mainly emphasizes “practice time,” is only a partial and limited solution (non-transferable cognitive skills) to brain fitness, health and wellness. Therefore, a brain fitness, health and wellness computer training program that claims to mainly exercise the brain by adopting the analogy of “use it or lose it,” as if the brain was just a “muscle,” is a program that works on material pieces consisting of muscles, tendons and bones and claims benefits that embrace the entire structure and functions of the body. This mechanistic, shortsighted approach to computer brain neuroperformance lacks proper understanding of the complex temporal reciprocal interactions, coordination and synergies that take place at multiple levels of biological functional organization which strongly constrain the body's physical structures and result in cognitive-mental and neuromuscular healthy behaviors.

More so, the notion that a few daily puzzles and quizzes can sharpen the intellect and stave off cognitive decline is controversial. Most research in the field has shown that these brain games do little than to allow the participant to develop strategies for improving performance on the particular task at hand. The improvement does not typically extend beyond the game itself. Still, research has also found that “there were absolutely no transfer effects” from the training tasks to more general tests of cognition. In other words, the expectation that the computer training available nowadays will improve overall mental sharpness by training only one aspect of the mind, such as memory, is presently unfounded.

Instead, the presently disclosed subject matter predicates a more physiological sound approach to brain fitness, based in a new cognitive training mainly focused on sensorial-motor-perceptual and fluid mental skills' exercises of symbolic alphanumeric sequential and statistical information, that aims to ensure that the aging individual attains, as a primary goal, stable cognitive neuroperformance, and in time (after 6 to 12 months of cognitive training), novel problem solving strategies transferring to functional benefits in daily (demanding) tasks. Further, the subject matter disclosed herein serves as a cognitive aptitude enhancement to a sub-population of healthy normally aging individuals. To that effect, the presently disclosed subject matter predicates a one of its kind non-pharmacological, cognitive symbolic language fitness intervention technology, where the end-user exercises novel strategies related to his/her fluid and crystallized intelligences in order to delay the normal aging process or reverse or postpone a state of mild neuro-degeneration in elderly neuro-pathology. These fluid and crystallized intelligence abilities consist of: inductive reasoning, spatial orienting, audio-visual processing speed, related memory processes (working memory, episodic etc.), psychomotor abilities (to operate and mobilize relevant biological knowledge within one's native language alphabet and natural number series [symbolic alphanumeric information], and to mobilize physiological bottom-up and top-down processes to assist in stabilizing related cognitive functions). Accordingly, the subject matter disclosed herein disclosed primes our structural-temporal-social brains to stabilize and enhance the performance of a number of cognitive functions which bring about competence gains due to the increased neural sensitivity. This new epoch of neural sensitivity promotes robust implicit learning of alphanumeric sequential and statistical information. Yes, in a certain way an aging adult's brain will experience the neuroperformance benefits of a child's brain again!

The subject matter disclosed herein provides a comprehensive cognitive intervention based on new exercising of alphabetical/numeric symbolic information and novel strategies concerning problem solving aimed to promote stability and sustain neuroperformance conditions in the aging population, which represents a paradigm shift in the way people view and think about the common usage of alphabetical knowledge in general, and about the way people think and operate with numbers (numerical series) in particular. Specifically, the subject matter disclosed herein provides an innovative out-of-the-box technological approach which could inspire new multidisciplinary non-pharmacological solutions to prevent and/or delay aging-related memory loss and other cognitive skills decline in normally aging, MCI and moderate Alzheimer's individuals.

Further, the presently disclosed non-pharmacological technology focuses on a new cognitive intervention platform that exercises novel fluid intelligence strategies centering on inductive-deductive reasoning, novel problem solving, abstract thinking, implicit identification of sequential and statistical pattern rules and irregularities, spatial orienting and related crystallized intelligence narrow abilities. Still, the present disclosed non-pharmacological technology also causes efficient interaction of symbolic exercised sequential information in working memory. Accordingly, the presently disclosed new cognitive training successfully primes existing neural networks, sensory-motor and perceptual abilities in the aging individual, enabling a new epoch of neural sensitivity similar to the ontological development characterized by early symbolic language acquisition. Successful performance of these basic cognitive symbolic alphabetical-numeric exercises is determinant to ensure proper neuro-linguistic-numeric symbolic development, instrumental namely in mastering one's native language, number operational knowledge and the role of numbers in language comprehension, all of which assist to competent copying with a wide range of basic daily (demanding) tasks.

In terms of development, early symbolic language acquisition is considered to be a most sensitive period, triggered and supported by neuronal plasticity. The early symbolic language acquisition enable the fast development of higher brain executive functions and competence aptitudes such as fluid intelligence abilities (e.g. inductive-deductive reasoning, novel problem solving etc.,) which supported by an efficient manipulation and processing of symbolic information in working memory, it later develops the ability to explicitly verbally learn facts sequentially and associatively.

Methods

The definition given to the terms below is in the context of their meaning when used in the body of this application and in its claims

A “series” is defined as a sequence of terms

“Serial terms” are defined as the orderly components of a series.

A “serial order” is defined as a sequence of terms characterized by: (a) the relative spatial position of each term and the relative spatial positions of those terms following and/or preceding it; (b) its sequential structure: an “indefinite serial order,” is defined as a serial order where no first neither last term are predefined; an “open serial order.” is defined as a serial order where the first term is predefined; a “closed serial order,” is defined as a serial order where only the first and last terms are predefined; and (c) its number of terms, as only predefined in ‘a closed serial order’.

A “string” is defines as any sequence of any number of terms.

“Terms” are represented by any symbols or by only letters, or numbers or alphanumeric symbols.

A “letter string” is defined as any sequence of any number of letters.

A “number string” is defined as any sequence of any number of numbers.

“Terms arrays” are defines as open serial orders of terms.

“Set arrays” are defined as closed serial orders of terms.

“Letter set arrays” are defined as closed serial orders of letters, wherein same letters may be repeated.

An “alphabetic set array” is a closed serial order of letters, wherein all letters are different (not repeated), where each letter is a particular member of a set, and where each of these members has a different ordinal position in the set array. An alphabetic set array is herein considered as a Complete and Non-Random letters sequence. Letter symbols are herein only graphically represented with capital letters. For single letter members, we will obtain the following 3 direct and 3 inverse alphabetic set arrays:

Direct alphabetic set array: A, B, C, D, E, F, G, H, I, J, K, L, M, N, O, P, Q, R, S, T, U, V, W, X, Y, Z.

Inverse alphabetic set array: Z, Y, X, W, V, U, T, S, R, Q, P, O, N, M, L, K, J, I, H, G, F, E, D, C, B, A.

Direct type alphabetic set array: A, Z, B, Y, C, X, D, W, E, V, F, U, G, T, H, S, I, R, J, K, L, P, K, O, M, N.

Inverse type alphabetic set array: Z, A, Y, B, X, C, W, D, V, E, U, F, T, G, S, H, R, I, Q, J, P, K, O, L, N, M.

Central type alphabetic set array: A, N, B, O, C, P, D, Q, E, R, F, S, G, T, H, U, I, V, J, W, K, X, L, Y, M, Z.

Inverse central type alphabetic set array: N, A, O, B, P, C, Q, D, R, E, S, F, T, G, U, H, V, I, W, J, X, K, Y, L, Z, M.

An “ordinal position” is defined as the relative position of a term in a series, in relation to the first term of this series, which will have an ordinal position defined by the first integer number (#1), and each of the following terms in the sequence with the following integer numbers (#2, #3, #4, . . . ). Therefore, the 26 different letter terms of the English alphabet will have 26 ordinal positions which, in the case of the direct set array (see above), ordinal position #1 will correspond to the letter “A”, and ordinal position #26 will correspond to the letter “Z”.

The term “incomplete” serial order refers herein only in relation to a serial order which has been previously defined as “complete.”

As used herein, the term “relative incompleteness” is used in relation to any previously selected serial order which, for the sake of the intended task herein required performing by a subject, the said selected serial order could be considered to be complete.

As used herein, the term “absolute incompleteness” is used only in relation to set arrays, because they are defined as complete closed serial orders of terms (see above). For example, in relation to a set array of terms, incompleteness only involves the number of missing terms; and in relation to an alphabetic set array, incompleteness is absolute, involving at the same time: number of missing letters, type of missing letters and ordinal positions of missing letters.

A “non-alphabetic letter sequence” is defined as any letter series that does not follow the sequence and/or ordinal positions of letters in any of the alphabetic set arrays.

A “symbol” is defined as a mental abstract graphical sign/representation, which includes letters and numbers.

A “letter term” is defined as a mental abstract graphical sign/representation, which is generally, characterized by not representing a concrete: thing/item/form/shape in the physical world. Different languages may use the same graphical sign/representation depicting a particular letter term, which it is also phonologically uttered with the same sound (like “s”).

A “letter symbol” is defined as a graphical sign/representation depicting in a language a letter term with a specific phonological uttered sound. In the same language, different graphical sign/representation depicting a particular letter term, are phonologically uttered with the same sound(s) (like “a” and “A”).

An “attribute” of a term (symbol, letter or number) is defined as a spatial distinctive related perceptual features and time distinctive related perceptual features.

A “spatial related perceptual attribute” is defined as a characteristically spatial related perceptual feature of a term, which can be discriminated by sensorial perception. There are two kinds of spatial related perceptual attributes.

An “individual spatial related perceptual attribute” is defined as a spatial related perceptual attribute that pertains to a particular term. Individual spatial related perceptual attributes include, e.g., symbol case; symbol size; symbol font; symbol boldness; symbol tilted angle in relation to an horizontal line; symbol vertical line of symmetry; symbol horizontal line of symmetry; symbol vertical and horizontal lines of symmetry; symbol infinite lines of symmetry; symbol no line of symmetry; and symbol reflection (mirror) symmetry.

A “collective spatial related perceptual attribute” is defined as a spatial related perceptual attribute that pertains to the relative location of a particular term in relation to the other terms in a letter set array or in an alphabetic set array or in an alphabetic letter symbol sequence. Collective spatial related perceptual attributes include, e.g., in a set array, a symbol ordinal position; the physical space occupied by a symbol; when printed in written form—the distance between the physical spaces occupied by two consecutive symbols\terms; and left or right relative position of a term\symbol in a set array.

A “time related perceptual attribute” is defined as a characteristically temporal related perceptual feature of a term (symbol, letter or number), which can be discriminated by sensorial perception such as: a) any color of the RGB full color range of the symbols term; b) frequency range for the intermittent display of a symbol, of a letter or of a number, from a very low frequency rate, up till a high frequency (flickering) rate. Frequency is denominated as: l/t, where t is in the order of seconds; c) particular sound frequencies by which a letter or a number is recognized by the auditory perception of a subject.

An “arrangement of terms” (symbols, letters and/or numbers) is defined as one of two classes of term arrangements, i.e., an arrangement of terms along a line, or an arrangement of terms in a matrix form. In an “arrangement along a line,” terms will be arranged along a horizontal line by default. If for example, the arrangement of terms is meant to be along a vertical or diagonal or curvilinear line, it will be indicated. In an “arrangement in a matrix form,” terms are arranged along a number of parallel horizontal lines (like letters arrangement in a text book format), displayed in a two dimensional format.

The terms “generation of terms,” “number of terms generated” (symbols, letters and/or numbers) is defined as terms generally generated by two kinds of term generation methods-one method wherein the number of terms is generated in a predefined quantity; and another method wherein the number of terms is generated by a quasi-random method.

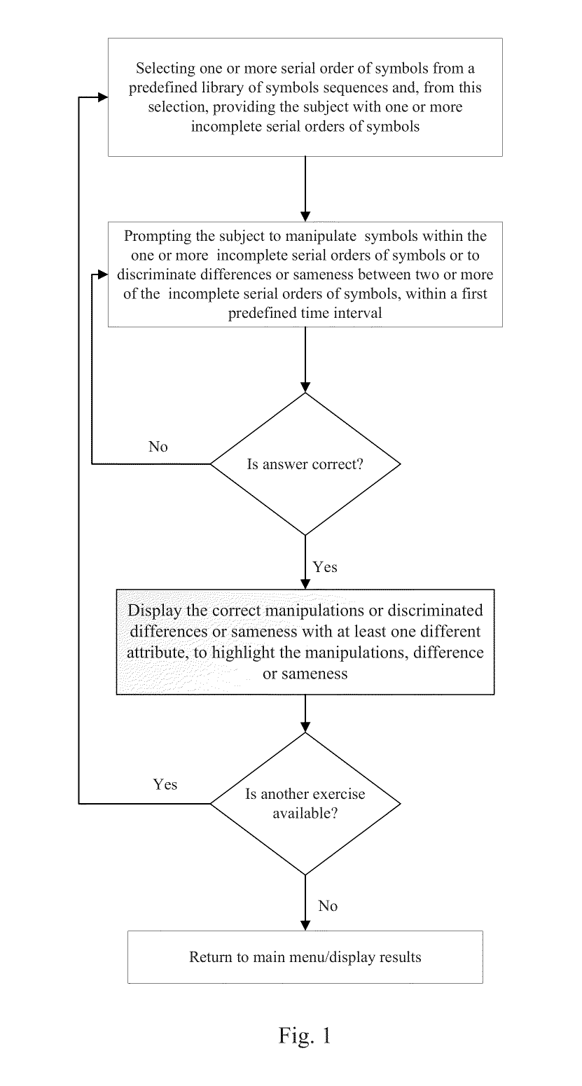

The implementation of the methods for promoting fluid intelligence abilities in a subject are carried out by way of a number of non-limiting exercises that can be used to enhance or promote the fluid intelligence abilities in a subject. By re-engaging the fluid intelligence abilities, the normal aging subject is better equipped to maintain or prolong its functional stability in a number of cognitive performances and abilities, prevent performance decay of basic day to day demanding tasks, and combat the effects, or even reverse the effects of mild cognitive decline. Still, by re-engaging the basic intelligence abilities, the aging elderly subject is in general better equipped to prevent or delay the onset of dementia and in particular postpone the negative manifestation of mild cognitive symptoms in the early stage of Alzheimer's disease. In general, the exercises that have been developed to achieve these aspects of the present subject matter involve a method of promoting fluid intelligence abilities in a subject. FIG. 1 is a flow chart setting forth the broad concepts covered by the specific non-limiting exercises put forth in the Examples below.

As can be seen in FIG. 1, the method of promoting fluid intelligence abilities in the subject comprises selecting at least one serial order of symbols from a predefined library of symbols sequences and providing the subject with an exercise involving at least one unique serial order of symbols obtained from the previously selected serial order of symbols. The subject is then prompted to, within a first predefined time interval, manipulate symbols within the at least one obtained serial order, or to discriminate if there are or not differences between two or more of the obtained serial orders within the exercise. After manipulating the symbols or discriminating if there are or not differences between two or more of the obtained serial orders within the exercise, an evaluation is performed to determine whether the subject correctly manipulated the symbols or correctly discriminated if there are or not differences between the two or more of the obtained serial orders. If the subject made an incorrect manipulation or discrimination, then the exercise is started again and the subject is prompted to again manipulate symbols within the at least one obtained serial order or to discriminate if there are or not differences between two or more of the obtained serial orders within the exercise. If, however, the subject correctly manipulated the symbols or correctly discriminated if there are or not differences between the two or more of the obtained serial orders, then the correct manipulations as well as correct discrimination of differences or sameness, are displayed with at least one different symbol attribute to highlight or remark the manipulation and the discriminated difference or sameness. The above steps in the method are repeated for a predetermined number of iterations separated by second predefined time intervals, and upon completion of the predetermined number of iterations, the subject is provided with the results of each iteration. The predetermined number of iterations can be any number needed to establish that a proficient reasoning performance concerning the particular task at hand is being promoted within the subject. Non-limiting examples of number of iterations include 1, 2, 3, 4, 5, 6, and 7.

It is important to point out that, in the above method of promoting fluid intelligence abilities and in the following exercises and examples implementing the method, the subject is performing the manipulation or the discrimination of symbols in an array/series of symbols without invoking explicit conscious awareness concerning underlying implicit governing rules or abstract concepts/interrelationships, correlations or cross-correlations among the manipulated or discriminated symbols by the subject. In other words, the subject is performing the manipulation and/or discrimination without overtly thinking or strategizing about the necessary actions to accomplish manipulating the symbols or discriminating differences or sameness between symbols in an array/series of symbols. The herein presented suite of exercises the subject is required to perform makes use of interrelations, correlations and cross-correlations among symbols in symbol string sequences and alphabetic set arrays, such that the mental ability of the exercising subject get to promote novel reasoning strategies that improve fluid intelligence abilities. The improved fluid intelligence abilities will be manifested in at least, novel problem solving, drawing inductive-deductive inferences, pattern and irregularities recognition, identifying relations, comprehending implications, extrapolating, transforming information and abstract concept thinking.

Furthermore, it is also important to consider that the methods described herein are not limited to only alphabetic symbols. It is also contemplated that the methods of the present subject matter are also useful when numeric serial orders and/or alpha-numeric serial orders are used within the exercises. In other words, while the specific examples set forth employ serial orders of letter symbols, it is also contemplated that serial orders comprising numbers and/or alpha-numeric symbols can be used.

The library of symbol sequences comprises a predefined number of set arrays (closed serial orders of predefined non-random sequences of terms: symbols\letters\numbers), which may include alphabetic set arrays. Alphabetic set arrays are characterized by comprising a predefined number of different letter terms, each letter term having a predefined ordinal position in the closed set array, and none of said different letter terms are repeated within this predefined unique serial order of letter terms. A non-limiting example of a unique set array is the English alphabet, in which there are 26 predefined different letter terms where each letter term has a predefined consecutive ordinal position of a unique closed serial order among 26 different members of a set array only comprising 26 members. In one aspect of the present subject matter, a predefined library of symbol sequences is considered, which may comprise set arrays. The English alphabet is herein considered as only one unique serial order of letter terms among the at least five other different serial orders of the same letter terms. The English alphabet is a particular alphabetic set array herein denominated: direct alphabetic set array, considered as a non-random sequence. The other five different serial orders of the same letter terms are also unique alphabetic set arrays, which are herein also considered as non-random sequences, denominated: inverse alphabetic set array; direct type of alphabetic set array; inverse type of alphabetic set array; central type of alphabetic set array; and, inverse central type alphabetic set array. It is understood that the above predefined library of letter terms sequences may contain fewer letter terms sequences than those listed above or comprise additional different set arrays.

The method implementing the present subject matter is not uniquely confined to sequences of letter terms. The method also contemplates the presentation of sequences involving letters and number symbols terms. However, the multiple letters and/or numbers and/or alphanumeric symbols of a sequence of terms, adhere to the unique serial order principle of excluding repeated terms within the set array sequence.

As put forth above, the present subject matter may prompt the subject to discriminate differences between two or more serial orders of terms which were obtained from previously selected one or more set arrays of a predefined library of set arrays. In one aspect of the present subject matter, the obtained two or more serial orders of terms contain at least one different attribute between each of the obtained serial orders of terms. An attribute of a term (symbol\letter\number), is a spatial or temporal perceptual related distinctive feature. In this regard, the present subject matter is directed to the concept that the attribute that is different between the two or more of the obtained serial orders of terms is an attribute selected from the group comprising at least symbol size, symbol font style, symbol spacing, symbol case, boldness of symbol, angle of symbol rotation, symbol mirroring, or combinations thereof. These attributes are considered spatial perceptual related attributes of the terms. Other spatial perceptual related attributes of a term includes, without limitation, letter symbol vertical line of symmetry, letter symbol horizontal line of symmetry, letter symbol vertical and horizontal lines of symmetry, letter symbol infinite lines of symmetry, and letter symbol with no line of symmetry.

The time perceptual related attributes of a term (symbol\letter\number) are features depicting a quantitative state change in time or a spatial quantitative state change in time of that term. The time perceptual related attributes of a term include any color of the full red-green-blue spectral color range of a term when it is visually displayed. Among other time perceptual related attributes there is the frequency range for the intermittent display of a term in a sequence, from a very low intermittency frequency rate up to a high flickering rate. Frequency rate of display is herein defined in l/t seconds, where t ranges from milliseconds to seconds.

The present methods are not restricted to presenting two or more serial orders of terms containing only one different attribute between each serial order of terms. The present methods also contemplate presenting the two or more obtained serial orders of terms with a plurality of different attributes between each of the serial orders of terms. The plurality of different attributes between the obtained serial orders of terms may be any of those described above.

As previously indicated above, the exercises and examples implementing the methods of the present subject matter are useful in promoting fluid intelligence abilities in the subject through the sensorial-motor and perceptual domains that jointly engage when the subject performs the given exercise. That is, the serial manipulating or discriminating of symbols from an array of symbols by the subject engages various degrees of motor activity within the subject's body. These various degrees of motor activity engaged within the subject's body may be any motor activity derived and selected from the group consisting of sensorial perceptual operations involved in the manipulation or discrimination in or between one and more obtained serial order of terms, body movements involved in the execution of said manipulation or discrimination, and combinations thereof. While any body movements can be considered motor activity implemented by the subject's body, the present subject matter is mainly concerned with implemented body movements selected from the group consisting of body movements of the subject's eyes, head, neck, arms, hands, fingers and combinations thereof.

By way of novel exercises, where the subject engage in certain degrees of body motor activity, the methods of the present subject matter are requiring the subject to bodily-ground cognitive fluid intelligence abilities, implementing manipulations and discrimination of, for non-limiting example, letter symbols via exercising of novel interrelations, correlations and cross-correlations among these letter symbols as mentioned above. The exercises and examples implementing the present subject matter bring the subject back to an early developmental realm where mental cognitive operations fast developed by interrelating, correlating and cross-correlating day to day trial and error experiences via planning and implementation of actions (manipulation) and basic pattern recognition (discrimination of differences and sameness) of qualities (attributes) heavily grounded in symbolic operational knowledge. By doing this, the exercises and examples herein strengthen the fluid intelligence abilities within the subject. It is important that the exercises and examples accomplish this goal by downplaying or mitigating as much as possible the subject need to recall and/or use verbal semantic or episodic memory. The exercises and examples are mainly within promoting fluid intelligence performance, maintaining or prolonging stability of particular trained fluid intelligence cognitive functions, improvement of particular trained fluid intelligence ability aptitude and transfer of improvement in some trained fluid intelligence ability performance to day to day tasking, but do not rise to the operational level of promoting crystalize intelligence via explicit associative learning based on declarative or semantic knowledge. As such, the letter sequences and serial orders of letter symbols are selected and presented together in ways aimed to specifically downplay or mitigate the subject's need for problem solving strategies and/or drawing inductive-deductive inferences necessitating information recall-retrieval from declarative semantic and/or episodic kinds of memory.

A large number of attributes utilized in the present exercises and examples are most efficient in promoting fluid intelligence. Accordingly, the subject will need a longer performance time to manipulate and mentally mesh together discrimination of different attributes (also different in kind e.g. spatial and temporal perceptual related attributes displaying in the same exercise) if more attributes are used within the exercises. It is herein contemplated that up to seven different attributes can be changed within the set arrays and the subject will still be within the realm of fluid intelligence abilities. However, if the number of different attributes under consideration rises above seven, manipulation and pattern recognition concerning underlying rules or abstract concepts linking together (interrelations) serial sequences of terms (letter\number\symbols), will be in need of crystalize narrow abilities in order to strategize and solve what is required from him/her to perform in order to solve the prompted problem. Thus, if more than seven attributes come into play, what was learned from past experience through semantic or episodic memory is unavoidably mentally invoked within the subject.

In addition to take into consideration the utilization of different attributes for the serial terms within an exercise, there are also temporal attributes which are integral components of the exercises in the Examples given below, which should not be confounded with the temporal perceptual attributes of terms in the serial orders explained above. There are a number of different time intervals that are an essential temporal part of the exercises. A first predefined time interval involves the time given to the subject to perform the serial manipulation of the symbols or the discrimination between the at least two or more serial orders of terms obtained from the one or more selected set arrays in the predefined library of non-random set arrays. In general, the subject is given a certain amount of time to perform the task. If the subject fails to perform the task within the first time interval, the method then stops that particular exercise and the subject is transitioned on to the next exercise in the task sequence. The first predefined time interval can range from milliseconds to minutes. The length of this first predefined time interval, depends on the actual challenge presented by the manipulations or discriminations being asked to the subject to perform.

A second predefined time interval is employed between iterations within the exercise of each implementation of the methods. The second predefined time interval is a pause between the exercises in each Example, thus giving the subject a break in the routine of the particular exercise. Without limitation, the second predefined time interval ranges generally from 5 seconds to 17 seconds.

This temporal integral aspect of the method in the Examples set forth below is utilized to help insure that the subject is exercising within the mental domain of fluid intelligence, therefore able to right away promote performance improvements in (the trained) fluid intelligence ability, and is not, in fact, contaminating the exercise by resorting to problem solving strategies based on verbal or episodic recall-retrieval of semantic information from long term memory (which will mostly result in practice effects contamination).

In an aspect of the present subject matter, the examples of the exercises include providing a graphical representation of a non-random letter set array sequence, in a ruler shown to the subject, when providing the subject with the obtained sequence of serial terms, to execute the exercise. The visual presence of the ruler helps the subject to perform the exercise, by fast visual spatial recognition of the presented set array, sequence, in order to assist manipulate the required letter symbols or discriminate between differences and sameness between the obtained two or more sequences of terms. In this aspect of the present subject matter, the ruler is a set array sequence selected from the predefined library of non-random set array sequences discussed above.

In a further aspect of the present subject matter, the exercises and examples are implemented through a computer program product. In particular, the present subject matter includes a computer program product for promoting fluid intelligence abilities in a subject, stored on a non-transitory computer-medium which when executed causes a computer system to perform a method. The method executed by the computer program on the non-transitory computer readable medium comprises selecting a serial order of letter-number-alphanumeric symbols from a predefined library of letter-number-alphanumeric symbols sequences and providing the subject with an exercise involving at least one serial order of terms, derived from a previously selected serial order from a predefined library of serial orders of terms. The subject is then prompted to manipulate serial terms (symbols\letters\numbers) within the serial order of terms or to discriminate differences between two or more of the obtained serial orders of terms within the exercise. After manipulating the serial terms or discriminating between the two or more serial orders of terms within the exercise, an evaluation is perform to determine whether the subject correctly manipulated the serial terms or correctly discriminated if there are or not differences between the two or more obtained serial orders of terms. If the subject made an incorrect manipulation or discrimination, then the exercise is started again and the subject is prompted to manipulate serial terms within the obtained serial order or to discriminate if there are differences or not, between two or more of the derived serial orders of terms within the exercise. If, however, the subject correctly manipulated the letter symbols or correctly discriminate the said differences, then the correct manipulations or discriminated differences are displayed with at least one different serial term attribute, to highlight and/or remark the manipulation or difference. The above steps in the method are repeated for a predetermined number of iterations, and upon completion of the predetermined number of iterations, the subject is provided with each iteration results.

In a still further aspect of the present subject matter, the exercises and examples implementing the present methods are presented by a system for promoting fluid intelligence abilities in a subject. The system comprises a computer system comprising a processor, memory, and a graphical user interface (GUI). The processor contains instructions for: selecting a serial order of terms from a predefined library of terms sequences, and providing the subject with an exercise involving at least one serial order of terms derived from the initially selected serial order of terms in the said predefined library, on the GUI; prompting the subject on the GUI to manipulate one or more serial terms within the derived serial order of terms or to discriminate if there are or not differences between two or more derived serial orders of terms within a first predefined time interval; determining whether the subject correctly manipulated the serial terms or correctly discriminated the said differences between the two or more obtained serial orders of terms; if the subject made an incorrect manipulation or discrimination of a serial term, then returning to the step of prompting the subject on the GUI to manipulate serial terms within the obtained serial order of terms, or to discriminate if there are or not differences between two or more obtained serial orders of terms within a first predefined time interval; if the subject correctly manipulated the letter symbols or correctly discriminated the said differences between the two or more obtained serial orders of terms, then displaying the correct manipulations or discriminated differences between serial terms on the GUI with at least one different spatial or temporal perceptual related attribute of a serial term to highlight the manipulation or said difference; repeating the above steps for a predetermined number of iterations separated by predefined time intervals; and, upon completion of the predetermined number of iterations, providing the subject with the results of each iteration on the GUI.

It will be readily apparent to a skilled artisan that the features of the general method as described above will be implementable in the computer program product and the system as further described. Furthermore, the following exercises and examples are non-limiting embodiments implementing the present subject matter and are not presented in a limiting form, meaning that other exercises and examples embodying the general concepts discussed herein are also within the scope and spirit of the present subject matter.

In addition, prior to conducting the exercises in the following Examples, it is contemplated that the subject will take a test and/or a battery of tests to determine the scope of any mild cognitive decline or the onset or severity of mild-cognitive impairment (MCI) or mild cognitive functional condition/state of Alzheimer's disease. Likewise, after completing any number of the exercises presented in the Examples, the subject may take a further battery of test/s to determine the scope of performance and transfer promotion of fluid reasoning abilities achieved through the completion of the exercises in the Examples.

Furthermore, as discussed above, while the following Examples provide a series of exercises involving problem solving related to the novel manipulation and discrimination of serial terms sequences, it is contemplated as being within the scope of the present subject matter that the exercises could also be comprised of numerical symbols alone (that is, numbers including the integer set 1-9) or contain alphanumeric symbols (that is, letters and numbers together in the symbol sequence of terms). Still further, the following exercises are generally implemented using a computer system and a computer program product and, as such, auditory and tactile exercises for promoting fluid intelligence abilities in a subject are also contemplated as being within the scope of the present subject matter.

In certain non-limiting embodiments, a modular software implements the neuroperformance platform technology disclosed herein, and exploits via its family of proprietary algorithms—statistical properties implicitly encoded in the sequential order of single letters and letter chunks (words, sentences, etc.) in a language alphabet and single numbers and number sets in a numerical series. Some modules are passive while others are interactive. Once an exercise session ends, the user may proceed to immediately test the impact of the session using a psychometric suite testing primary cognitive ability (e.g., inductive reasoning, spatial orientation, numerical facility, perceptual speed, verbal comprehension, verbal recall (general ability of verbal memory encoding, storage also measuring speed of processing via retrieval speed of verbal items).

In certain non-limiting embodiments, performance of alphanumeric exercises sessions lasts about 20-25 minutes long. Since new learning is facilitated by frequent training repetitions for attaining optimal improvement in performance, in a non-limiting embodiment it is recommended that the user perform a daily routine of at least 2 sessions. If alongside improvements in fluid intelligence abilities, improvement in memory performance (e.g., long term improvements) is also desired, each alphanumeric exercise session should last for at least 35 minutes (in healthy aging individuals, memory training session duration will be adjusted according to the user's age), twice a day in a daily fashion. In normal aging population, mini (short)-programs to improve performance in the specific trained cognitive skill may last from 3 to 6 months depending on the trained cognitive skill (e.g., memory, inductive reasoning, spatial orienting, speed of processing etc.) and/or cognitive decline domain area and severity. However, if the desired goal is to improve a specific trained cognitive skill competence and not only attain improvement in skill performance, longer-programs will be required that may last from 1 to 3 years. A variety of programs offering a number of booster sessions will also be available 3 to 6 months after a training program has been completed. It is estimated that a minimum of 80% participation in each program is required by the user for him/her to experience the desired performance improvements in the specific trained cognitive skill. In the MCI population, some programs such as the one focused on compensating or delaying memory and/or reasoning and visuospatial impairments, may require a daily routine program for as long as a user wishes to keep performing a given program.

It should be noted that the effects of some modules may be cumulative, meaning the improvement will build progressively as a function of repetitive and continuous use, and may last for months. Other modules may require daily use to retain improvements.

In certain non-limiting embodiments, a personal neuro-linguistic performance profile is established for a specific user who is then provided a personal access code. Once the profile is established, a selected suite of exercises, including e.g., language and/or visual simulation modules from a library of modules are accessed and downloaded (e.g., via the Internet) directly to an end user's computer, tablet, cellphone, iPod, etc.

To assess the herein cognitive training efficacy over time in adults and the elderly, and its effective rate of transfer to other untrained ability, a customized and adaptive version of the psychometric ability tests can be used. As discussed above, upon completion of an exercise session (comprising one or more exercises disclosed herein), the user may proceed to immediately test the impact of the session using a psychometric suite testing a primary cognitive ability (e.g., inductive reasoning, spatial orientation, numerical facility, perceptual speed, verbal comprehension, verbal recall [general ability of verbal memory encoding, storage also measuring speed of processing via retrieval speed of verbal items].)

Several methods (e.g., tests) for evaluating various aspects of fluid intelligence abilities are known in the art. Some exemplary tests are enumerated below. A person skilled in the art can readily select from available tests the one to use depending on the fluid intelligence ability being measured.

Inductive reasoning ability involves identification of novel relationships in serial patterns and the inference of principles and rules in order to determine additional serial patterns. Inductive reasoning is measured by e.g., The Primary Mental Ability Battery (PMA) reasoning test (See Thurstone, L. L., & Thurstone, T. G. (1949). Examiner Manual for the SRA Primary Mental Abilities Test (Form 10-14). Chicago: Science Research Associates.). The user is shown a series of letters (e.g., A B C B A D E F E) and is asked to identify the next letter in the series. Another test for inductive reasoning is the ADEPT letter series test (See Blieszner et al., Training research in aging on the fluid ability of inductive reasoning. Journal of Applied Developmental Psychology 1981; 2:247-265.). This is a similar test to the PMA reasoning test. In the word series test for inductive reasoning, the user is shown a series of words (e.g., January, March, May) and is asked to identify the next word in the series (See Schaie, K. W. (1985). Manual for the Schaie-Thurstone Adult Mental Abilities Test (STAMAT). Palo Alto, Calif.: Consulting Psychologists Press). In the ETS Number Series test, the user is shown a series of numbers (e.g., 6, 11, 15, 18, 20) and is asked to identify the next number that would continue the series. (See Ekstrom, R. B. et al., 1976. Kit of factor-referenced cognitive tests (rev. ed.). Princeton, N.J.: Educational Testing Service.). The Raven's Progressive Matrices (RPM) test measures (non-verbal) relational reasoning, or the ability to consider one or more relationships between mental representations (as the number of relations increases in the RPM, the user tend to respond more slowly and less accurately). The user is required to identify relevant features based on the spatial organization of an array of objects, and then select the object that matches one or more of the identified features. The Kaufman Brief Intelligence Test (KBIT) measures fluid and crystalized intelligence consisting of a core and expanded batteries, e.g., propositional analogy—like matrix reasoning tests, propositional analogy tests also evaluate relational reasoning. Propositional analogy testing entails the abstraction of a relationship between a familiar representation and mapping it to a novel representation. The user is required to determine whether the semantic relationship existing between two entities is the same as the relationship between two other, often completely different, entities.

Spatial orientation is the ability to visualize and mentally manipulate spatial configurations, to maintain orientation with respect to spatial objects, and to perceive relationships among objects in space. In the alphanumeric rotation test to measure spatial orientation, the user is shown a letter or number and is asked to identify which six other drawings represent the model rotated in two-dimensional space.

Numerical facility is the ability to understand numerical relationships and compute simple arithmetic functions. In the PMA number test, the user checks whether additions or simple sums shown are correct or incorrect. (See Thurstone & Thurstone, 1949, cited above). The addition test measures speed and accuracy in adding three single or two-digit numbers. (See Ekstrom, et al., 1976, cited above). The subtraction and multiplication test is a test of speed and accuracy with alternate rows of simple subtraction and multiplication problems (See Ekstrom et al. 1976, cited above)

Perceptual speed is the ability to search and find alphanumeric symbols, make comparisons and carry out other basic tasks involving visual perception, with speed and accuracy. For example in the Finding A's test, in each column of 40 words, the user must identify the five words containing the letter “A”. (See Ekstrom, et al., 1976, cited above). In the number comparison test, the user inspects pairs of multi-digit numbers and indicates whether the two numbers in each pair are the same or different. (See Ekstrom, et al., 1976, cited above).

Verbal comprehension (e.g., language knowledge and comprehension) is measured by assessing the scope of the user's recognition vocabulary. Verbal comprehension is measured by tests such as PMA verbal meaning which is a four-choice synonym test which is highly speeded. (See Thurstone & Thurstone, 1949, cited above). ETS Vocabulary II is a five-choice synonym test of moderate difficulty level, and ETS Vocabulary IV is another five-choice synonym test consisting mainly of difficult items (See Ekstrom, et al., 1976, cited above).

Verbal recall is the ability to encode, store and recall meaningful language units. In the Immediate Recall test, the user study a list of 20 words for 3½ minutes and then is given an equal period of time to recall the words in any order. (See Zelinski et al., Three-year longitudinal memory assessment in older adults: Little change in performance. Psychology and Aging 1993; 8: 176). In the Delayed Recall test, the user is asked to recall the same list of words as in Immediate Recall testing after an hour of intervening activities (other psychometric tests). (See Zelinski et al., 1993, cited above). In the PMA Word Fluency test, the user freely recalls as many words as possible according to a lexical rule within a five-minute period. (See Thurstone & Thurstone, 1949, cited above).

Memory tests measure verbal memory ability and memory change over time (assessing verbal list-learning and memory—recognition and delayed recognition and immediate and delayed recall) or measure memory behaviors characteristic of everyday life. The Hopkins Verbal Learning Test (HVLT and HVLT-R) is used to measure memory. The HVLT requires recall of a series of 12 semantically related words (four words from each of three semantic categories) over three learning trials, free recall after a delay, and a recognition trial. (See Brandt, J. & Benedict, R. (2001), Hopkins Verbal Learning Test-Revised: Professional Manual. PAR: Florida). In another memory test, the Rey-Auditory Verbal learning Test (AVLT), the user is presented (hears) with a 15-item list (List A) of unrelated words, which it is asked to write down (recall) immediately over five repeated free-recall trials. After five repeated free-recall trials, a second “interference” list (List B) is presented in the same manner, and the user is asked to recall as many words from list B as possible. After the interference trial (List B), the user is immediately asked to recall the words from list A, which he/she heard five times previously. After a 20 minute delay, the user is asked to again recall the words from List A. (See Rey A. Archives de Psychologie. 1941; 28:215-285). The Rivermead Behavioral Memory Test's (RBMT) battery consists of: (i) remembering a name (given the photograph of a face); (ii) remembering a belonging (some belonging of the testee is concealed, and the testee has to remember to ask for it back on completion of the test); (iii) remembering a message after a delay; (iv) an object recognition task (ten pictures of objects are shown, and the testee then has to recognize these out of a set of 20 pictures shown with a delay; (v) a face recognition task (similar to object recognition, but using five faces to be recognized later among five distractors); (vi) a task involving remembering a route round the testing room; and (vii) recall of a short story, both immediately and after a delay (See Wilson et al. The Rivermead Behavioural Memory Test. 34, The Square, Titchfield, Fareham, Hampshire PO14 4AF: Thames Valley Test Company; 1985).

In each of the non-limiting Examples below, the subject is presented with various exercises and prompted to make selections based upon the particular features of the exercises. It is contemplated that, within the non-limiting Examples 1-4, the choice method presented to the subject could be any one of three particular non-limiting choice methods: multiple choice; force choice; and/or go-no-go choice.

When the subject is provided with multiple choices when performing the exercise, the subject is presented multiple choices as to what the possible answer is. The subject must discern the correct answer/selection and select the correct answer from the given multiple choices.

Furthermore, when the force choice method is employed within the exercises, the subject is presented with only one choice for the correct answer and, as is implicit in the name, the subject is forced to make that choice. In other words, the subject is forced to select the correct answer because that is the only answer presented to the subject.

Likewise, a choice method presented to the subject is a go-no-go choice method. In this method, the subject is prompted to answer every time the subject is exposed to the correct answer. In a non-limiting example, the subject may be requested to click on a particular button each time a certain symbol is shown to the subject. Alternatively, the subject may be requested to click a different button each time another certain symbol is displayed. Thus, the subject clicks the button when the particular symbol appears and does not click any buttons if the particular symbol is not there.

The present subject matter is further described in the following non-limiting examples.

### Example 1

### Inductively Inferring the Next Term in an Alphabetical Sequence

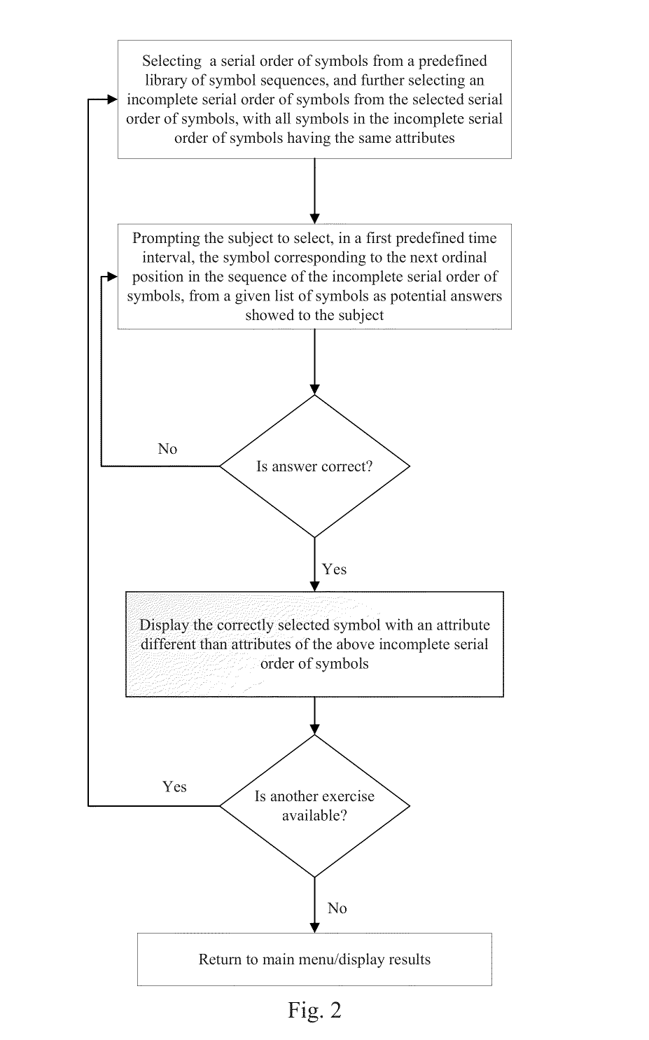

A goal of the exercise presented in Example 1 is to exercise elemental fluid intelligence ability namely, “inductive reasoning.” Specifically, the presented Example 1 exercises a subject ability to inductively infer the next term in a provided direct alphabetical letter symbols sequence or inverse alphabetical letter symbols sequence. FIG. 2 is a flow chart setting forth the method that the present exercises use in promoting fluid intelligence abilities in a subject by inductively inferring the next term.

As can be seen in FIG. 2, the method of promoting inductive reasoning in the subject comprises selecting a serial order of symbols from a predefined library of complete symbol sequences, and further selecting an incomplete serial order of symbols from the selected complete serial order of symbols. All of the symbols in the incomplete serial order of symbols have the same spatial or time perceptual related attributes. The subject is then prompted to select, in a first predefined time interval, the symbol corresponding to the next ordinal position in the sequence of the incomplete serial order of symbols, from a given list of symbols as potential answers showed to the subject. If the selection made by the subject is a correct selection, then the correctly selected symbol is displayed with a spatial or time perceptual related attribute different than attributes of the incomplete serial order of symbols. If the selection made by the subject is an incorrect selection, then the subject is returned to the step of being prompted to select the symbol corresponding to the next ordinal position in the sequence of the incomplete serial order of symbols. The above steps in the method are repeated for a predetermined number of iterations separated by one or more predefined time intervals, and upon completion of the predetermined number of iterations, the subject is provided with each iteration results. The predetermined number of iterations can be any number needed to establish that a satisfactory reasoning performance concerning the particular task at hand is being promoted within the subject. Non-limiting examples of number of iterations include 1, 2, 3, 4, 5, 6, and 7. However, any number of iterations can be performed, like 1 to 23.

In another aspect of Example 1, the method of promoting inductive reasoning in a subject is implemented through a computer program product. In particular, the subject matter in Example 1 includes a computer program product for promoting inductive reasoning in a subject, stored on a non-transitory computer-readable medium which when executed causes a computer system to perform a method. The method executed by the computer program on the non-transitory computer readable medium comprises selecting a serial order of symbols from a predefined library of complete symbol sequences, and further selecting an incomplete serial order of symbols from the selected complete serial order of symbols. All of the symbols in the incomplete serial order of symbols have the same spatial or time perceptual related attributes. The subject is then prompted to select, in a first predefined time interval, the symbol corresponding to the next ordinal position in the sequence of the incomplete serial order of symbols, from a given list of symbols as potential answers showed to the subject. If the selection made by the subject is a correct selection, then the correctly selected symbol is displayed with a spatial or time perceptual related attribute different than attributes of the incomplete serial order of symbols. If the selection made by the subject is an incorrect selection, then the subject is returned to the step of being prompted to select the symbol corresponding to the next ordinal position in the sequence of the incomplete serial order of symbols. The above steps in the method are repeated for a predetermined number of iterations separated by one or more predefined time intervals, and upon completion of the predetermined number of iterations, the subject is provided with each iteration results.

In a further aspect of Example 1, the method of promoting inductive reasoning in a subject is implemented through a system. The system for promoting inductive reasoning in a subject comprises: a computer system comprising a processor, memory, and a graphical user interface (GUI), the processor containing instructions for: selecting a serial order of symbols from a predefined library of complete symbol sequences, and further selecting an incomplete serial order of symbols from the selected complete serial order of symbols, wherein all symbols in the incomplete serial order of symbols have the same spatial or time perceptual related attributes; prompting the subject on the GUI to select, in a first predefined time interval, the symbol corresponding to the next ordinal position in the sequence of the incomplete serial order of symbols, from a given list of symbols as potential answers showed to the subject; if the selection made by the subject is a correct selection, then displaying the correctly selected symbol on the GUI with a spatial or time perceptual related attribute different than attributes of the incomplete serial order of symbols; if the selection made by the subject is an incorrect selection, then returning to the step of prompting the subject; repeating the above steps for a predefined number of iterations separated by one or more predefined time intervals; and upon completion of a predefined number of iterations, providing the subject with the results of all iterations.

For this non-limiting Example 1, the Example can include 4 block exercises. Each block exercise comprises 8 sequential trial exercises. In each trial exercise, a sequence of symbols is presented to the subject for a brief period of time. Without delay, upon seeing this sequence, the subject is required to inductively infer what would be the next-term following the last term presented in the sequence. When the symbol sequences are alphabetical sequences, member terms of the alphabetical sequences are single letters. More so, the present task has been designed to reduce cognitive workload by minimizing the dependency of the subject's reasoning inferring skills on real-time manipulation of information by the subject's working memory; therefore for each trial exercise, four subsequent symbol option answers are also displayed, from which the subject is requested to choose each time a single next-term symbol.

The subject is given a first predefined time interval within which the subject must validly perform the exercises. If the subject does not perform a given exercise within the first predefined time interval, also referred to as “a valid performance time period,” then after a delay, which could be of about 2 seconds, the next in-line letter string sequence type for the subject to perform is displayed. In an embodiment, the first predefined time interval or maximal valid performance time period for lack of response, is defined to be 10-20 seconds, in particular 15-20 seconds, and further specifically 17 seconds.

In the present Example, there are second predefined time intervals between block exercises. Let Δ1 herein represent a fixed time interval between block exercises' performances of the present task, where Δ1 is herein defined to be of 8 seconds. However, other time intervals are also contemplated, including without limitation, 5-15 seconds and the integral times there between.

In an aspect of the exercises of Example 1, the selection of the serial order of symbols is done at random, from predefined complete serial order of symbols of the library, and selection of the incomplete serial order of symbols is done also at random, from predefined number of symbols and predefined ordinal positions of these symbols, in the previously selected complete serial order of symbols. While this aspect of the exercises is easier to implement through the use of a computer program, it is also understood that the random selection of the serial order of symbols is also achievable manually.

In the exercises of Example 1, when alphabetic serial orders are utilized, two types of incomplete serial orders made up by alphabetical letter sequences, are provided in a predefined sequence: 1) a direct alphabetical sequence and 2) an inverse alphabetical sequence. Still, each direct alphabetical or inverse alphabetical sequence type initially displays, as a default, three letter terms. It is understood that the incompleteness of an alphabetical sequence is in relation to th complete direct alphabetic set array of the direct English alphabetical sequence consisting of A-Z letter terms, while the incompleteness of an inverse alphabetical letter sequence is in relation to the complete inverse alphabetic set array of the inverse English alphabetical sequence consisting of Z-A letter terms. Furthermore, for the exercises of Example 1, the letter terms or symbols are generally provided in their upper case (or capital) form, for example letter terms A, B, C, D, etc.

The alphabetical serial orders are provided to the subject in a way such that each member of the direct alphabetical serial order or inverse alphabetical serial order is provided as a single letter symbol.

The direct alphabetical serial order of letter symbols or inverse alphabetical serial order of letter symbols can be made of consecutive letter symbols. In an alternative aspect, the direct alphabetical letter serial order of symbols or inverse alphabetical letter serial order of symbols can be made of non-consecutive letter symbols.

For each block exercise of Example 1, a total of eight incomplete serial orders of letter symbols are provided to the subject. In an embodiment, from the eight incomplete serial orders of symbols provided to the subject, four of the incomplete serial orders of symbols are direct alphabetical and four of the incomplete serial orders of symbols are inverse alphabetical. In other non-limiting case, the direct alphabetical serial orders of symbols and inverse alphabetical serial orders of symbols are not presented in a predefined order, meaning that the subject is provided randomly with either a direct alphabetical serial order of symbols or inverse alphabetical serial order of symbols.

In providing the exercises in Example 1, a length of the original incomplete serial order of symbols is 2-6 symbols prior to the selecting of the next symbol by the subject. In another aspect of the present exercises, the length of the original incomplete serial order of symbols is 3 letter symbols prior to the selecting of the next letter symbol by the subject.

As discussed above, upon selection of the correct answer by the subject, the correct serial order of symbols is then displayed with the selected symbol being displayed with a spatial or time perceptual related attribute different than the attributes of the provided incomplete serial order of symbols. The changed spatial or time perceptual related attribute of the correct answer is selected from the group of spatial or time related perceptual attributes, which includes symbol color, symbol sound, symbol size, symbol font style, symbol spacing, symbol case, boldness of symbol, angle of symbol rotation, symbol mirroring, or combinations thereof. Furthermore, the correctly selected symbol may be displayed with a time related perceptual attribute “flickering” behavior in order to further highlight the correct answer.

In a particular aspect of the present Example, the change in attributes is done according to predefined correlations between space and time related attributes, and the ordinal position of those letter symbols in the selected complete serial order of symbols in the first step of the method. For the case of a subject's visual perception of a complete direct alphabetic set array of the English language, the first ordinal position (occupied by the letter “A”), will generally appear toward the left side of his/her field of vision, whereas the last ordinal position (occupied by the letter “Z”) will appear towards his/her right field of vision. For a non-limiting example of this predefined correlation, if the ordinal position of the letter symbol for which an attribute will be changed falls in the left field of vision, the change in attribute may be different than if the ordinal position of the letter symbol for which the attribute will be changed falls in the right field of vision. In this non-limiting example, if the attribute to be changed is the color of the letter symbol, and if the ordinal position of the letter symbol for which the attribute will be changed falls in the left field of vision, then the color will be changed to a first different color, while if the ordinal position of the letter symbol falls in the right field of vision, then the color will be changed to a second color different from the first color. Likewise, if the attribute to be changed is the size of the letter symbol being displayed, then those letter symbols with an ordinal position falling in the left field of vision will be changed to a first different size, while the letter symbols with an ordinal position falling in the right field of vision will be changed to a second different size that is yet different than the first different size.

As previously indicated above with respect to the general methods for implementing the present subject matter, the exercises in Example 1 are useful in promoting fluid intelligence abilities in the subject through the sensorial-motor and perceptual domains that jointly engage when the subject performs the given exercise. That is, the serial manipulating or discriminating of symbols by the subject engages body movements to execute selecting the next symbol, and combinations thereof. The motor activity engaged within the subject may be any motor activity jointly involved in the sensorial perception of the complete and incomplete serial order of symbols. While any body movements can be considered motor activity implemented by the subject body, the present subject matter is mainly concerned with implemented body movements selected from the group consisting of body movements of the subject's eyes, head, neck, arms, hands, fingers and combinations thereof.

By requesting that the subject engage in various degrees of body motor activity, the exercises of Example 1 are requiring the subject to bodily-ground cognitive fluid intelligence abilities. The exercises of Example 1 cause the subject to revisit an early developmental realm where he/she implicitly acted\experienced fast and efficient enactment of fluid cognitive abilities when specifically dealing with serial pattern recognition of non-concrete terms\symbols meshing with their salient spatial-time related attributes. The established relationships between these non-concrete terms\symbols and their salient spatial and/or time related attributes heavily promote symbolic knowhow in a subject. By doing this, the exercises of Example 1 strengthen the ability to infer the next term in an incomplete series of terms through inductive reasoning within the subject. It is important that the exercises of Example 1 accomplish this downplaying or mitigating as much as possible the subject need to recall-retrieve and use verbal semantic or episodic memory knowledge in order to support or assist his/her inductive reasoning strategies to problem solving of the exercises in Example 1. The exercises of Example 1 are mainly within promoting fluid intelligence in general and inductive reasoning in particular in the subject, but do not rise to the operational level of promoting crystalize intelligence via explicit associative learning based on declarative semantic knowledge. As such, the specific letter strings and unique serial orders of letter symbols are herein selected to specifically downplay or mitigate the subject's need for developing problem solving strategies and/or drawing inductive-deductive inferences necessitating verbal knowledge and/or recall-retrieval of information from declarative-semantic and/or episodic kinds of memories.

In an aspect of the exercises present Example 1, the library of complete sequences includes the following complete sequences as defined above: direct alphabetic set array; inverse alphabetic set array; direct type of alphabetic set array; inverse type of alphabetic set array; central type of alphabetic set array; and, inverse central type alphabetic set array. It is understood that the above library of complete sequences may contain additional set arrays sequences or fewer set arrays sequences than those listed above.

Furthermore, it is also important to consider that the exercises of Example 1 are not limited to serial orders of alphabetic symbols. It is also contemplated that the exercises are also useful when numeric serial orders and/or alpha-numeric serial orders are used within the exercises. In other words, while the specific examples set forth employ serial orders of letter symbols, it is also contemplated that serial orders comprising numbers and/or alpha-numeric symbols can also be used.

In an aspect of the present subject matter, the exercises of Example 1 include providing a graphical representation of a letter, in a ruler shown to the subject, when providing the subject with an incomplete direct alphabetical sequence (which is an incomplete direct alphabetic set array) or an inverse alphabetical sequence (which is an incomplete inverse alphabetic set array). The visual presence of the ruler helps the subject to perform the exercise, by promoting a fast visual spatial recognition of the presented letter sequence, in order to assist the subject to manipulate and inductively infer the next letter. In the present exercises, the ruler comprises one of a plurality of sequences in the above disclosed library of complete sequences, namely direct alphabetic set array; inverse alphabetic set array; direct type of alphabetic set array; inverse type of alphabetic set array; central type of alphabetic set array; and inverse central type alphabetic set array.

The methods implemented by the exercises of Example 1 also contemplate those situations in which the subject fails to perform the given task. The following failing to perform criteria is applicable to any exercise in any block exercise of the present task in which the subject fails to perform. Specifically, for the present exercises, there are two kinds of “failure to perform” criteria. The first kind of “failure to perform” criteria occurs in the event the subject fails to perform by not click-selecting (that is, the subject remains inactive/passive) with the subject's hand-held mouse device on the valid or not valid next-term option choice displayed (among 4 next-term option choices), within a valid performance time period, then after a delay, which could be of about 2 seconds, the next in-line letter sequence type trial exercise for the subject to perform is displayed. In embodiments, this valid performance time period is defined to be specifically 17 seconds.

The second “failure to perform” criteria is in the event the subject fails to perform by selecting consecutively twice on the wrong next-term option choice displayed. More so, as an operational rule applicable for any failed trial exercise of the present task, failure to perform results in the automatic displaying of the next in-line require to perform letter sequence type trial exercise for the subject to correctly infer the next-term. However, in the event the subject fails to correctly infer the next-term option choice for any herein required to perform incomplete serial orders of symbols in excess of 2 non-consecutive trial exercises (in a single block exercise), then one of the following two options will occur: 1) if the failure to perform is for more than 2 non-consecutive trial exercises (in a single block exercise of Example 1), then the subject's current block-exercise performance is immediately halted and after a time interval of about 2 seconds, the next in-line herein require to perform letter sequence type in its respective trial exercise will immediately be displayed (for the subject to perform) in the next in-line block exercise; or 2) (which is only relevant for the last block exercise of Example 1) the subject will be immediately exited from the remainder of the fourth block exercise and returned back to the main menu of the program.

Total duration to complete the exercises of Example 1, as well as the time it took to implement each one of the individual trial exercises, is registered in order to help generate an individual and age-gender group performance score. Records of all wrong next-term letter symbol option choices answers for all type letter symbols sequences displayed and required to be performed are also generated and displayed. In general, the subject will perform this task about 6 times during their-based brain mental fitness training program.

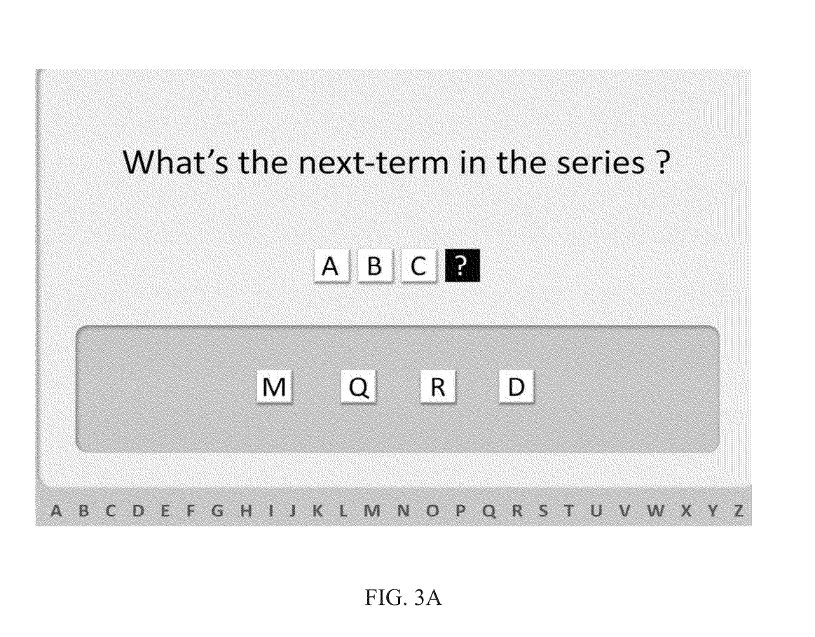

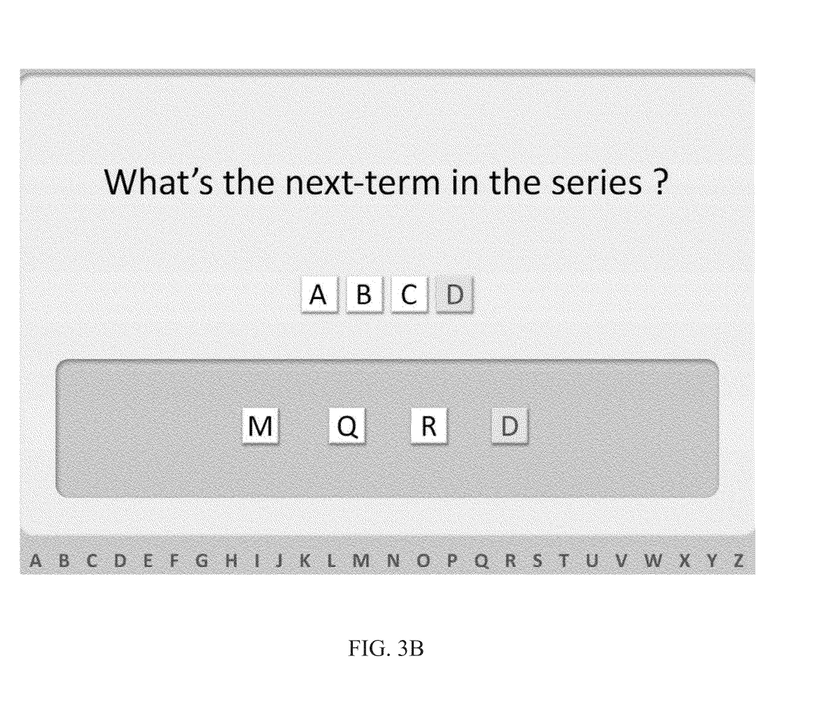

FIGS. 3A-3B depicts a number of non-limiting examples of the exercises for inductively inferring the next symbol in an incomplete serial order of symbols. FIG. 3A shows a direct alphabetical serial order of symbols comprising three letter symbols and prompts the subject to correctly select the fourth letter symbol. In this case, the subject is provided with A, B and C, letter symbols and given the letter symbols M, Q, R and D as options for selecting the next term letter symbol. FIG. 3B shows that the correct selection is the letter symbol D. As can be seen, the letter symbol D replaces the question mark in the original incomplete serial order of letter symbols and is highlighted by changing time related perceptual attribute of color. The correct selection in the given possible answers is also highlighted by changing the time related perceptual attribute of color. It is understood that other spatial or time perceptual related attributes could also be changed to highlight the correct answer.

As is explained above, the provided incomplete serial order of letter symbols can be either direct alphabetical or inverse alphabetical. Likewise, the provided incomplete serial order of letter symbols can comprise consecutive letter symbols or non-consecutive letter symbols.

As is shown in this exercise with respect to FIGS. 3A-3B, the incomplete serial order of letter symbols provided to the subject is a consecutive direct alphabetical letter sequence. It is understood that the provided incomplete serial orders of letter symbols could also be a non-consecutive direct alphabetical letter sequence, a consecutive inverse alphabetical letter sequence, or a non-consecutive inverse alphabetical letter sequence.

### Example 2

### Fluid Intelligence Ability to Efficiently Discriminate Sameness Versus Differentness in Letter Symbols Sequences

The goal of the present exercises of Example 2 is to efficiently exercise a basic fluid intelligence skill related to the ability of quickly and accurately discriminating commonness versus non-commonness between two pattern sequences of symbols displayed at once. Specifically, the aim of the present exercises is to steer the subject's reasoning strategy to focus on efficiently grasping sameness versus differentness concerning sequential pattern properties of the two sequences of symbols and the specific spatial or time perceptual related attributes of their symbols. The present task also exercises the subject's reasoning/grasping ability to implicitly pick-up, if existing, common (abstract) rules that characterize both symbols sequences. Accordingly, the goal is mainly concerned with finding out if the presented symbol sequences are: 1) identical or 2) different. To that effect, in a non-limiting aspect of Example 2, the subject is presented with an incomplete direct alphabetic set array consisting of A-Z letters symbols and with an incomplete inverse alphabetic set array consisting of Z-A letters symbols of various letter lengths.

In the context of the present exercises, it is important to clarify the definition of sameness or differentness of symbols making up the alphabetical letter string sequences. Both same and different incomplete direct alphabetic and incomplete inverse alphabetic set arrays displayed in any trial exercise herein comprise a set of the same letter terms and same number of letter terms. Therefore, in the specific context of the present exercises, being different does not only mean that an incomplete direct or inverse alphabetic set array possesses: 1) at least one altered letter term in the letter sequence, as for example ABC≠ATC; or 2) at least one letter term in excess or lacking in the letter sequence, as for example ABC⊕ABCD or ABC⊕AB. Still, the concept of being identical in the present exercises does not simply mean two letter symbols sequences that entail, for example, same repeated letter terms. Rather, sameness or differentness of letter symbols sequences are herein linked to a related or correlated or cross-correlated property of letter symbols spatial or time perceptual related attributes amongst the letter terms of the two letter symbols sequences, requiring the following considerations: 1) at least one letter term of the two letter sequences could have a different spatial or time perceptual related attribute, 2) when reasoning in trying solving the problem of sameness or difference concerning two letter symbols sequences with same letter terms and same number of letter terms should be considered; 3) according to 1 and 2 above, when the subject is required to reason about differentness among two letter symbols sequences, one letter term must have at least one altered spatial or time perceptual related attribute in relation to the letter terms in the other letter sequence; and 4) according to 1 and 2 above, when the subject is required to reason about sameness among two letter symbols sequences, all letter symbols in their respective letter symbols sequences must not differ in a single spatial or time perceptual related attribute.

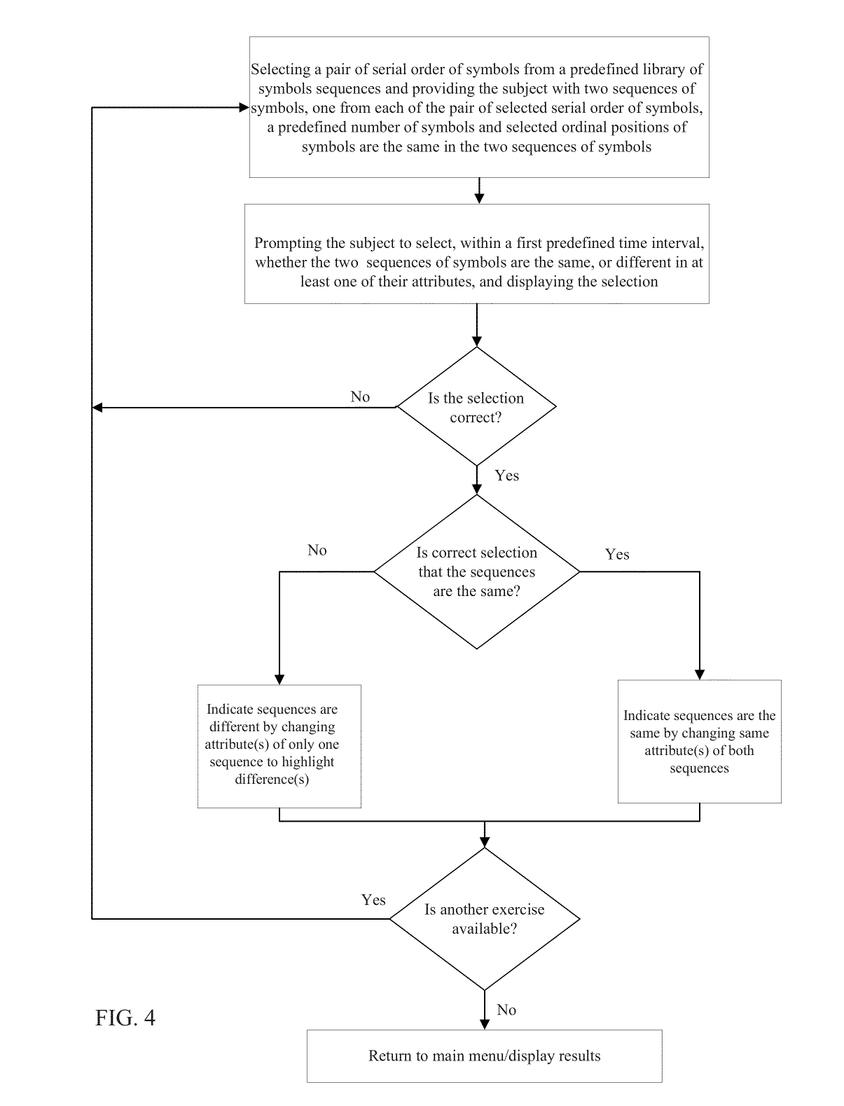

FIG. 4 is a flow chart setting forth the method that the present exercises use in promoting fluid intelligence abilities in a subject. In the present exercise the subject reasons about the similarity or disparity in letter sequences. As can be seen in FIG. 4, the method of promoting fluid intelligence reasoning ability in the subject comprises selecting a pair of serial orders of symbols from a predefined library of complete symbols sequences and providing the subject with two sequences of symbols, one from each of the pair of selected serial order of symbols. A predefined number of symbols and their selected ordinal positions of these symbols are the same in the two provided sequences of symbols. The subject is then prompted to select, within a first predefined time interval, whether the two provided sequences of symbols are the same, or different in at least one of their spatial or time perceptual related attributes, and the selection is displayed. If the selection made by the subject is an incorrect selection, then the subject is returned to the step of selecting a pair of serial orders of symbols. If the selection made by the subject is a correct selection and the correct selection is that the two sequences of symbols are the same, then the correct selection is displayed with an indication that the two sequences of symbols are the same by changing at least one spatial or time perceptual related attribute in both sequences of symbols. If the selection made by the subject is a correct selection and the correct selection is that the two provided sequences of symbols are different, then the correct selection is displayed with an indication that the two provided sequences of symbols are different by changing at least one spatial or time perceptual related attribute of only one sequence of symbols to highlight the difference between the two provided sequences of symbols. The above steps of the method are repeated for a predetermined number of iterations separated by one or more predefined time intervals, and upon completion of the predetermined number of iterations, the subject is provided with each iteration results. The predetermined number of iterations can be any number needed to establish that a satisfactory reasoning performance concerning the particular task at hand is being promoted within the subject. Non-limiting examples of number of iterations include 1, 2, 3, 4, 5, 6, and 7. However, any number of iterations can be performed, like 1 to 23.

In another aspect of Example 2, the method of promoting fluid intelligence reasoning ability in a subject is implemented through a computer program product. In particular, the subject matter of Example 2 includes a computer program product for promoting fluid intelligence reasoning ability in a subject, stored on a non-transitory computer-readable medium which when executed causes a computer system to perform a method. The method executed by the computer program product on the non-transitory computer readable medium comprises selecting a pair of serial orders of symbols from a predefined library of complete symbols sequences and providing the subject with two sequences of symbols, one from each of the pair of selected serial order of symbols. A predefined number of symbols and selected ordinal positions of symbols are the same in the two provided sequences of symbols. The subject is then prompted to select, within a first predefined time interval, whether the two provided sequences of symbols are the same, or different in at least one of their spatial or time perceptual related attributes, and the selection is displayed. If the selection made by the subject is an incorrect selection, then the subject is returned to the step of selecting a pair of serial orders of symbols. If the selection made by the subject is a correct selection and the correct selection is that the two provided sequences of symbols are the same, then the correct selection is displayed with an indication that the two provided sequences of symbols are the same by changing at least one spatial or time perceptual related attribute in both sequences of symbols. If the selection made by the subject is a correct selection and the correct selection is that the two provided sequences of symbols are different, then the correct selection is displayed with an indication that the two provided sequences of symbols are different by changing at least one spatial or time perceptual related attribute of only one sequence of symbols to highlight the difference between the two provided sequences of symbols. The above steps of the method are repeated for a predetermined number of iterations separated by one or more predefined time intervals, and upon completion of the predetermined number of iterations, the subject is provided with each iteration results.

In a further aspect of Example 2, the method of promoting fluid intelligence reasoning ability in a subject is implemented through a system. The system for promoting fluid intelligence reasoning ability in a subject comprises: a computer system comprising a processor, memory, and a graphical user interface (GUI), the processor containing instructions for: selecting a pair of serial orders of symbols from a predefined library of complete symbols sequences and providing the subject on the GUI with two sequences of symbols, one from each of the pair of selected serial order of symbols, wherein a predefined number of symbols and selected ordinal positions of symbols are the same in the two sequences of symbols; prompting the subject on the GUI to select, within a first predefined time interval, whether the two provided sequences of symbols are the same, or different in at least one of their spatial or time perceptual related attributes, and displaying the selection; if the selection made by the subject is an incorrect selection, then returning to the step of selecting a pair of serial orders of symbols; if the selection made by the subject is a correct selection and the correct selection is that the two provided sequences of symbols are the same, then displaying the correct selection on the GUI and indicating that the two provided sequences of symbols are the same by changing at least one spatial or time perceptual related attribute in both sequences of symbols; if the selection made by the subject is a correct selection and the correct selection is that the two provided sequences of symbols are different, then displaying the correct selection on the GUI and indicating that the two provided sequences of symbols are different by changing at least one spatial or time perceptual related attribute of only one sequence of symbols to highlight the difference between the two provided sequences of symbols; repeating the above steps for a predetermined number of iterations separated by one or more predefined time intervals; and upon completion of the predetermined number of iterations, providing the subject with each iteration results.

In an aspect of the exercises of Example 2, the selection of the pair of serial order of symbols is done at random, from a predefined library of complete serial order of symbols, and selection of the two sequences of symbols is done also at random, from predefined number of symbols and predefined ordinal positions of these symbols, in the previously selected pair of complete serial order of symbols. While this aspect of the exercises is easier to implement through the use of a computer program, it is also understood that the random selection of the serial order of symbols is also achievable manually.

The subject is given a predefined time interval within which the subject must validly perform the exercises. If the subject remains passive, and for whatever reason does not perform the exercise within the predefined time interval, also referred to as “a valid performance time period”, then after a delay, which could be of about 4 seconds, the next in-line letter string sequence type for the subject to perform is displayed. In an embodiment, this predefined time interval or maximal valid performance time period for lack of response is defined to be 10-60 seconds, in particular 30-50 seconds, and further specifically 45 seconds.

In the present Example, there are also predefined time intervals between block exercises. Let Δ1 herein represent a fixed time interval between block exercises' performances of the present task, where Δ1 is herein defined to be of 8 seconds. However, other time intervals are also contemplated, including without limitation, 5-15 seconds and the integral times there between.

In a non-limiting embodiment, Example 2 includes four block exercises. Each block exercise comprises six trial exercises that are displayed sequentially. In block exercises #1-#4, each trial exercise displays, for a brief period of time, letter symbols sequences in the following manner: 1) two A-Z letter symbols sequences, also referred herein as incomplete direct alphabetic set arrays; or 2) two incomplete inverse alphabetic Z-A set arrays. Consequently, upon seeing and reasoning about these two incomplete direct alphabetic or two incomplete inverse alphabetic set arrays being displayed during a predefined time window, the subject is required, without delay, to quickly select if the pattern of the letters sequences and the letters spatial or time perceptual related attributes of the two presented letter symbols sequences are: 1) identical (according to criteria and rules explained above) or 2) different (according to criteria and rules explained above). Subsequently, for option 1) above, the subject selects as fast as possible the option that the two letter symbols sequences are the “same”, thus immediately ending the current exercise; or, if option 2) above was chosen, the subject selects as fast as possible that the two letter symbols sequences are “different,”, thus immediately ending the current exercise. All exercises in all block exercises #1-#4 follow the same operational procedure as explained above.

The incomplete direct alphabetic set array or the incomplete inverse alphabetic set array can be made of consecutive letter symbols. In an alternative aspect, the incomplete direct alphabetic set array or incomplete inverse alphabetic set array can be made of non-consecutive letter symbols.

As discussed above, if the selection made by the subject is a correct selection and the correct selection is that the two patterns of letter symbols in the sequences are the same, then the correct selection is displayed with an indication that the two patterns of letter symbols in the sequences are the same by changing at least one same spatial or time perceptual related attribute in both sequences of letter symbols. The changed spatial or time perceptual related attribute of the correct answer is selected from the group of spatial or time perceptual related attributes, or combinations thereof. In a particular aspect, the changed spatial or time perceptual related attributes are selected from the group including symbol color, symbol sound, symbol size, symbol font style, letter symbol spacing, letter symbol case, boldness of letter symbol, angle of letter symbol rotation, letter symbol mirroring, or combinations thereof. Furthermore, the correctly selected letter symbol may be displayed with time perceptual related attribute flickering behavior in order to further highlight the correct selection.

Similarly, if the selection made by the subject is a correct selection and the correct selection is that the two patterns of letter symbols in the sequences are different in at least one spatial or time perceptual related attribute, then the correct selection is displayed with an indication that the two patterns of letter symbols sequences are different by changing at least one spatial or time perceptual related attribute of only one pattern of letter symbols in one of the sequences to highlight the difference between the two patterns of letter symbols in the sequences. The changed spatial or time perceptual related attribute of the correct answer is selected from the group consisting of spatial or time perceptual related attributes, or combinations thereof. In particular, the changed spatial or time perceptual related attribute is selected from the group including symbol color, symbol sound, symbol size, symbol font style, letter symbol spacing, letter symbol case, boldness of letter symbol, angle of letter symbol rotation, letter symbol mirroring, or combinations thereof. Furthermore, the correctly selected letter symbol may be displayed with a time perceptual related attribute flickering behavior in order to further highlight the correct answer.

In a particular aspect of the present Example, the change in attributes is done according to predefined correlations between space and time related attributes, and the ordinal position of those letter symbols in the selected complete serial order of symbols in the first step of the method. For the case of the subject's visual perception of a complete direct alphabetic set array of the English language, the first ordinal position (occupied by the letter “A”), will generally appear towards the left side of his/her fields of vision, whereas the last ordinal position (occupied by the letter “Z”) will appear towards his/her right visual field of vision. For a non-limiting example of these predefined correlations, if the ordinal position of the letter symbol for which an attribute will be changed falls in the left field of vision, the change in attribute may be different than if the ordinal position of the letter symbol for which the attribute will be changed falls in the right field of vision. In this non-limiting example, if the attribute to be changed is the color of the letter symbol, and if the ordinal position of the letter symbol for which the attribute will be changed falls in the left field of vision, then the color will be changed to a first different color, while if the ordinal position of the letter symbol falls in the right field of vision, then the color will be changed to a second color different from the first color. Likewise, if the attribute to be changed is the size of the letter symbol being displayed, then those letter symbols with an ordinal position falling in the left field of vision will be changed to a first different size, while the letter symbols with an ordinal position falling in the right field of vision will be changed to a second different size that is yet different than the first different size.

For those exercises in which the two patterns of letter symbols sequences are different, the difference between the two patterns of letter symbols can be at least one different spatial or time perceptual related attribute amongst the respective letter symbols. The at least one spatial perceptual related attribute different amongst the two letter symbols sequences can be any spatial perceptual related attribute previously discussed herein, namely an attribute selected from the group including, symbol size, symbol font style, letter symbol spacing, letter symbol case, boldness of letter symbol, angle of letter symbol rotation, letter symbol mirroring, or combinations thereof. These attributes are considered spatial perceptual related attributes of the letter symbols. The at least one attribute different amongst the two patterns of letter symbols sequences can be any attribute previously discussed herein, namely an attribute selected from the time perceptual related attributes of the letter symbols including symbol color, symbol sound and symbol flickering. Other spatial perceptual related attributes of letter symbols that could be used to discern sameness and differentness between two patterns of letter symbols include, without limitation, letter symbol vertical line of symmetry, letter symbol horizontal line of symmetry, letter symbol vertical and horizontal lines of symmetry, letter symbol infinite lines of symmetry, and letter symbol with no line of symmetry.

A further difference that can be a basis for the subject to select that the two patterns of letter symbols are different is the change in serial order of the letter symbols between the two letter symbols patterns. In other words, if the letter symbols within the two patterns of letter symbols sequences are not in the same serial order, then the subject should select that the two patterns of letter symbols are different.

In each one of block exercises #1-#4, there are six trial exercises, where each trial exercise displays two letter symbols sequences, and therefore a total of 12 letter symbols sequences are displayed in each block exercise. In embodiments wherein letter symbols sequences are not randomly selected, within the 12 letter symbols sequences, six are incomplete direct alphabetic set arrays, and six are incomplete inverse alphabetic set arrays. In general, the total number of incomplete direct and inverse alphabetic set arrays to be displayed to the subject is 48, and the subject is requested to perform the exercises accordingly. Furthermore, each of the two patterns of letter symbols in the sequences for each trial exercise comprises 2-7 letter symbols. Particularly, each of the two patterns of letter symbols sequences comprises 3-5 letter symbols.

As is the case with respect to the exercises in Example 1, the exercises in Example 2 are useful in promoting fluid intelligence abilities in the subject by grounding basic fluid cognitive activity in selective motor activity that occur when the subject performs the given exercise. That is, the manipulating or discriminating by the subject engages motor activity within the subject's body. The motor activity engaged within the subject may be any motor activity jointly involved in the sensorial perception of the selected complete and further selected incomplete serial orders of letter symbols, in body movements to execute selecting differentness or sameness among letter symbols sequences based on serial pattern recognition\identification of at least one spatial or time related perceptual attribute, and combinations thereof. While any body movements can be considered motor activity within the subject, the present subject matter is concerned with body movements selected from the group consisting of body movements of the subject's eyes, head, neck, arms, hands, fingers and combinations thereof.

In an aspect of the exercises present Example 2, the library of complete symbol sequences includes the following complete symbol sequences as defined above: direct alphabetic set array; inverse alphabetic set array; direct type of alphabetic set array; inverse type of alphabetic set array; central type of alphabetic set array; and, inverse central type alphabetic set array. It is understood that the above library of complete symbol sequences may contain additional set arrays or fewer set arrays than those listed above.

Furthermore, it is also important to consider that the exercises of Example 2 are not limited to serial orders of alphabetic symbols. It is also contemplated that the exercises are also useful when numeric serial orders and/or alpha-numeric serial orders are used within the exercises. In other words, while the specific examples set forth employ serial orders of letter symbols, it is also contemplated that serial orders comprising numbers and/or alpha-numeric symbols can be used.

In an aspect of the present subject matter, the exercises of Example 2 include providing a graphical representation of a letter set array sequence, in a ruler shown to the subject. The ruler provided to the subject is the selected direct alphabetic set array or inverse alphabetic set array. The visual presence of the ruler helps the subject to perform the exercise, by promoting a fast visual spatial recognition of the presented pattern of letter symbols sequences, in order to assist the subject to reason about the similarity or disparity in letter symbols sequences. In the present exercises, the ruler comprises one of a plurality of symbols sequences in the above disclosed library of set arrays sequences, namely direct alphabetic set array; inverse alphabetic set array; direct type of alphabetic set array; inverse type of alphabetic set array; central type of alphabetic set array; and inverse central type alphabetic set array.

The methods implemented by the exercises of Example 2 also contemplate those situations in which the subject fails to perform the given task. The following failing to perform criteria is applicable to any exercise in any block exercise of the present task in which the subject fails to perform. Specifically, for the present exercises, there are two kinds of “failure to perform” criteria. The first kind of “failure to perform” criteria occurs in the event the subject fails to perform for whatever reason by not selecting a valid choice of “same” or “different”, within a valid performance time period, then after a delay, which could be of about 4 seconds, the next in-line serial orders of symbols for the subject to perform is displayed. In embodiments, this valid performance time period for lack of response is defined to be 10-50 seconds, in particular 15-40 seconds, and further specifically 45 seconds. Failure to perform because of a lack of response prompts the display of up to three new additional trial exercises to the subject, unless the failure to select an answer occurs in the last block exercise, in which case the exercises are terminated and the subject is returned to the main menu of examples.

The second “failure to perform” criteria is in the event the subject fails to perform by selecting the wrong choice of “same” or “different”. More so, as an operational rule applicable for any failed trial exercise of the present task, failure to perform results in the automatic displaying of the next in-line require to perform serial order of symbols in its respective trial exercise for the subject to correctly reason whether the two pattern of letter symbols sequences are the same or different. However, in the event the subject fails to correctly reason about symbol attributes sameness or differentness in excess of 2 non-consecutive trial exercises (in a single block exercise), then one of the following two options will occur: 1) if the failure to perform is for more than 2 non-consecutive trial exercises (in a single block exercise of Example 2), then the subject's current block-exercise performance is immediately halted and after a time interval of about 4 seconds, the next in-line herein require to perform for the two letter sequences in its respective trial exercise, will immediately be displayed (for the subject to perform) in the next in-line block exercise; or 2) (which is only relevant for the last block exercise of Example 2) the subject will be immediately exited from the remainder of the fourth block exercise and returned back to the main menu of the computer program.

Total duration to complete the exercises of Example 2, as well as the time it took to implement each one of the individual trial exercises, is registered in order to help generate an individual and age-gender group performance score. Records of all wrong answers for all type serial orders displayed and required to be performed are also generated and displayed. In general, the subject will perform this task about 6 times during their-based brain mental fitness training program.

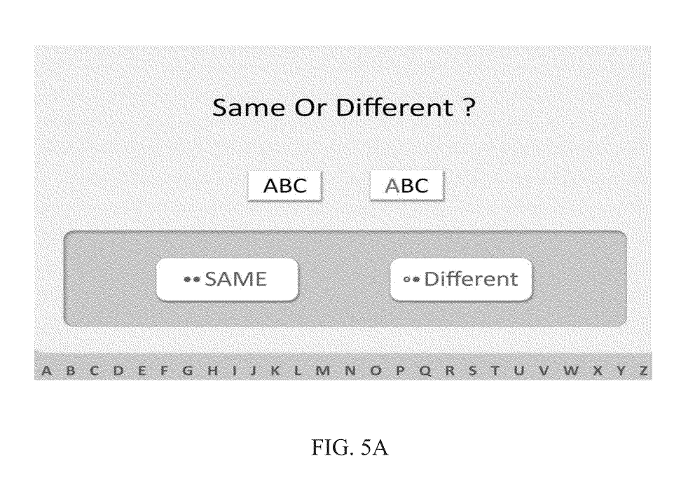

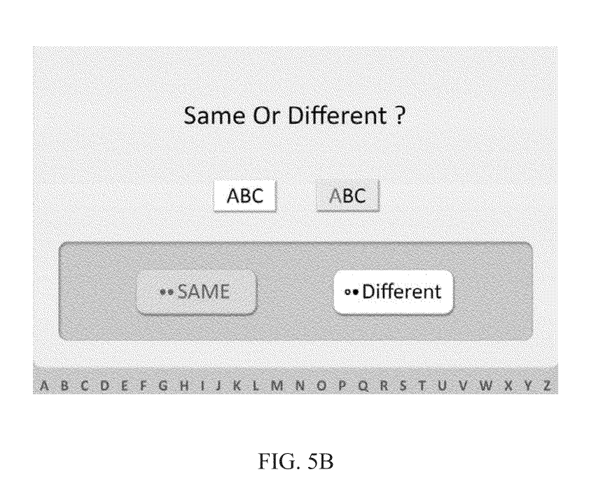

FIGS. 5A-5B depicts a number of non-limiting examples of the exercises for reasoning about the sameness and differentness in two serial orders of symbols. FIG. 5A shows two serial orders of symbols, each comprising three letter symbols and prompts the subject to correctly select whether the serial orders are the same or different. In this case, the subject is provided with two patterns of symbols comprising symbols A, B and C, in the same serial order but containing different spatial or time perceptual related attributes (the letter symbol A is of a different time related color attribute in one of the two patterns of letter symbols sequences). In this exercise, the subject should select that the two patterns of letter symbols sequences are different, as is shown in FIG. 5B. While the exercise depicted in FIGS. 5A and 5B shows one of the letter symbols having a changed time related attribute in the form of a color change, it is understood that any previously discussed spatial or time perceptual related attribute could be changed in lieu of, or in addition to, the changed time related color attribute. The subject matter of Example 2 contemplates that up to 7 different spatial or time perceptual related attributes could be changed amongst the two serial orders of letter symbols sequences where sameness or differentness is required to discriminate. Furthermore, the exercise in FIGS. 5A and 5B uses a portion (incomplete direct alphabetic set array) of a direct alphabetical serial order of symbols, and it should be understood that a portion (incomplete inverse alphabetic set array) of an inverse alphabetical serial order of symbols are also used in the various exercises. It should also be understood that, while the exercise in FIGS. 5A and 5B depict two serial orders comprising three symbols each, any number of symbols could be used in the serial orders, namely from 2-7 symbols per serial order.

Furthermore, it is noted that the series of symbols in each of the two letter symbols sequences are consecutive letter terms of an incomplete direct alphabetic set array of letter symbols. It is contemplated that the series of symbols of the two letter symbols sequences provided to the subject could also be of non-consecutive letter terms of an incomplete direct alphabetic set array of letter symbols, as well as consecutive letter terms of an incomplete inverse alphabetic set array of letter symbols, or non-consecutive letter terms of an incomplete inverse alphabetic set array of letter symbols.

### Example 3

### Completing an Incomplete Letter Sequence by Serial Order Insertion of Missing Letters

The goal of the present exercises of Example 3 is to exercise the fast insertion of a number of missing symbols into their correct ordinal position within a serial order of symbols having the same spatial or time perceptual related attributes. In a non-limiting embodiment of the present exercises, the goal is the fast insertion of a number of missing letter symbols into their correct direct alphabetical or inverse alphabetical serial order positions in an incomplete direct alphabetical (A-Z) or incomplete inverse alphabetical (Z-A) symbols sequence. At the end of a successful symbols insertion exercise, the subject ends up with a complete serial order of symbols with the same spatial or time perceptual related attributes, in particular a complete direct alphabetical or complete inverse alphabetical serial order of symbols, herein defined as direct alphabetic or inverse alphabetic set arrays.

In the particular non-limiting embodiment of the present exercises, the subject is required to insert a number of uppercase missing letter symbols in their correct serial alphabetical order position in an incomplete direct alphabetic set array or in an incomplete inverse alphabetic set array. Specifically, the exercises comprise the display of three sequential block exercises, each comprising two trial exercises. For example, each block exercise first trial exercise could display an incomplete direct alphabetic set array followed immediately by a second trial exercise displaying an incomplete inverse alphabetic set array (this exercise contemplates the completion of six incomplete alphabetic set arrays.) Accordingly, in each block exercise, both types of incomplete alphabetic set arrays, namely, an incomplete direct alphabetic set array type and an incomplete inverse alphabetic set array type are generated and provided to the subject.

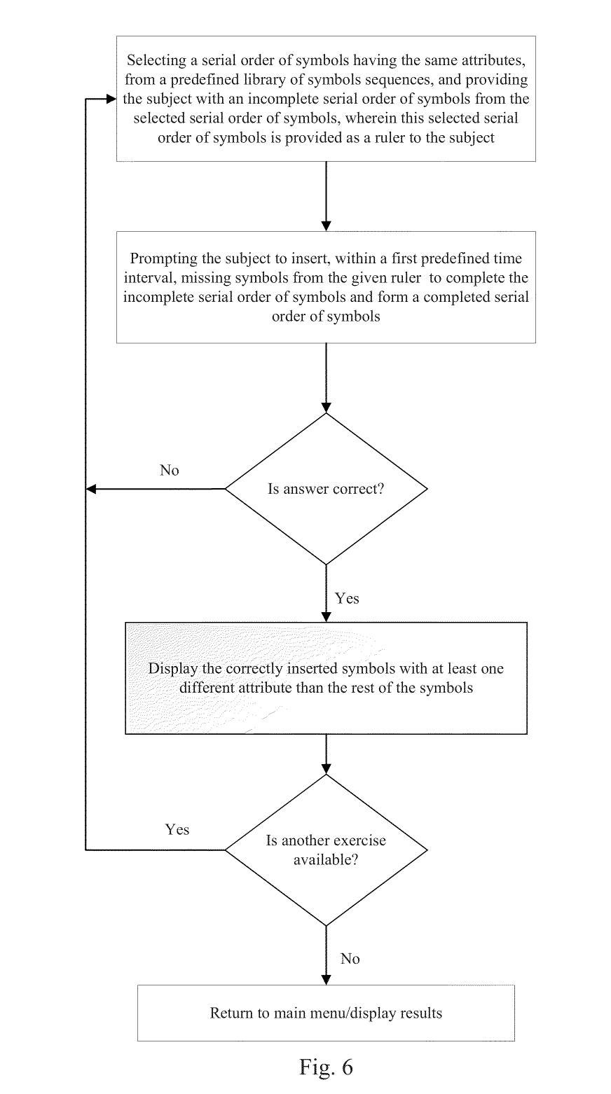

FIG. 6 is a flow chart setting forth the method that the present exercises uses in promoting fluid intelligence abilities in a subject by the reasoning strategies the subject utilizes in order to insert missing symbols into an incomplete serial order of symbols sequence to form a completed serial order of symbols sequence. As can be seen in FIG. 6, the method of promoting fluid intelligence reasoning ability in the subject comprises selecting a serial order of symbols having the same spatial or time perceptual related attributes, from a predefined library of complete symbols sequences, and providing the subject with an incomplete serial order of symbols from the selected complete serial order of symbols. This selected complete serial order of symbols is graphically provided as a ruler to the subject. The subject is then prompted to insert, within a first predefined time interval, missing symbols from the given array of symbols in the ruler, to complete the incomplete serial order of symbols and form a completed serial order of symbols. If at least one symbol insertion made by the subject is an incorrect symbol insertion, then the subject is returned to the step of selecting a complete serial order of symbols having the same spatial or time perceptual related attributes. If the symbols insertions made by the subject are all correct symbols insertions, then the correctly inserted symbols are displayed with at least one different spatial or time perceptual related attribute than the rest of the symbols in the completed symbols sequence. The above steps of the method are repeated for a predetermined number of iterations separated by one or more predefined time intervals, and upon completion of the predetermined number of iterations, the subject is provided with each iteration results. The predetermined number of iterations can be any number needed to establish that a satisfactory reasoning performance concerning the particular task at hand is being promoted within the subject. Non-limiting examples of number of iterations include 1, 2, 3, 4, 5, 6, and 7. However, any number of iterations can be performed, like 1 to 23.

In another aspect of Example 3, the method of promoting fluid intelligence reasoning ability in a subject is implemented through a computer program product. In particular, the subject matter in Example 3 includes a computer program product for promoting fluid intelligence reasoning ability in a subject, stored on a non-transitory computer-readable medium which when executed causes a computer to perform a method. The method executed by the computer program on the non-transitory computer readable medium comprises selecting a serial order of symbols having the same spatial or time perceptual related attributes, from a predefined library of complete symbols sequences, and providing the subject with an incomplete serial order of symbols from the selected complete serial order of symbols. The selected complete serial order of symbols is graphically provided as a ruler to the subject. The subject is then prompted to insert, within a first predefined time interval, missing symbols from the given array of symbols in the ruler, to complete the incomplete serial order of symbols in the given incomplete symbol sequence and form a completed serial order of symbols in the given sequence. If at least one symbol insertion made by the subject is an incorrect symbol insertion, then the subject is returned to the step of selecting a complete serial order of symbols having the same spatial or time perceptual related attributes. If the symbols insertions made by the subject are all correct symbols insertions, then the correctly inserted symbols are displayed with at least one different spatial or time perceptual related attribute than the rest of the symbols in the completed symbols sequence. The above steps of the method are repeated for a predetermined number of iterations separated by second predefined time intervals, and upon completion of the predetermined number of iterations, the subject is provided with the results of each iteration.

In a further aspect of Example 3, the method of promoting fluid intelligence reasoning ability in a subject is implemented through a system. The system for promoting fluid intelligence reasoning ability in a subject comprises: a computer system comprising a processor, memory, and a graphical user interface (GUI), the processor containing instructions for: providing the subject with an incomplete direct alphabetic set array or an incomplete inverse alphabetic set array on the GUI, obtained from a previously selected complete set array of a predefined library of complete letter sequences; the selected complete set array provided graphically as a ruler to the subject; prompting the subject on the GUI to insert missing letter symbols from the given array of letter symbols in the ruler, to complete the incomplete direct alphabetic set array or incomplete inverse alphabetic set array; if at least one symbol insertion made by the subject is an incorrect symbol insertion, then returning to the step of providing the subject with an incomplete direct alphabetic set array or an incomplete inverse alphabetic set array on the GUI; if the symbols insertions made by the subject are all correct symbols insertions, then displaying on the GUI the complete direct alphabetic set array or complete inverse alphabetic set array with the correctly inserted letter symbols being displayed with at least one different spatial or time perceptual related attribute than the rest of the letter symbols in the completed symbols sequence; repeating the above steps for a predetermined number of iterations; and upon completion of the predetermined number of iterations, providing the subject with the results of each iteration on the GUI.

In general, the exercises of Example 3 require the subject to insert a number of missing symbols in an incomplete serial order of symbols in order to form a completed serial order of symbols in a sequence of symbols. The first step in the method of the present Example is to provide the subject with an incomplete serial order of symbols from the selected complete serial order of symbols. In an embodiment, the complete serial order of symbols is selected from the group consisting of direct alphabetic set array, direct type of alphabetic set array, and central type of alphabetic set array where in the derived incomplete direct alphabetical serial order of symbols the number of symbols missing comprises 2-7 symbols.

Likewise, if the complete serial order of symbols is selected from the group consisting of inverse alphabetic set array, inverse type of alphabetic set array, and inverse central type of alphabetic set array in the derived incomplete inverse alphabetical serial order of symbols the number of symbols missing comprises 2-5 symbols.

In a particular non-limiting embodiment, in order to successfully complete an incomplete direct alphabetic set array or an incomplete inverse alphabetic set array, the subject is required to visually serially search, click-select and drag (when using a computer) one selected letter symbol at a time with his/her hand-held mouse device, from a complete alphabetic set array displayed as a ruler underneath the incomplete letter symbols sequence and insert the letter symbol, as fast as possible, in its correct alphabetical serial order position in the displayed incomplete letter symbols sequence.

The subject is given a predefined time interval within which the subject must validly perform the trial exercises. If the subject for whatever reason does not perform the trial exercise within this predefined time interval, also referred to as “a valid performance time period”, then after a delay, which could be of about 4 seconds, the next in-line incomplete letter symbols sequence type trial exercise for the subject to perform is displayed. In embodiments, this predefined time interval or valid performance time period, herein representing the maximal allowed time for a subject lack of response, is defined to be 10-60 seconds, in particular 20-40 seconds, and further specifically 22 seconds.

In the present Example, there are predefined time intervals between block exercises. Let Δ1 herein represent a fixed time interval between block exercises' performances of the present task, where Δ1 is herein defined to be of 8 seconds. However, other time intervals are also contemplated, including without limitation, 5-15 seconds and the integral times there between.

As previously discussed, upon insertion of the correct missing letter symbols by the subject, the completed direct alphabetic set array or the completed inverse alphabetic set array is then displayed with the inserted letter symbols being displayed with at least one spatial or time perceptual related attribute different than the attributes of letter symbols in the originally provided incomplete direct alphabetic set array or in the originally provided incomplete inverse set array. The changed attribute of the correct answer is selected from the group consisting of spatial or time related perceptual attributes, or combinations thereof. In particular, the changed spatial or time perceptual related attribute is selected from the group including symbol color, symbol size, symbol font style, letter symbol spacing, letter symbol case, boldness of letter symbol, angle of letter symbol rotation, letter symbol mirroring, or combinations thereof. Furthermore, the correctly selected letter symbol may be displayed with a time related perceptual attribute flickering behavior in order to further highlight the differences in letter symbols attributes.

In a particular aspect of the present Example, the change in attributes is done according to predefined correlations between space and time related attributes, and the ordinal position of those letter symbols in the selected complete serial order of symbols in the first step of the method. For the case of a subject's visual perception of a complete direct alphabetic set array of the English language, the first ordinal position (occupied by the letter “A”), will generally appear towards the left side of his/her field of vision, whereas the last ordinal position (occupied by the letter “Z”) will appear towards his/her right field of vision. For a non-limiting example of these predefined correlations, if the ordinal position of the letter symbol for which an attribute will be changed falls in the left field of vision, the change in attribute may be different than if the ordinal position of the letter symbol for which the attribute will be changed falls in the right field of vision. In this non-limiting example, if the attribute to be changed is the color of the letter symbol, and if the ordinal position of the letter symbol for which the attribute will be changed falls in the left field of vision, then the color will be changed to a first different color, while if the ordinal position of the letter symbol falls in the right field of vision, then the color will be changed to a second color different from the first color. Likewise, if the attribute to be changed is the size of the letter symbol being displayed, then those letter symbols with an ordinal position falling in the left field of vision will be changed to a first different size, while the letter symbols with an ordinal position falling in the right field of vision will be changed to a second different size that is yet different than the first different size.

Further, the exercises in Example 3 are useful in promoting fluid intelligence abilities in the subject by grounding its basic fluid cognitive abilities in selective motor activity that occurs when the subject performs the given exercise. That is, the sequential manipulating or serially discriminating by the subject engages motor activity within the subject's body. The motor activity engaged within the subject may be any motor activity involved in the group consisting of sensorial perception of the selected complete and incomplete serial orders of symbols, in the body movements to execute when selecting and dragging from the ruler the missing symbols, and combinations thereof. While any body movements can be considered motor activity within the subject, the present subject matter is concerned with body movements selected from the group consisting of body movements of the subject's eyes, head, neck, arms, hands, fingers and combinations thereof.

By requesting that the subject engage in various degrees of body motor activity, the exercises of Example 3 are requiring the subject to bodily-ground cognitive fluid intelligence abilities as discussed above. The exercises of Example 3 bring the subject back to revisit an early developmental realm where he/she implicitly acted\experienced fast and efficient enactment of fluid cognitive abilities when specifically dealing with serial pattern recognition of non-concrete terms/symbols meshing with their salient spatial-time related attributes. The established relationships between these non-concrete terms/symbols and their salient spatial-time related attributes heavily promote symbolic knowhow in a subject. By doing this, the exercises of Example 3 strengthen the ability to serially search, identify and insert the correct missing terms/symbols in relevant incomplete symbols sequences via novel reasoning strategies set forward by the subject in order to quickly and efficiently problem solve the exercises of Example 3. It is important that the exercises of Example 3 accomplish this downplaying or mitigating as much as possible the subject need to recall-retrieve and use verbal semantic or episodic memory knowledge in order to support or assist his/her novel reasoning strategies to problem solving of the exercises in Example 3. The exercises of Example 3 are mainly within promoting fluid intelligence abilities in general and novel reasoning strategies in particular in a subject, but do not rise to the operational level of promoting crystalize intelligence narrow abilities mainly via explicit associative learning supported by declarative semantic knowledge. As such, in predefined libraries of complete serial orders of symbols sequences, a specific alphabetical symbols type sequence and complete serial orders of letter symbols are selected, to specifically downplay or mitigate the subject's need for developing problem solving strategies and/or drawing inductive-deductive inferences necessitating verbal knowledge and/or recall-retrieval of information from declarative-semantic and/or episodic kinds of memories.

In an aspect of the exercises presented in Example 3, the library of complete symbols sequences includes the following symbols sequences as defined above: direct alphabetic set array; inverse alphabetic set array; direct type of alphabetic set array; inverse type of alphabetic set array; central type of alphabetic set array; and, inverse central type alphabetic set array. It is understood that the above library of complete symbols sequences may contain additional set arrays sequences or fewer set arrays sequences than those listed above.

Furthermore, it is also important to consider that the exercises of Example 3 are not limited to serial orders of alphabetic symbols. It is also contemplated that the exercises are also useful when numeric serial orders and/or alpha-numeric serial orders are used within the exercises. In other words, while the specific examples set forth employ serial orders of letter symbols, it is also contemplated that serial orders comprising numbers and/or alpha-numeric symbols can be used.

In an aspect of the present subject matter, the exercises of Example 3 include providing a graphical representation of a complete letter symbols sequence, in a ruler shown to the subject, when providing the subject with an incomplete direct alphabetical letter symbols sequence (which is an incomplete direct alphabetic set array) or an incomplete inverse alphabetical letter symbols sequence (which is an incomplete inverse alphabetic set array). In a subject, the visual presence of the ruler facilitates a less demanding visual attentional performance of the exercise. Accordingly, the presence of the ruler facilitates a faster and more accurate visual recognition of the missing and non-missing letter symbols required to exercise in the letter symbols sequence therefore, a faster insertion of a number of missing letter symbols into their correct direct alphabetical or inverse alphabetical serial order positions in an incomplete direct alphabetic (A-Z) or incomplete inverse alphabetic (Z-A) set array is to be expected. In summary, the graphical representation of a ruler facilitates in a subject its efficient completing the required herein to perform letter symbols sequence. In the present exercises, the ruler comprises one of a plurality of symbols sequences in the above disclosed library of complete symbols sequences, namely direct alphabetic set array; inverse alphabetic set array; direct type of alphabetic set array; inverse type of alphabetic set array; central type of alphabetic set array; and inverse central type alphabetic set array.

The methods implemented by the exercises of Example 3 also contemplate those situations in which the subject fails to perform the given task. The following failing to perform criteria is applicable to any exercise in any block exercise of the present task in which the subject fails to perform for whatever reason. Specifically, for the present exercises, there are two kinds of “failure to perform” criteria. The first kind of “failure to perform” criteria occurs in the event the subject fails to perform by not click-selecting (that is, the subject remains inactive/passive) with the subject's hand-held mouse device on the valid or not valid next-term option choice displayed (among 4 next-term option choices), within a predefined valid performance time period, then after a delay, which could be of about 4 seconds, the next in-line letter symbols sequence type trial exercise for the subject to perform is displayed.

The second “failure to perform” criteria is in the event the subject fails to perform by the insertion of an incorrect letter symbol. More so, as an operational rule applicable for any failed trial exercise of the present task, failure to perform results in the automatic displaying of the next in-line require to perform letter symbols sequence type in its respective trial exercise for the subject to insert the missing letter symbols into the incomplete direct alphabetic set array or incomplete inverse alphabetic set array. However, in the event the subject fails to correctly insert the proper missing letter symbols inside the required to perform letter symbols sequence in excess of 2 consecutive wrong answers (in a single trial exercise in a single block exercise), then one of the following two options will occur: 1) if the failure to perform is for more than 2 consecutive wrong answers (in a single trial exercise of Example 3), then the subject's current trial exercise performance is immediately halted and after a time interval of about 4 seconds, the next in-line herein require to perform letter symbols sequence type in its respective trial exercise will immediately be displayed (for the subject to perform) or in the next in-line block exercise; or 2) (which is only relevant for the last block exercise of Example 3) if the subject is failing to perform trial exercise #2 in block exercise #3, it will be immediately exited from the remainder of the third block exercise, and returned back to the main menu of the computer program.

Total duration to complete the exercises of Example 3, as well as the time it took to implement each one of the individual trial exercises, is registered in order to help generate an individual and age-gender related performance score. Records of all missing letter symbols answers for all type letter symbols sequences displayed and required to be performed are also generated and displayed. In general, the subject will perform the kind of task of this example exercise #3, about 6 times during their-based brain mental fitness training program.

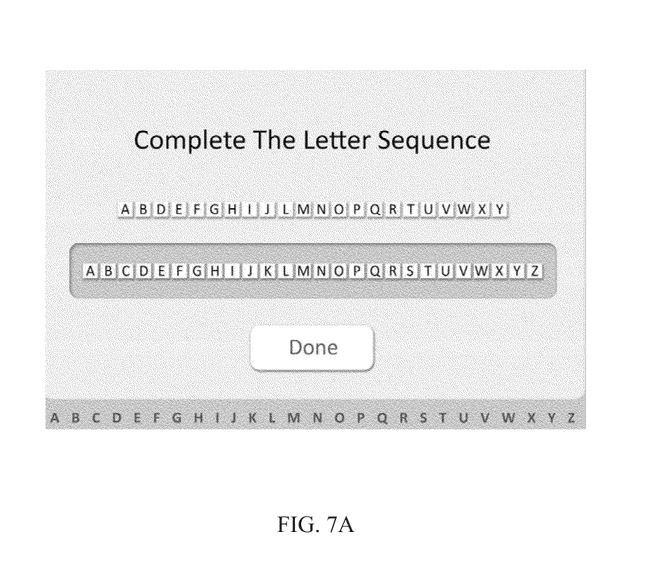

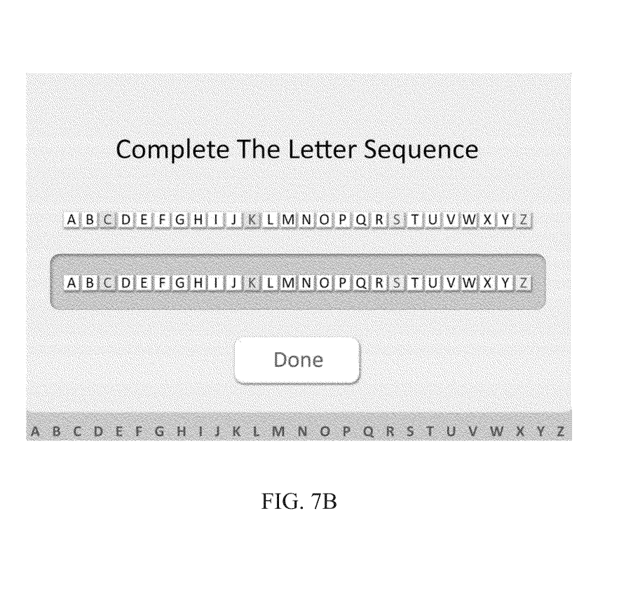

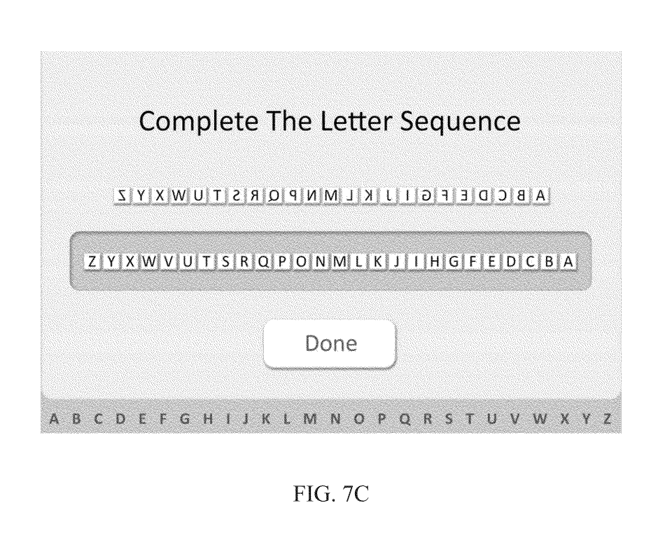

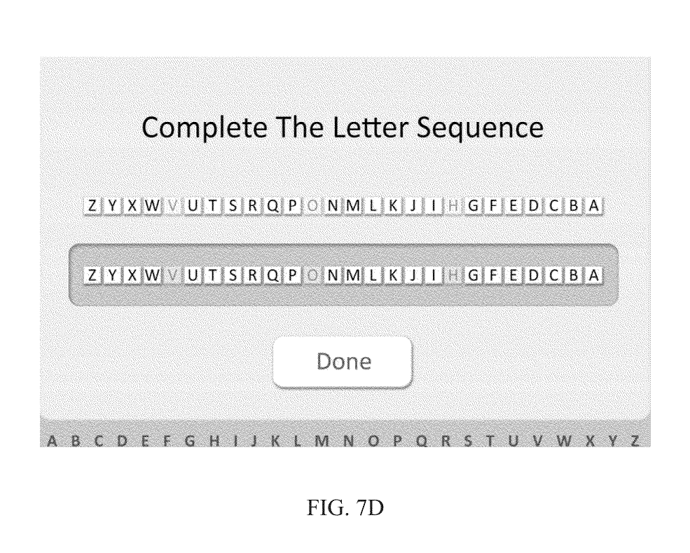

FIGS. 7A-7D depicts a number of non-limiting examples of the exercises for inserting the missing letter symbols in an incomplete serial order of letter symbols in a sequence of letter symbols. FIG. 7A shows an incomplete direct alphabetical serial order of letter symbols, along with the complete direct alphabetic set array of letter symbols underneath the incomplete serial order of letter symbols. The subject is then prompted to complete the incomplete direct alphabetical serial order of letter symbols by inserting the missing letter symbols one at a time. FIG. 7B shows the completed direct alphabetical serial order of letter symbols with the inserted missing letter symbols being displayed with a single changed spatial or time perceptual related attribute. In this exercise, the inserted missing letter symbols (C, K, S and Z) have a changed time perceptual related color attribute. While the exercise depicted in FIGS. 7A and 7B shows the inserted missing letter symbols having a changed time perceptual related attribute in the form of a color change, it is understood that any previously discussed spatial or time perceptual related attribute could be changed in lieu of, or in addition to, the changed time perceptual related color attribute. The subject matter of Example 3 contemplates that up to 7 different spatial-time perceptual related attributes could be changed amongst the various inserted missing letter symbols. Furthermore, it should also be understood that, while the exercise in FIGS. 7A and 7B depict an exercise in which 4 letter symbols were missing from the incomplete direct alphabetical serial order of letter symbols, any number from 2-7 letter symbols could have been missing.

Likewise, FIG. 7C shows an incomplete inverse alphabetical serial order of letter symbols in a letter symbols sequence, along with the complete inverse alphabetic set array of letter symbols underneath the incomplete inverse alphabetical serial order of letter symbols. In embodiments, all letter symbols from an incomplete inverse alphabetical serial order of letter symbols in a letter symbols sequence can display with a single changed spatial related attribute. In this exercise, all symbol letters of the displayed incomplete inverse alphabetical serial order of letter symbols in the letter symbols sequence have a change spatial related letter symbol mirroring attribute. The subject is then prompted to complete the inverse alphabetical serial order of letter symbols in the letter symbol sequence by inserting the missing letter symbols. FIG. 7D shows the completed inverse alphabetical serial order of letter symbols in the letter symbols sequence with the inserted missing letter symbols being displayed with a single changed spatial or time perceptual related attribute. In this exercise, the inserted missing letter symbols (V, 0, and H) have a changed spatial related letter symbol boldness attribute. While the exercise depicted in FIGS. 7C and 7D shows the inserted missing letter symbols having a single changed spatial related attribute in the form of a letter symbol boldness change, it is understood that any previously discussed spatial-time perceptual related attribute could be changed in lieu of, or in addition to, the changed spatial related letter symbol boldness attribute. The subject matter of Example 3 contemplates that up to 7 different spatial or time perceptual related attributes could be changed amongst the various inserted missing letter symbols. Furthermore, it should also be understood that, while the exercise in FIGS. 7C and 7D depict an exercise in which 3 letter symbols were missing from the incomplete inverse alphabetical serial order of letter symbols in the letter symbols sequence, any number from 2-5 letter symbols could have been missing.

### Example 4

### Completing a Direct Alphabetical or Inverse Alphabetical Letter Symbols Sequence with Two or More Added Contiguous Incomplete Letter Symbols Sequences

In a particular embodiment of the present exercises, the subject is required to exercise his/her ability to quickly visually recognize incomplete alphabetical letter symbols sequences that can become a complete direct or inverse alphabetic set array if their entailing incomplete letter symbols sequences, were complemented by two or more contiguous incomplete letter symbols sequences, wherein all letter symbols in the completed direct or inverse alphabetic set array have the same spatial and time perceptual related attributes. Specifically, a plurality of incomplete direct alphabetical letter symbols sequences (A-Z) or incomplete inverse alphabetical letter symbols sequences (Z-A) are selected and provided to the subject (incomplete letter symbols sequences, meaning that no one of them will comprise 26 different letter symbols—for the application in the English language). The goal of the present exercises is for the subject to rapidly visually serially search and effectively recognize the sequential order positions corresponding to the letter symbols entailing these incomplete direct alphabetical or incomplete inverse alphabetical letter symbols sequences. In relation to one predefined provided incomplete alphabetic letter symbol sequence, the subject should quickly select either two or more alphabetically contiguous, incomplete direct alphabetical or incomplete inverse alphabetical letter symbols sequences from a given pull comprising the selected incomplete letter symbols sequences, to complement the predefined provided incomplete alphabetic letter symbols sequence, and attain a complete direct alphabetical or a complete inverse alphabetical letter symbols sequence, meaning a direct alphabetic set array or an inverse alphabetic set array.

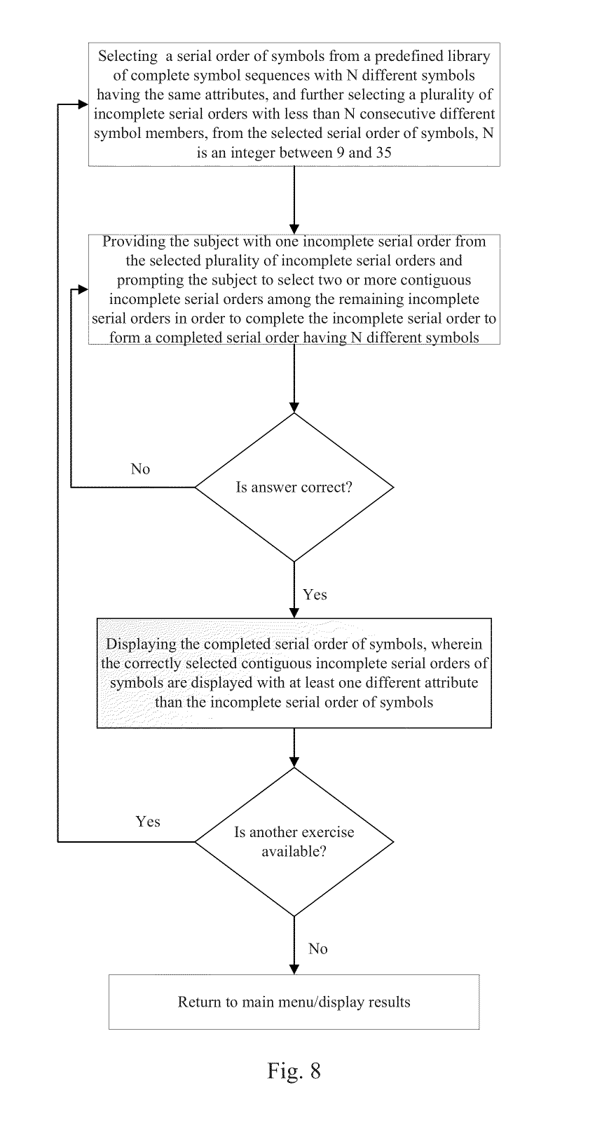

FIG. 8 is a flow chart setting forth the method that the present exercises uses in promoting fluid intelligence abilities in a subject by completing an incomplete serial order of symbols of a symbol sequence to form a completed serial order of different symbols (e.g., alphabetic or numeric or alphanumeric symbols) in a symbol sequence. As can be seen in FIG. 8, the method of promoting fluid intelligence abilities in the subject comprises first selecting a serial order of symbols from a predefined library of complete symbol sequences, where the first selected serial order of symbols sequence entails N different symbols having the same spatial or time perceptual related attributes, and further comprises a second selecting a plurality of incomplete symbol sequences entailing serial orders of symbols with less than N consecutive symbol members. In a non-limiting example (e.g., English language and the 9 integer numbers −1 to 9) N could be an integer between 9 and 35. The subject is then provided with one symbol sequence entailing an incomplete serial order of symbols from the selected plurality of incomplete serial orders of symbols sequences. The subject is prompted to select, within a first predefined time interval, two or more incomplete serial orders of symbols sequences among the remaining incomplete serial orders of symbols of the selected plurality of incomplete serial orders of symbols sequences, in order to gradually complete in a contiguous manner the incomplete serial order of symbols provided in the previous step, to form a completed direct or inverse alphabetical serial order of symbols having the N different symbols of the complete symbol sequence. If at least one selection made by the subject is an incorrect selection of an incomplete serial order of symbols, then the subject is returned to the step of prompting the subject to select the one or more incomplete serial orders of symbols sequences. If the two or more selections made by the subject are all correct selections of incomplete serial orders of symbols, the completed serial order of different symbols is displayed, wherein the two or more correctly selected incomplete serial orders of symbols sequences are displayed with at least one different spatial or time perceptual related attribute than the attributes in the provided incomplete serial order of symbols sequence. The above steps of the method are repeated for a predetermined number of iterations separated by one or more predefined time intervals, and upon completion of the predetermined number of iterations, the subject is provided with each iteration results. The predetermined number of iterations can be any number needed to establish that a satisfactory reasoning performance concerning the particular task at hand is being promoted within the subject. Non-limiting examples of number of iterations include 1, 2, 3, 4, 5, 6, and 7. However, any number of iterations can be performed, like 1 to 23.

Another aspect of Example 4 is directed to the method of promoting fluid intelligence abilities in the subject on which this method is being implemented, through a computer program product. In particular, the subject matter in Example 4 includes a computer program product for promoting fluid intelligence abilities in a subject, stored on a non-transitory computer readable medium which when executed causes a computer system to perform a method. The method executed by the computer program on the non-transitory computer readable medium comprises selecting a serial order of symbols from a predefined library of complete symbol sequences with N different symbols having the same spatial or time perceptual related attributes, and further selecting a plurality of incomplete serial orders of symbols sequences with less than N different consecutive symbol members from the selected serial order of symbols sequences. In a non-limiting example N could be an integer between 9 and 35. The subject is then provided with one incomplete serial order of symbols from the selected plurality of incomplete serial orders of symbols sequences. The subject is prompted to select, within a first predefined time interval, two or more incomplete serial orders of symbols sequences among the remaining incomplete serial orders of symbols sequences of the selected plurality of incomplete serial orders of symbols sequences, in order to gradually complete in a contiguous manner the provided incomplete serial order of symbols in the previous step, to form a completed direct or inverse alphabetical serial order of symbols having N different symbols in the completed symbol sequence. If at least one selection made by the subject is an incorrect selection of a contiguous incomplete serial order of symbols, then the subject is returned to the step of prompting the subject to select the two or more contiguous incomplete serial orders of symbols sequences. If the two or more selections made by the subject are all correct selections of contiguous incomplete serial orders of symbols, the completed serial order of symbols is displayed, wherein the correctly selected two or more incomplete serial orders of symbols sequences are displayed with at least one different spatial or time related attribute than the attributes in the provided symbol sequence entailing an incomplete serial order of symbols. The above steps of the method are repeated for a predetermined number of iterations separated by one or more predefined time intervals, and upon completion of the predetermined number of iterations, the subject is provided with each iteration results.

In a further aspect of Example 4, the method of promoting fluid intelligence abilities in a subject is implemented through a system. The system for promoting fluid intelligence abilities in a subject comprises: a computer system comprising a processor, memory, and a graphical user interface (GUI), the processor containing instructions for: selecting a serial order of symbols from a predefined library of complete symbol sequences with N different symbols having the same spatial or time perceptual related attributes, and further selecting a plurality of incomplete serial orders of symbols sequences with less than N consecutive symbol members, from the selected complete serial order of symbols, wherein N could be in a non-limiting example an integer between 9 and 35; providing the subject on the GUI with one incomplete symbol sequence entailing an incomplete serial order of symbols from the selected plurality of incomplete serial orders of symbols sequences; prompting the subject on the GUI to select, within a first predefined time interval, two or more incomplete serial orders of symbols sequences among the remaining incomplete serial orders of symbols sequences of the selected plurality of incomplete serial orders of symbols sequences, to gradually complete in a contiguously manner the incomplete serial order of symbols previously provided, in order to form a completed direct or inverse alphabetical serial order of symbols sequence having N different symbols; if at least one selection made by the subject is an incorrect selection of an incomplete serial order of symbols, then returning to the step of prompting the subject on the GUI to select two or more incomplete contiguous serial orders of symbols sequences; if the two or more selections made by the subject are all correct selections of incomplete contiguous serial orders of symbols sequences, then displaying the completed direct or inverse alphabetical serial order of symbols on the GUI, wherein the correctly selected two or more incomplete contiguously serial orders of symbols sequences are displayed with at least one different spatial or time perceptual related attribute than the attributes of the originally provided to the subject incomplete serial order of symbols; repeating the above steps for a predetermined number of iterations separated by one or more predefined time intervals; and upon completion of the predetermined number of iterations, providing the subject with the results of each iteration on the GUI.

In an aspect of the exercises of Example 4, the first selection of the serial order of symbols is done at random, from predefined serial order of complete symbols sequences of the said library, followed by a second random selection of a plurality of incomplete serial orders of symbols sequences, done also at random, from predefined numbers of consecutive symbol members and predefined ordinal positions of these symbols members in the previously first selected complete serial order of symbols. While this aspect of the exercises is easier to implement through the use of a computer program, it is also understood that the above first and second random selection of the serial order of symbols, is also achievable manually.

The second selection step in the method of the present Example is to provide the subject with a plurality of incomplete serial orders of symbols sequences from the first selection step of serial order of symbols from predefined serial order of complete symbols sequences. In embodiments, when the serial order of symbols in the first step is first selected from the group consisting of direct alphabetic set array, direct type of alphabetic set array, and central type of alphabetic set array, the number of symbols in the provided one incomplete serial order of symbols from the plurality of incomplete serial orders of symbols sequences, comprises 2-7 symbols. In particular the number of letter symbols of the provided incomplete serial order of symbols in these non-limiting example exercises is between three and five letter symbols.

Likewise, when the serial order of symbols in the first step is first selected from the group consisting of inverse alphabetic set array, inverse type of alphabetic set array, and inverse central type of alphabetic set array, the number of symbols in the provided one incomplete serial order of symbols from the plurality of incomplete serial orders of symbols sequences comprises 2-5 symbols. In particular, the number of letter symbols of the provided incomplete inverse serial order of symbols in these non-limiting example exercises, is between three and four letter symbols.

Furthermore, the above mentioned plurality of incomplete serial orders of symbols sequences is displayed for their possible use in contiguously completing the one provided incomplete serial order of symbols sequence. The number of incomplete serial orders of symbols sequences provided to the subject for possible use in contiguously completing the provided incomplete serial order of symbols sequence is of 8-16 incomplete serial orders of symbols sequences. In embodiments, the number of incomplete serial orders of symbols sequences in the selected pool of incomplete symbols sequences, for the subject's further selection, is of 10-12 letter symbols sequences.

The pool of incomplete serial orders of symbols sequences displayed to the subject is the plurality of incomplete serial orders of symbols sequences from where the subject selects in order to contiguously complete the provided incomplete serial order of symbols sequence. In an embodiment, each of the plurality of incomplete serial orders of symbols sequences that the subject selects to contiguously complete the incomplete serial order of symbols sequence comprises 2-12 symbols. In particular, each of the plurality of incomplete serial orders of symbols sequences comprises 6-10 letter symbols.

When the methods of Example 4 are implemented by a computer product program or a computer system, the computer product program can generate the one original complete serial order of symbols, including both direct alphabetic and inverse alphabetic set arrays, as well as the pool of incomplete serial orders of symbols sequences that will be displayed to the subject in order to select two or more incomplete serial orders of symbols sequences to contiguously complete the provided incomplete serial order of symbols sequence. In the alternative, the computer product program can be programmed to select serial order of symbols sequences from a library module containing the original incomplete serial order of symbols sequence required to contiguously complete, as well as the plurality of incomplete serial orders of symbols sequences displayed to the subject in the exercises. Furthermore, it is contemplated that the library module storing various serial orders of symbols sequences can also store a multi-alphabetical-language library module in which various serial orders of symbols sequences represent alphabets of different spoken-written languages, are stored and available for the computer product program, to provide to the subject.

The subject is given a predefined time interval within which the subject must validly perform the exercises. If the subject does not perform for whatever reason the trial exercise within the predefined time interval, also referred to as “a valid performance time period”, then after a delay, which could be of about 4 seconds, the next in-line incomplete letter symbols sequence type for the subject to perform, is displayed. The predefined time interval or valid performance time period for maximal allowed lack of response is defined to be 10-60 seconds, in particular 20-40 seconds, and further specifically 22 seconds.

In the present Example, there is one or more predefined time intervals between block exercises. Let Δ1 herein represent a fixed time interval between block exercises' performances of the present task, where Δ1 is herein defined to be of 8 seconds. However, other time intervals between block exercises are also contemplated, including without limitation, 5-15 seconds and the integral times there between.

As previously discussed, upon selection of the correct incomplete serial orders of symbols sequences by the subject, the contiguously completed serial order of symbols sequence is then displayed with the complementary contiguous serial orders of symbols being displayed with at least one spatial or time perceptual related attribute different than the attributes of the originally provided incomplete serial order of symbols sequence. The changed spatial or time related perceptual attribute of the correctly selected two or more incomplete serial orders of symbols sequences, is selected from the group of spatial or time perceptual related attributes, or combinations thereof. In a particular aspect, the changed spatial or time perceptual related attribute is selected from the spatial or time perceptual related attribute group consisting of symbol color, symbol sound, symbol size, symbol font style, letter symbol spacing, letter symbol case, boldness of letter symbol, angle of letter symbol rotation, letter symbol mirroring, or combinations thereof. Furthermore, the correctly selected letter symbol may be displayed with a flickering time related attribute behavior in order to further highlight differences in letter symbols attributes.

In a particular aspect of the present Example, the change in attributes is done according to predefined correlations between space and time related attributes, and the ordinal position of those letter symbols in the selected complete serial order of symbols in the first step of the method. For the case of a subject's visual perception of a complete direct alphabetic set array of the English language, the first ordinal position (occupied by the letter “A”), will generally appear towards the left side of his/her field of vision, whereas the last ordinal position (occupied by the letter “Z”), will appear towards his/her right field of vision For a non-limiting example of these predefined correlations, if the ordinal position of the letter symbol for which an attribute will be changed falls in the left field of vision, the change in attribute may be different than if the ordinal position of the letter symbol for which the attribute will be changed falls in the right field of vision. In this non-limiting example, if the attribute to be changed is the color of the letter symbol, and if the ordinal position of the letter symbol for which the attribute will be changed falls in the left field of vision, then the color will be changed to a first different color, while if the letter symbol falls in the right field of vision, then the color will be changed to a second color different from the first color. Likewise, if the attribute to be changed is the size of the letter symbol being displayed, then those letter symbols with an ordinal position falling in the left field of vision will be changed to a first different size, while the letter symbols with an ordinal position falling in the right field of vision will be changed to a second different size that is yet different than the first different size.

Further, the exercises in Example 4 are useful in promoting fluid intelligence abilities in the subject by grounding its basic fluid cognitive abilities in selective motor activity that occurs when the subject performs the given exercise. That is, the symbols discriminating and manipulating by the subject engages motor activity within the subject's body. The motor activity engaged within the subject may be any motor activity involved in the group consisting of sensorial perception of the selected serial order of symbols from a library of complete serial orders of symbols, as well as in the selection of the relevant contiguous incomplete serial orders of symbols sequences to form a complete serial order of symbols sequence, in body movements to execute when selecting and dragging with the finger-hand (touch screen) or hand held mouse device the incomplete serial orders of symbols sequences, and in the serial pattern recognition\awareness of symbols spatial-time perceptual related attribute change and combinations thereof. While any body movements can be considered motor activity within the subject, the present subject matter is concerned with body movements selected from the group consisting of body movements of the subject's eyes, head, neck, arms, hands, fingers and combinations thereof.

By requesting that the subject engage in specific degrees of motor activity, the exercises of Example 4 are requiring the subject to bodily-ground cognitive fluid intelligence abilities as discussed above. The exercises of Example 4 cause the subject to revisit an early developmental realm where he/she implicitly acted\experienced fast and efficient enactment of fluid cognitive abilities when specifically dealing with serial pattern recognition of non-concrete terms\symbols meshing with their salient spatial-time related attributes. The established relationships between these non-concrete terms\symbols and their salient spatial and/or time related attributes heavily promote symbolic knowhow in a subject. By doing this, the exercises of Example 4 strengthen the subject ability to rapidly and accurately serially discriminate, select and manipulate the correct contiguous incomplete serial order of symbols sequences from the pull of incomplete symbols sequences in order to complete and obtain the herein required to perform a direct or inverse alphabetic set array. In general, the method of Example 4 encourage the subject to reason in novel ways in order to efficiently problem solve the exercises of Example 4. It is important that the exercises of Example 4 accomplish this downplaying or mitigating as much as possible the subject need to recall-retrieve and use verbal semantic or episodic memory knowledge in order to support or assist his/her novel reasoning ability to problem solving of the exercises in Example 4. The exercises of Example 4 are mainly within promoting fluid intelligence abilities in general and novel reasoning strategies concerning pattern recognition and contiguous assembling of incomplete symbols sequences to obtain a complete direct or inverse alphabetical serial order of symbols sequence, but do not rise to the operational level of promoting crystalize intelligence narrow abilities mainly via explicit associative learning supported by declarative semantic knowledge. As such, the specific selected serial orders of symbols as well as the selection of the relevant contiguous incomplete serial orders of symbols sequences to form the completed serial order of symbols are herein selected to specifically downplay or mitigate the subject's need for developing problem solving strategies and/or drawing deductive-inductive inferences necessitating recall-retrieval of information from declarative-semantic and/or episodic kinds of memories.

In an aspect of the exercises presented in Example 4, the library of complete symbol sequences includes the following complete symbol sequences as defined above: direct alphabetic set array; inverse alphabetic set array; direct type of alphabetic set array; inverse type of alphabetic set array; central type of alphabetic set array; and, inverse central type alphabetic set array. It is understood that the above library of complete symbol sequences may contain additional set arrays sequences or fewer set arrays sequences, than those listed above.

Furthermore, it is also important to consider that the exercises of Example 4 are not limited to serial orders with alphabetic symbols. It is also contemplated that the exercises of Example 4 are also useful when numeric serial orders and/or alpha-numeric serial orders are used within the exercises. In other words, while the specific examples set forth employ serial orders of letter symbols, it is also contemplated that serial orders comprising numbers symbols and/or alpha-numeric symbols can also be used. In an aspect of the present subject matter, the exercises of Example 4 include providing a graphical representation of the first selected direct alphabetical set array or the first selected inverse alphabetic set array, in a ruler shown to the subject. In a subject, the visual presence of the ruler facilitates his/her visual attentional performance of the exercise. Accordingly, the presence of the ruler facilitates a faster and more accurate visual recognition of the required to exercise direct alphabetic or inverse alphabetic set array therefore, a faster completion of the first selected direct or inverse alphabetical set array is to be expected. In summary, the ruler facilitates in a subject an efficient completing of the required herein to perform direct or inverse alphabetic set arrays.

In the present exercises, the ruler comprises one of a plurality of complete symbols sequences in the above disclosed predefined library of complete symbols sequences, which comprises direct alphabetic set array; inverse alphabetic set array; direct type of alphabetic set array; inverse type of alphabetic set array; central type of alphabetic set array; inverse central type alphabetic set array;

The methods implemented by the exercises of Example 4 also contemplate those situations in which the subject fails to perform the given task. The following failing to perform criteria is applicable to any exercise in any block exercise of the present task in which the subject fails to perform for whatever reason. Specifically, for the present exercises, there are two kinds of “failure to perform” criteria. The first kind of “failure to perform” criteria occurs in the event the subject fails to perform by not click-selecting and/or dragging (that is, the subject remains inactive/passive) with the subject's hand-held mouse device on a valid or invalid complementary contiguous incomplete serial order of symbols sequence option choice displayed. If there is no response within a predefined valid performance time period, the subject is returned to the beginning of the trial exercise to start over. In an embodiment, the valid performance time period for lack of response is defined to be 20-60 seconds, in particular 25-40 seconds, and further specifically 22 seconds. In the case of lack of response, the subject will be provided with up to 3 additional new exercises. If failure to perform within the valid performance time period take place consecutively within the 3 additional new exercises, the method provides that the subject will be transitioned to the next in-line second block exercise (if the failure to perform occurred in the first block exercise), or the subject is returned to the main menu and the exercise is aborted if the failure to perform occurs in the last block exercise, meaning during the subject performance in the second block exercise.

The second kind of “failure to perform” criteria, is applicable in the event the subject fails to perform by attempting to combine incorrect complementary contiguous incomplete letter symbols sequences. In the event that the subject fails in any trial exercise of the present Example because of eliciting a wrong complementary contiguous incomplete letter symbols sequence answer, the subject's wrong answer is immediately undone. The subject's wrong complementary contiguous incomplete letter symbols sequences answers are continuously being undone, until he/she correctly succeeds selecting all required complementary contiguous incomplete letter symbols sequences answers. Nevertheless, in the event the subject executes three consecutive wrong complementary contiguous incomplete letter symbols sequences answers, the subject's performance of the current exercise ends and the next in-line exercise will commence after a time interval. If the three consecutive wrong complementary contiguous incomplete letter symbols sequences answers are elicited during the subject performance in the second block exercise, the block exercise is aborted and the subject is returned to the main menu.

Total duration to complete the exercises of Example 4, as well as the time it took to implement each one of the individual trial exercises, is registered in order to help generate an individual or age-gender related performance score. Records of all wrong complementary contiguous incomplete letter symbols sequences answers for all type of complementary contiguous letter symbols sequences displayed and required to be performed are also generated and displayed. In general, the subject will perform this task about 6 times during their-based brain mental fitness training program.

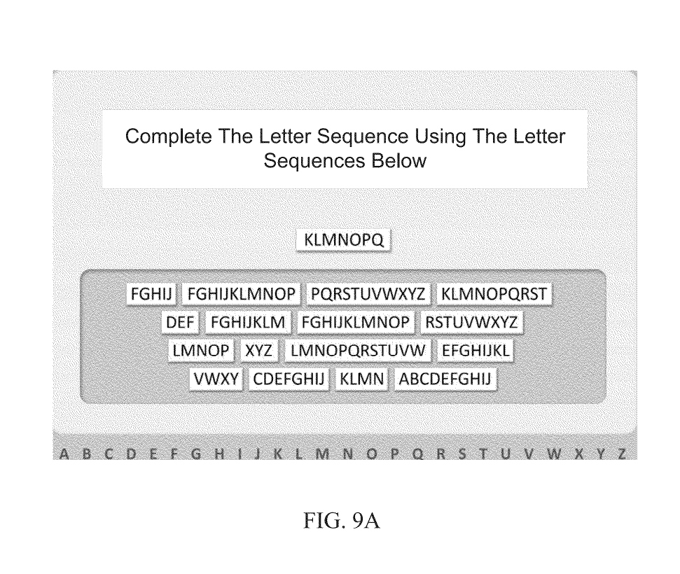

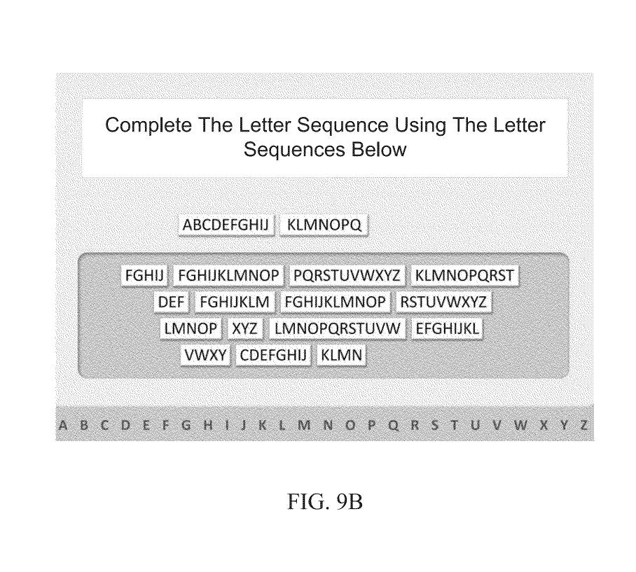

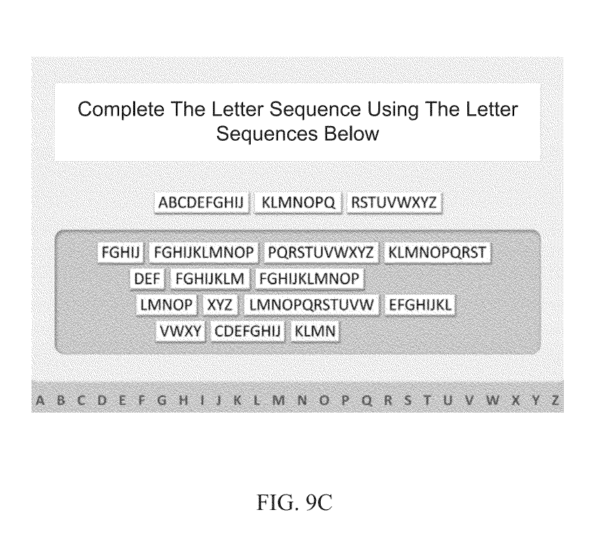

FIGS. 9A-9C depicts a non-limiting example of the exercises completing an incomplete serial order of symbols sequence. FIG. 9A shows an original incomplete direct alphabetical serial order of symbols sequence, along with a number of other incomplete serial orders of symbols sequences provided under the original incomplete direct alphabetical serial order of symbols sequence. The original incomplete direct alphabetical serial order of symbols sequence provided in FIG. 9A is KLMNOPQ. The subject is then prompted to complete the original incomplete direct alphabetical serial order of symbols sequence by serially identifying and selecting two or more of the complementary contiguous incomplete serial orders of symbols sequences. FIG. 9B shows that the subject has correctly identified one complementary contiguous incomplete serial order of symbols sequence in the form of ABCDEFGHIJ. Further, FIG. 9C shows the completed direct alphabetical serial order of symbols sequence, with the subject having correctly identified the second complementary contiguous incomplete serial order of symbols in the form of RSTUVWXYZ. In this exercise, although not shown in FIGS. 9B and 9C, the correctly selected complementary contiguous incomplete serial orders of symbols sequences would be identified as being correct by having changed a single spatial or time perceptual related attribute. The subject matter of Example 4 contemplates that up to a total of 7 different spatial and/or time perceptual related attributes could be changed amongst the various inserted symbols, including any of those previously discussed.

The disclosed subject matter being thus described, it will be obvious that the same may be modified or varied in many ways. Such modifications and variations are not to be regarded as a departure from the spirit and scope of the disclosed subject matter and all such modifications and variations are intended to be included within the scope of the following claims.

What is claimed is:

1. A method of promoting fluid intelligence abilities in a subject comprising:
a) selecting one or more serial order of symbols from a predefined library of complete symbols sequences and, from this selection, providing the subject with one or more incomplete serial orders of symbols;
b) prompting the subject, within an exercise, to manipulate symbols within the one or more incomplete serial orders of symbols or to discriminate differences or sameness between two or more of the incomplete serial orders of symbols, within a first predefined time interval;
c) determining whether the subject correctly manipulated the symbols or correctly discriminated differences or sameness between the two or more incomplete serial orders of symbols;
d) if the subject made an incorrect symbol manipulation or discrimination, then returning to step b);
e) if the subject correctly manipulated the symbols or correctly discriminated differences or sameness between the two or more of the incomplete serial orders of symbols, then displaying the correct manipulations or discriminated differences or sameness with at least one different spatial or time perceptual related attribute, to highlight the symbols manipulations, difference or sameness;
f) repeating the above steps for a predetermined number of iterations separated by one or more predefined time intervals; and
g) upon completion of the predetermined number of iterations, providing the subject with the results of each iteration.

2. The method of claim 1, wherein the symbols manipulation or discrimination of the incomplete serial orders of symbols by the subject are accomplished without invoking explicit awareness by the subject.

3. The method of claim 1 wherein the selection of serial orders of symbols from the predefined library and the selection of incomplete serial orders of symbols from the selected serial orders, are done at random.

4. The method of claim 1, wherein serial order of symbols in the predefined library of complete serial order of symbols comprises set arrays with a predefined number of different symbols, each symbol having a predefined unique ordinal position and none of said different symbols are repeated within the set arrays of symbols, or are located at a different ordinal position within the set arrays of symbols.

5. The method of claim 1, wherein the predefined library of complete symbol sequences comprise alphabetic set arrays where the symbol of each member term is a single letter symbol, wherein the alphabetic set arrays where the symbol of each member term is a single letter comprise:
direct alphabetic set array; inverse alphabetic set array; direct type of alphabetic set array; inverse type of alphabetic set array; central type of alphabetic set array; inverse central type alphabetic set array.

6. The method of claim 1, wherein the two or more incomplete serial orders of symbols sequences contain at least one different attribute, between each of the two or more incomplete serial orders of symbols sequences.

7. The method of claim 6, wherein the attribute that is different between the two or more incomplete serial orders of symbols sequences is an attribute selected from the group including symbol color, symbol size, symbol font style, symbol spacing, symbol case, boldness of symbol, angle of symbol rotation, symbol mirroring, or combinations thereof.

8. The method of claim 6, wherein the two or more incomplete serial orders of symbols sequences contain a plurality of different attributes between each of the two or more incomplete serial orders of symbols sequences.

9. The method of claim 8, wherein each attribute that is different between the two or more incomplete serial orders of symbols is an attribute selected from the group including symbol color, symbol size, symbol font style, letter symbol spacing, letter symbol case, boldness of letter symbol, angle of letter symbol rotation, letter symbol mirroring, or combinations thereof.

10. The method of claim 1, wherein the manipulating or discriminating by the subject engages motor activity within the subject's body, the motor activity selected from the group involved in the sensorial perception of the firsts selected serial orders of complete symbols and of the incomplete serial order of symbols, in the body movements to execute the manipulations or discriminations, and combinations thereof.

11. The method of claim 10, wherein the body movements comprise movements selected from the group consisting of movements of the subject's eyes, head, neck, arms, hands, fingers and combinations thereof.

12. The method of claim 1, further comprising providing a ruler in step a).

13. The method of claim 12, wherein the ruler is selected from the first selected serial orders of symbols, from a predefined library of complete symbols sequences, which includes two or more complete serial orders of symbols of the group comprising: direct alphabetic set array; inverse alphabetic set array; direct type of alphabetic set array; inverse type of alphabetic set array; central type of alphabetic set array; and inverse central type alphabetic set array.

14. The method of claim 1, wherein the predetermined number of iterations ranges from 1-23 iterations.

15. A computer program product for promoting fluid intelligence abilities in a subject, stored on a non-transitory computer-readable medium which when executed causes a computer system to perform a method, comprising:
a) selecting one or more serial order of symbols sequences from a predefined library of complete symbols sequences and, from this selection, providing the subject with one or more incomplete serial orders of symbols sequences;
b) prompting the subject, within an exercise, to manipulate symbols within the one or more incomplete serial orders of symbols sequences or to discriminate differences or sameness between two or more of the incomplete serial orders of symbols sequences, within a first predefined time interval;
c) determining whether the subject correctly manipulated the symbols or correctly discriminated differences or sameness between the two or more further selected incomplete serial orders of symbols sequences;
d) if the subject made an incorrect manipulation within the one or more incomplete serial orders of symbols sequences or discrimination about differences or sameness between the two or more of the incomplete serial order of symbols sequences, then returning to step b);
e) if the subject correctly manipulated the symbols within the one or more incomplete serial orders of symbols sequences or correctly discriminated differences or sameness between the two or more of the incomplete serial orders of symbols sequences, then displaying the correct symbols manipulations or discriminated differences or sameness with at least one different spatial or time perceptual related attribute, to highlight the manipulations, difference or sameness;
f) repeating the above steps for a predetermined number of iterations separated by one or more predefined time intervals; and
g) upon completion of the predetermined number of iterations, providing the subject with the results of each iteration.

16. A system for promoting fluid intelligence abilities in a subject, the system comprising: a computer system comprising a processor, memory, and a graphical user interface (GUI), the processor containing instructions for:
a) selecting one or more serial order of symbols sequences from a predefined library of complete symbols sequences and, from this selection, providing the subject with one or more incomplete serial orders of symbols sequences on the GUI;
b) prompting the subject, within an exercise, to manipulate symbols sequences within the one or more incomplete serial orders of symbols sequences or to discriminate differences or sameness between two or more of the incomplete serial orders of symbols sequences on the GUI, within a first predefined time interval;
c) determining whether the subject correctly manipulated the symbols within the one or more incomplete serial orders of symbols sequences or correctly discriminated differences or sameness between the two or more further selected incomplete serial orders of symbols sequences;
d) if the subject made an incorrect manipulation within the one or more incomplete serial orders of symbols sequences or discrimination about differences or sameness between the two or more of the incomplete serial order of symbols sequences, then returning to step b);
e) if the subject correctly manipulated the symbols within the one or more incomplete serial orders of symbols sequences or correctly discriminated differences or sameness between the two or more of the incomplete serial orders of symbols sequences, then displaying the correct manipulations or discriminated differences or sameness on the GUI with at least one different spatial or time perceptual related attribute, to highlight the manipulations, discriminated difference or sameness;
f) repeating the above steps for a predetermined number of iterations separated by one or more predefined time intervals; and
g) upon completion of the predetermined number of iterations, providing the subject with the results of each iteration on the GUI.

17. A method of promoting fluid intelligence abilities in a subject comprising:
a) selecting a serial order of symbols sequence from a predefined library of complete symbol sequences, and further selecting and providing the subject with an incomplete serial order of symbols sequence from the selected complete serial order of symbols, wherein all symbols in the incomplete serial order of symbols sequence have the same spatial or time perceptual related attributes;
b) prompting the subject to select, in a first predefined time interval, the symbol corresponding to the next ordinal position in the sequence of the provided incomplete serial order of symbols, from a given list of symbols as potential answers showed to the subject;
c) if the symbol selection made by the subject is a correct symbol selection, then displaying the correctly selected symbol with an spatial or time perceptual related attribute different than symbols spatial or time perceptual related attributes of the incomplete serial order of symbols in step a);
d) if the symbol selection made by the subject is an incorrect symbol selection, then returning to step b);
e) repeating the above steps for a predefined number of iterations separated by one or more predefined time intervals; and
f) upon completion of a predefined number of iterations, providing the subject with the results of all iterations.

18. The method of claim 17, wherein first selection of the serial order of symbols sequence is done at random, from predefined complete serial order of symbols sequences of the library, and further selection of the incomplete serial order of symbols sequence is done also at random, from predefined number of symbols and predefined ordinal positions of these symbols, in the previously selected complete serial order of symbols sequence.

19. The method of claim 17, wherein the library of complete symbols sequences comprise alphabetic set arrays wherein each member term is a single letter symbol, comprising:
direct alphabetic set array; inverse alphabetic set array; direct type of alphabetic set array; inverse type of alphabetic set array; central type of alphabetic set array; inverse central type alphabetic set array.

20. The method of claim 17, wherein a change in attribute of the correctly selected symbol is selected from the group of spatial and time perceptual related attributes, or combinations thereof.

21. The method of claim 20, wherein the change in attributes is done according to predefined correlations between space and time perceptual related attributes, and the ordinal position of those letter symbols in the selected complete serial order of symbols of step a).

22. The method of claim 17, wherein each member term of the first selected complete serial order of symbols sequence is provided as a single letter symbol.

23. The method of claim 17, wherein the further selected incomplete serial order of symbols sequence comprises consecutive member terms of letter symbols.

24. The method of claim 17, wherein the further selected incomplete serial order of symbols sequence comprises non-consecutive member terms of letter symbols.

25. The method of claim 17, wherein the sequence length of the further selected incomplete serial order of symbols sequence comprises 2-6 symbols of the first selected complete serial order of symbols.

26. The method of claim 17, wherein the selecting by the subject of the next symbols according to step b), engages motor activity within the subject's body, the motor activity selected from the group involved in the sensorial perception of the selected serial orders of symbols, and in the body movements involved in prompting the subject according to step b), and combinations thereof.

27. The method of claim 26, wherein the body movements comprise movements selected from the group consisting of movements of the subject's eyes, head, neck, arms, hands, fingers and combinations thereof.

28. The method of claim 17, further comprising providing a ruler in step a).

29. The method of claim 28, wherein the ruler is selected from the group including direct alphabetic set array; inverse alphabetic set array; direct type of alphabetic set array; inverse type of alphabetic set array; central type of alphabetic set array; and inverse central type alphabetic set array.

30. A computer program product for promoting fluid intelligence abilities in a subject, stored on a non-transitory computer-readable medium which when executed causes a computer system to perform a method, comprising:
a) selecting a serial order of symbols from a predefined library of complete symbol sequences, and further selecting and providing to the subject with an incomplete serial order of symbols sequence from the selected complete serial order of symbols, wherein all symbols in the incomplete serial order of symbols have the same spatial or time perceptual related attributes;
b) prompting the subject to select, in a first predefined time interval, the symbol corresponding to the next ordinal position in the sequence of the provided incomplete serial order of symbols, from a given list of symbols as potential answers showed to the subject;
c) if the symbol selection made by the subject is a correct symbol selection, then displaying the correctly selected symbol with an spatial or time perceptual related attribute different than spatial or time perceptual related attributes of the incomplete serial order of symbols sequence in step a);
d) if the symbol selection made by the subject is an incorrect symbol selection, then returning to step b);
e) repeating the above steps for a predefined number of iterations separated by one or more predefined time intervals; and
f) upon completion of a predefined number of iterations, providing the subject with the results of all iterations.

31. A system for promoting fluid intelligence abilities in a subject, the system comprising: a computer system comprising a processor, memory, and a graphical user interface (GUI), the processor containing instructions for:
a) selecting a serial order of symbols from a predefined library of complete symbol sequences, and further selecting and providing to the subject an incomplete serial order of symbols sequence from the selected complete serial order of symbols, wherein all symbols in the incomplete serial order of symbols sequence have the same spatial or time perceptual related attributes;
b) prompting the subject on the GUI to select, in a first predefined time interval, the symbol corresponding to the next ordinal position in the provided sequence of incomplete serial order of symbols, from a given list of symbols as potential answers showed to the subject;
c) if the symbol selection made by the subject is a correct symbol selection, then displaying the correctly selected symbol on the GUI with an spatial or time perceptual related attribute different than spatial or time perceptual related attributes of the incomplete serial order of symbols sequence in step a);
d) if the symbol selection made by the subject is an incorrect symbol selection, then returning to step b);
e) repeating the above steps for a predefined number of iterations separated by one or more predefined time intervals; and
f) upon completion of a predefined number of iterations, providing the subject with the results of all iterations on the GUI.

32. A method of promoting fluid intelligence abilities in a subject comprising:
a) selecting a pair of serial order of symbols from a predefined library of complete symbols sequences, and providing the subject with two sequences of symbols, one from each of the pair of selected serial order of symbols, wherein a predefined number of symbols and selected ordinal positions of symbols are the same in the two provided sequences of symbols;
b) prompting the subject to select, within a first predefined time interval, whether the two provided sequences of symbols are the same, or different in at least one of their spatial or time perceptual related attributes, and displaying the selection;
c) if the selection made by the subject is an incorrect selection, then returning to step a);
d) if the selection made by the subject is a correct selection and the correct selection is that the two provided sequences of symbols are the same, then displaying the correct selection and indicating that the two sequences of symbols are the same by a change in at least one spatial or time perceptual related attribute in both sequences of symbols;
e) if the selection made by the subject is a correct selection and the correct selection is that the two provided sequences of symbols are different, then displaying the correct selection and indicating that the two sequences of symbols are different by a change in at least one spatial or time perceptual related attribute of only one sequence of symbols, to highlight the difference between the two sequences of symbols;
f) repeating the above steps for a predetermined number of iterations separated by one or more predefined time intervals; and
g) upon completion of the predetermined number of iterations, providing the subject with the results of each iteration.

33. The method of claim 32, wherein the selection of the two serial orders of symbols is done at random, from predefined complete sequences of symbols of the said library, and selection of the two sequences of symbols provided to the said subject is done also at random, from same predefined number of symbols and same predefined ordinal positions of these symbols, in the two previously selected serial order of symbols.

34. The method of claim 32, wherein the library of complete symbols sequences comprise alphabetic set arrays wherein each member term is a single letter symbol, comprising:
direct alphabetic set array; inverse alphabetic set array; direct type of alphabetic set array; inverse type of alphabetic set array; central type of alphabetic set array; inverse central type alphabetic set array.

35. The method of claim 32, wherein the two provided sequences of symbols comprise symbol sequences of consecutive member terms.

36. The method of claim 32, wherein the two provided sequences of symbols comprise symbol sequences of non-consecutive member terms.

37. The method of claim 32, wherein the two provided sequences of symbols are different, and the difference between the two provided sequences of symbols comprises at least one difference selected from the group of spatial or time perceptual related attributes, or combinations thereof.

38. The method of claim 32, wherein each of the two provided sequences of symbols comprises 2-7 member symbols terms.

39. The method of claim 32, where any changed attribute of the correct answer in steps d) and e), is selected from the group of spatial or time perceptual related attributes, or combinations thereof.

40. The method of claim 39, wherein the change in attributes is done according to predefined correlations between space and time related attributes, and the ordinal position of those letter symbols in the selected complete serial orders of symbols of step a).

41. The method of claim 32, wherein the selecting by the subject in step b) engages motor activity within the subject's body, the motor activity selected from the group involved in the sensorial perception of the selected serial orders and of the two provided sequences of symbols, and in the body movements involved in prompting the subject according to step b), and combinations thereof.

42. The method of claim 41, wherein the body movements comprise movements selected from the group consisting of movements of the subject's eyes, head, neck, arms, hands, fingers and combinations thereof.

43. The method of claim 32, further comprising providing a ruler in step a).

44. The method of claim 43, wherein the ruler is selected from the group including direct alphabetic set array; inverse alphabetic set array; direct type of alphabetic set array; inverse type of alphabetic set array; central type of alphabetic set array; and inverse central type alphabetic set array.

45. A computer program product for promoting fluid intelligence abilities in a subject, stored on a non-transitory computer-readable medium which when executed causes a computer system to perform a method, comprising:
a) selecting a pair of serial order of symbols sequences from a predefined library of complete symbols sequences and providing the subject with two sequences of symbols, one from each of the pair of selected serial order of symbols, wherein a predefined number of symbols and selected ordinal positions of symbols are the same in the two provided sequences of symbols;
b) prompting the subject to select, within a first predefined time interval, whether the two provided sequences of symbols are the same, or different in at least one of their spatial or time perceptual related attributes, and displaying the selection;
c) if the selection whether the two provided sequences of symbols are the same, or different in at least one of their spatial or time perceptual related attributes made by the subject is an incorrect selection, then returning to step a);
d) if the selection made by the subject is a correct selection and the correct selection is that the two provided sequences of symbols are the same, then displaying the correct selection and indicating that the two provided sequences of symbols are the same by a change in at least one spatial or time perceptual related attribute in both provided sequences of symbols;
e) if the selection made by the subject is a correct selection and the correct selection is that the two provided sequences of symbols are different, then displaying the correct selection and indicating that the two provided sequences of symbols are different by a change in at least one spatial or time perceptual related attribute of only one provided sequence of symbols to highlight the difference between the two provided sequences of symbols;
f) repeating the above steps for a predetermined number of iterations separated by one or more predefined time intervals; and
g) upon completion of the predetermined number of iterations, providing the subject with the results of each iteration.

46. A system for promoting fluid intelligence abilities in a subject, the system comprising: a computer system comprising a processor, memory, and a graphical user interface (GUI), the processor containing instructions for:
a) selecting a pair of serial order of symbols sequences from a predefined library of complete symbols sequences and providing the subject with two sequences of symbols, one from each of the pair of selected serial order of symbols, wherein a predefined number of symbols and selected ordinal positions of symbols are the same in the two provided sequences of symbols;
b) prompting the subject on the GUI to select, within a first predefined time interval, whether the two provided sequences of symbols are the same, or different in at least one of their spatial or time perceptual related attributes, and displaying the selection;
c) if the selection whether the two provided sequences of symbols are the same, or different in at least one of their spatial or time perceptual related attributes made by the subject is an incorrect selection, then returning to step a);
d) if the selection made by the subject is a correct selection and the correct selection is that the two provided sequences of symbols are the same, then displaying the correct selection on the GUI and indicating that the two provided sequences of symbols are the same by a change in at least one spatial or time perceptual related attribute in both sequences of symbols;
e) if the selection made by the subject is a correct selection and the correct selection is that the two provided sequences of symbols are different, then displaying the correct selection on the GUI and indicating that the two provided sequences of symbols are different by a change in at least one spatial or time perceptual related attribute of only one provided sequence of symbols to highlight the difference between the two provided sequences of symbols;
f) repeating the above steps for a predetermined number of iterations separated by one or more predefined time intervals; and
g) upon completion of the predetermined number of iterations, providing the subject with the results of each iteration on the GUI.

47. A method of promoting fluid intelligence abilities in a subject comprising:
a) selecting a serial order of symbols having the same spatial or time perceptual related attributes, from a predefined library of complete symbols sequences, and providing the subject with an incomplete serial order of symbols sequence from the selected complete serial order of symbols, wherein this selected complete serial order of symbols is provided as a ruler to the subject;
b) prompting the subject to insert, in the provided incomplete serial order of symbols sequence, missing symbols obtained from the given ruler within a first predefined time interval, complete the incomplete serial order of symbols sequence and form a completed serial order of symbols sequence;
c) if at least one insertion of a missing symbol from the given ruler made by the subject is an incorrect insertion, then returning to step a);
d) if the insertions of missing symbols from the given ruler made by the subject are all correct insertions, then displaying the correctly inserted missing symbols with at least one different spatial or time perceptual related attribute than the rest of the symbols in the provided incomplete serial order of symbols sequence;
e) repeating the above steps for a predetermined number of iterations separated by one or more predefined time intervals; and
f) upon completion of the predetermined number of iterations, providing the subject with the results of each iteration.

48. The method of claim 47, wherein the library of complete symbols sequences comprise alphabetic set arrays wherein each member term is a single letter symbol, comprising:
direct alphabetic set array; inverse alphabetic set array; direct type of alphabetic set array; inverse type of alphabetic set array; central type of alphabetic set array; inverse central type alphabetic set array.

49. The method of claim 48, wherein the complete serial order of symbols sequence is selected from the group consisting of direct alphabetic set array, direct type of alphabetic set array, and central type of alphabetic set array, and where the number of symbols missing in the provided incomplete serial order of symbols sequence comprises 2-7 symbols.

50. The method of claim 49, wherein the number of missing symbols in the provided incomplete serial order of symbols sequence is between 3 and 5 symbols.

51. The method of claim 48, wherein the complete serial order of symbols sequence is selected from the group consisting of inverse alphabetic set array, inverse type of alphabetic set array, and inverse central type of alphabetic set array, and the number of symbols missing in the provided incomplete serial order of symbols sequence comprises 2-5 symbols.

52. The method of claim 51, wherein the number of missing symbols in the provided incomplete serial order of symbols sequence is between 3 or 4 symbols.

53. The method of claim 47, wherein the changed attribute of the correctly inserted missing letter symbol is selected from the group of spatial or time perceptual related attributes, and combinations thereof.

54. The method of claim 53, wherein the change in attributes is done according to predefined correlations between space and time related attributes, and the ordinal position of those letter symbols in the selected complete serial order of symbols of step a).

55. The method of claim 47, wherein the inserting of missing symbols from the given ruler by the subject engages motor activity within the subject's body, the motor activity selected from the group involved in the sensorial perception of the selected complete and incomplete serial orders sequences, in the body movements to execute insertion of the missing symbols, and combinations thereof.

56. The method of claim 55, wherein the body movements comprise movements selected from the group consisting of movements of the subject's eyes, head, neck, arms, hands, fingers and combinations thereof.

57. The method of claim 47, wherein the complete serial order of symbols sequence in the given ruler is selected from the group including direct alphabetic set array; inverse alphabetic set array; direct type of alphabetic set array; inverse type of alphabetic set array; central type of alphabetic set array; and inverse central type alphabetic set array.

58. The method of claim 47, wherein the predetermined number of iterations ranges from 1-23 iterations.

59. A computer program product for promoting fluid intelligence abilities in a subject, stored on a non-transitory computer-readable medium which when executed causes a computer system to perform a method, comprising:
a) selecting a serial order of symbols sequence having the same spatial or time perceptual related attributes, from a predefined library of complete symbols sequences, and providing the subject with an incomplete serial order of symbols sequence from the selected complete serial order of symbols sequence, wherein this selected complete serial order of symbols sequence is provided as a ruler to the subject;
b) within a first predefined time interval, prompting the subject to insert missing symbols from the given ruler, in the provided incomplete serial order of symbols sequence, to complete the incomplete serial order of symbols sequence and form a completed serial order of symbols sequence;
c) if at least one missing symbol insertion made by the subject is an incorrect missing symbol insertion, then returning to step a);
d) if the insertions of missing symbols made by the subject are all correct missing symbols insertions, then displaying the correctly inserted symbols with at least one different spatial or time perceptual related attribute than the rest of the symbols in the provided incomplete serial order of symbols sequence;
e) repeating the above steps for a predetermined number of iterations separated by one or more predefined time intervals; and
f) upon completion of the predetermined number of iterations, providing the subject with the results of each iteration.

60. A system for promoting fluid intelligence abilities in a subject, the system comprising: a computer system comprising a processor, memory, and a graphical user interface (GUI), the processor containing instructions for:
a) selecting a serial order of symbols sequence having the same spatial or time perceptual related attributes, from a predefined library of complete symbols sequences, and providing the subject with an incomplete serial order of symbols sequence from the selected complete serial order of symbols sequence on the GUI, wherein this selected complete serial order of symbols sequence is provided as a ruler to the subject;
b) prompting the subject on the GUI to insert in the provided incomplete serial order of symbols sequence within a first predefined time interval, missing symbols from the given ruler, to complete the incomplete serial order of symbols sequence and form a completed serial order of symbols sequence;
c) if at least one missing symbol insertion made by the subject is an incorrect missing symbol insertion, then returning to step a);
d) if the insertions of missing symbols made by the subject are all correct insertions of missing symbols, then displaying the correctly inserted symbols on the GUI with at least one different spatial or time perceptual related attribute than the rest of the symbols in the provided incomplete serial order of symbols sequence;
e) repeating the above steps for a predetermined number of iterations separated by one or more predefined time intervals; and
f) upon completion of the predetermined number of iterations, providing the subject with the results of each iteration on the GUI.

61. A method of promoting fluid intelligence abilities in a subject comprising:
a) selecting a serial order of symbols sequence from a predefined library of complete symbol sequences with a predefined number of N consecutive different symbols having the same spatial or time perceptual related attributes, and further selecting a plurality of incomplete serial orders of symbols sequences with less than the predefined number of N consecutive different symbols, from the selected complete serial order of symbols sequences;
b) providing the subject with one incomplete serial order of different symbols in a sequence, from the selected plurality of incomplete serial orders of symbols sequences;
c) prompting the subject to select, within a first predefined time interval, two or more incomplete serial orders of symbols sequences among the remaining selected plurality of incomplete serial orders of symbols sequences, in order to contiguously complete the provided incomplete serial order of symbols sequence of step b) to form a completed serial order of symbols sequence having a predefined number of N consecutive different symbols;
d) if at least one contiguous incomplete symbols sequence selection made by the subject is an incorrect selection, then returning to step c);
e) if the two or more contiguous incomplete symbols sequences selections made by the subject are all correct contiguous incomplete symbols sequences selections, then displaying the obtained completed serial order of symbols sequence, wherein the correctly selected contiguous incomplete serial orders of symbols sequences are displayed with at least one different spatial or time perceptual related attribute than the provided incomplete serial order of symbols sequence of step b);
f) repeating the above steps for a predetermined number of iterations separated by one or more predefined time intervals; and
g) upon completion of the predetermined number of iterations, providing the subject with the results of each iteration.

62. The method of claim 61, wherein selection of the complete serial order of different symbols is done at random, from predefined complete serial orders of symbols of the said library, and selection of the plurality of incomplete serial order of symbols sequences is done also at random, from predefined numbers of consecutive different symbol members and predefined ordinal positions of these different symbols members in the previously selected complete serial order of symbols sequence.

63. The method of claim 61, wherein the predefined number N of consecutive different symbols, is an integer between 9 and 35.

64. The method of claim 61, wherein the library of complete symbols sequences comprise alphabetic set arrays wherein each member term is a single different letter symbol, comprising:
direct alphabetic set array; inverse alphabetic set array; direct type of alphabetic set array; inverse type of alphabetic set array; central type of alphabetic set array; inverse central type alphabetic set array.

65. The method of claim 64, wherein the complete serial order of symbols sequence is selected from the group consisting of direct alphabetic set array, direct type of alphabetic set array, and central type of alphabetic set array, and the number of symbols of the further selected incomplete serial order of symbols sequence of step b) comprises 2-7 symbols.

66. The method of claim 65, wherein the number of symbols of the further selected incomplete serial order of symbols sequence of step b) is between 3 and 5 symbols.

67. The method of claim 64, wherein the complete serial order of symbols sequence is selected from the group consisting of inverse alphabetic set array, inverse type of alphabetic set array, and inverse central type of alphabetic set array, and the number of symbols of the further selected incomplete serial order of symbols sequence of step b) comprises 2-4 symbols.

68. The method of claim 67, wherein the number of symbols of the further selected incomplete serial order of symbols sequence of step b) is 3 or 4 symbols.

69. The method of claim 61, wherein the plurality of selected incomplete serial orders of symbols sequences, comprises symbols sequences of 2-12 consecutive symbols.

70. The method of claim 69, wherein the plurality of selected incomplete serial orders of symbols sequences, comprises symbols sequences of 6-10 consecutive symbols.

71. The method of claim 61, wherein selecting a plurality of serial orders of symbols sequences with less than a predefined number of N consecutive different symbols, comprise selecting 8-17 serial orders of these symbols sequences.

72. The method of claim 71, wherein selecting a plurality of serial orders of symbols sequences comprise selecting 10-13 serial orders of these symbols sequences.

73. The method of claim 61, wherein the changed attribute of the correctly selected contiguous incomplete serial orders of symbols sequences is selected from the group of spatial and temporal perceptual related attributes, and combinations thereof.

74. The method of claim 73, wherein the change in attributes is done according to predefined correlations between space and time related attributes, and the ordinal position of those letter symbols in the selected complete serial order of symbols of step a).

75. The method of claim 61, wherein the selecting by the subject engages motor activity within the subject's body, the motor activity selected from the group involved in the sensorial perception of the selected incomplete serial order of symbols sequences from the selected complete serial order of symbols sequence and of the plurality of incomplete serial orders of symbols sequences, and in the body movements involved in prompting the subject in step c), and combinations thereof.

76. The method of claim 75, wherein the body movements comprise movements selected from the group consisting of movements of the subject's eyes, head, neck, arms, hands, fingers and combinations thereof.

77. The method of claim 61, further comprising providing a ruler in step a).

78. The method of claim 77, wherein the ruler is selected from the group including: direct alphabetic set array; inverse alphabetic set array; direct type of alphabetic set array; inverse type of alphabetic set array; central type of alphabetic set array; inverse central type alphabetic set array.

79. The method of claim 61, wherein the predetermined number of iterations ranges from 1-23 iterations.

80. A computer program product for promoting fluid intelligence abilities in a subject, stored on a non-transitory computer-readable medium which when executed causes a computer system to perform a method, comprising:
a) selecting a serial order of symbols sequence from a predefined library of complete symbol sequences with a predefined number of N consecutive different symbols having the same spatial or time perceptual related attributes, and further selecting a plurality of incomplete serial orders with less than the predefined number of N consecutive different symbol members, from the selected complete serial order of symbols sequences;
b) providing the subject with one incomplete serial order of different symbols in a sequence, from the selected plurality of incomplete serial orders of symbols sequences;
c) prompting the subject to select, within a first predefined time interval, two or more incomplete serial orders of symbols sequences among the remaining plurality of incomplete serial orders of symbols sequences, in order to contiguously complete the provided incomplete serial order of symbols sequence of step b) to form a completed serial order of symbols sequence having a predefined number of N consecutive different symbols;
d) if at least one contiguous incomplete symbols sequence selection made by the subject is an incorrect selection, then returning to step c);
e) if the two or more incomplete serial orders of symbols sequences selections made by the subject are all correct contiguous incomplete serial orders of symbols sequences selections, then displaying the obtained completed serial order of symbols sequence, wherein the correctly selected contiguous incomplete serial orders of symbols sequences are displayed with at least one different spatial or time perceptual related attribute than in the provided incomplete serial order of symbols sequence of step b);
f) repeating the above steps for a predetermined number of iterations separated by one or more predefined time intervals; and
g) upon completion of the predetermined number of iterations, providing the subject with the results of each iteration.

81. A system for promoting fluid intelligence abilities in a subject, the system comprising: a computer system comprising a processor, memory, and a graphical user interface (GUI), the processor containing instructions for:
a) selecting a serial order of symbols sequence from a predefined library of complete symbol sequences with a predefined number of N consecutive different symbols having the same spatial or time perceptual related attributes, and further selecting a plurality of incomplete serial orders of symbols sequences with less than N consecutive different symbol members, from the selected complete serial order of symbols sequence;
b) providing the subject on the GUI with one incomplete serial order of different symbols in a sequence from the selected plurality of incomplete serial orders of symbols sequences;
c) prompting the subject on the GUI to select, within a first predefined time interval, two or more incomplete serial orders of symbols sequences among the remaining plurality of incomplete serial orders of symbols sequences, in order to contiguously complete the provided incomplete serial order of symbols sequence of step b) to form a completed serial order of symbols sequence having N consecutive different symbols;
d) if at least one contiguous incomplete symbols sequence selection made by the subject is an incorrect selection, then returning to step c);
e) if the two or more contiguous incomplete symbols sequences selections made by the subject are all correct contiguous incomplete serial orders of symbols sequences selections, then displaying the obtained completed serial order of symbols sequence on the GUI, wherein the correctly selected contiguous incomplete serial orders of symbols sequences are displayed with at least one different spatial or time perceptual related attribute than the provided incomplete serial order of symbols sequence of step b);
f) repeating the above steps for a predetermined number of iterations separated by one or more predefined time intervals; and
g) upon completion of the predetermined number of iterations, providing the subject with the results of each iteration on the GUI.
